(19) United States
(12) Patent Application Publication
(10) Pub. No.: US 2006/0210170 A1
(43) Pub. Date: Sep. 21, 2006

(54) Image comparing apparatus using features of partial images

(75) Inventors: Manabu Yumoto, Nara-shi (JP); Yasufumi Itoh, Tenri-shi (JP); Manabu Onozaki, Nara-shi (JP); Takashi Horiyama, Yamatokoriyama-shi (JP); Teruaki Morita, Kitakatsuragi-gun (JP); Masayuki Ehiro, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/376,268

(22) Filed: Mar. 16, 2006

(30) Foreign Application Priority Data
Mar. 17, 2005 (JP) 2005-077527
Apr. 20, 2005 (JP) 2005-122628

(51) Int. Cl. G06K 9/46; G06K 9/68; G06K 9/36; G06K 9/32

(52) U.S. Cl. 382/219; 382/190; 382/291; 382/294

(57) ABSTRACT

An image comparing apparatus receives two images to be compared with each other. For each of the two images, respective feature values of partial images in the image are determined. With respect to each partial image in one of the images, the position of a partial image that is in the other image and that has the maximum score of matching with the partial image in that one image is searched for. The search range is limited to partial images selected according to three or five different feature values determined in advance. Then, the similarity score representing the degree of similarity between these two images is calculated, based on information about a movement vector indicating a relation between a reference position for locating the partial image in one image and the maximum matching score position that is searched for with respect to the partial image. Images to be searched belong to the same category as that of the partial image. Here, the images are classified into categories based on the feature values.

This nonprovisional application is based on Japanese Patent Applications Nos. 2005-077527 and 2005-122628 filed with the Japan Patent Office on Mar. 17, 2005 and April 20, 2005, respectively, the entire contents of which are hereby incorporated by reference.

### BACKGROUND OF THE INVENTION

1. Field of the Invention

The present invention relates to an image comparing apparatus. In particular, the invention relates to an image comparing apparatus that compares two images with each other by using features of partial images.

2. Description of the Background Art

Conventional methods of comparing fingerprint images can be classified broadly into image feature matching method and image-to-image matching method. Regarding the former, namely image feature matching, images are not directly compared with each other. Instead, features in the images are extracted and thereafter the extracted image features are compared with each other, as described in KOREDE WAKATTA BIOMETRICS (This Is Biometrics), edited by Japan Automatic Identification Systems Association, Ohmsha, Ltd., pp. 42-44. When this method is applied to fingerprint image comparison, minutiae (ridge characteristics of a fingerprint that occur at ridge bifurcations and ending, and few to several minutiae can be found in a fingerprint image) as shown in FIGS. 52A and 52B serve as the image feature. According to this method, minutiae are extracted by image processing from images as shown in FIG. 53; based on the positions, types and ridge information of the extracted minutiae, a similarity score is determined as the number of minutiae of which relative position and direction match among the images; the similarity score is incremented/decremented in accordance with match/mismatch in, for example, the number of ridges traversing the minutiae; and the similarity score thus obtained is compared with a predetermined threshold for identification.

Regarding the latter method, namely in image-to-image matching, from images “α” and “β” to be compared with each other as shown in FIG. 54, partial images “α1” and “β1” that may correspond to the full area or partial area of the original images are extracted; matching score between partial images “α1” and “β1” is calculated based on the total sum of difference values, correlation coefficient, phase correlation method or group delay vector method, as the similarity score between images “α” and “β”; and the calculated similarity score is compared with a predetermined threshold for identification.

Inventions utilizing the image-to-image matching method have been disclosed, for example, in Japanese Patent Laying-Open No. 63-211081 and Japanese Patent Laying-Open No. 63-078286. According to the invention of Japanese Patent Laying-Open No. 63-211081, an object image is subjected to image-to-image matching, the object image is then divided into four small areas, and in each resultant area, positions that attain to the maximum matching score in peripheral portions are found, and an average matching score is calculated therefrom, to obtain a similarity score. This approach can address distortion or deformation of fingerprint images that inherently occur at the time the fingerprints are taken. According to the invention of Japanese Patent Laying-Open No. 63-078286, one fingerprint image is compared with a plurality of partial areas that include features of the one fingerprint image, while substantially maintaining positional relation among the plurality of partial areas, and the total sum of matching scores of the fingerprint image with respective partial areas is calculated and provided as the similarity score.

Generally speaking, the image-to-image matching method is more robust to noise and finger condition variations (dryness, sweat, abrasion and the like), while the image feature matching method enables higher speed of processing then the image-to-image matching as the amount of data to be compared is smaller.

Further, Japanese Patent Laying-Open No. 2003-323618 proposes image comparison using movement vectors.

At present, biometrics-based technique of personal authentication as represented by fingerprint authentication is just beginning to be applied to consumer products. In this early stage of diffusion, it is desired to make as short as possible the time for personal authentication. Further, for expected application of such authentication function to a personal portable telephone or to a PDA (Personal Digital Assistants), shorter time and smaller power consumption required for authentication are desired, as the battery capacity is limited. In other words, regarding any of the above-referenced documents, shortening of the processing time is desired.

### SUMMARY OF THE INVENTION

An object of the present invention is to provide an image comparing apparatus that can achieve fast processing.

With the purpose of achieving this object, an image comparing apparatus according to an aspect of the present invention includes:

a feature calculating unit calculating a value corresponding to a pattern of a partial image to output the calculated value as a feature of the partial image;

a position searching unit searching, with respect to the partial image in a first image, a second image for a maximum matching score position having a maximum score of matching with the partial image;

a similarity score calculating unit calculating a similarity score representing the degree of similarity between the first image and the second image, according to a positional relation amount representing positional relation between a reference position for locating the partial image in the first image and the maximum matching score position searched for, with respect to the partial image, by the position searching unit, and outputting the calculated similarity score; and

a determining unit determining whether or not the first image and the second image match each other, based on the similarity score as provided.

The feature calculating unit includes a first feature calculating unit that generates a third image by superimposing on each other the partial image and images generated by displacing, by a predetermined number of pixels, the partial image respectively in first opposite directions, and generates a fourth image by superimposing on each other the partial image and images generated by displacing, by the predetermined number of pixels, the partial image respectively in second opposite directions. The first feature calculating unit calculates a difference between the generated third image and the partial image and a difference between the generated fourth image and the partial image to output, as the feature, a first feature value based on the calculated differences.

A region that is included in the second image and that is searched by the position searching unit is determined according to the feature of the partial image that is output by the feature calculating unit.

Preferably, the feature calculating unit further includes a second feature calculating unit. The second feature calculating unit generates a fifth image by superimposing on each other the partial image and images generated by displacing, by a predetermined number of pixels, the partial image respectively in third opposite directions, and generates a sixth image by superimposing on each other the partial image and images generated by displacing, by the predetermined number of pixels, the partial image respectively in fourth opposite directions. The second feature calculating unit calculates a difference between the generated fifth image and the partial image and a difference between the generated sixth image and the partial image to output, as the feature, a second feature value based on the calculated differences.

Preferably, the first image and the second image are each an image of a fingerprint. The first opposite directions refer to left-obliquely opposite directions relative to the fingerprint, and the second opposite directions refer to right-obliquely opposite directions relative to the fingerprint. The third opposite directions refer to upward and downward directions relative to the fingerprint, and the fourth opposite directions refer to leftward and rightward directions relative to the fingerprint.

Thus, according to the feature of the partial image, the scope of search is limited (reduced) to a certain scope, and thereafter search of the second image can be conducted to find the position (region) having the highest score of matching with the partial image in the first image. Therefore, the scope searched for comparing images is limited to a certain scope in advance, and accordingly the time for comparison can be shortened and the power consumption of the apparatus can be reduced.

Preferably, the apparatus further includes a category determining unit determining, based on the feature of the partial image that is output from the feature calculating unit, a category to which the first image belongs. The second image is selected based on the category determined by the category determining unit.

Thus, based on the category to which the first image belongs that is determined by the category determining unit, the second image to be compared can be selected. Therefore, even if a large number of second images are prepared, a limited number of second images can be used for comparison. Accordingly, the time required for comparison can be shortened and the power consumption of the apparatus can be reduced.

Here, preferably the positional relation amount is a movement vector. In this case, the similarity score is calculated using information concerning partial images that are determined to have the same movement vector, corresponding to a predetermined range.

Regarding an image of a fingerprint, an arbitrary partial image in the image includes such information as the number, direction, width and changes of ridges that characterize the fingerprint. Then, a characteristic utilized here is that, even in different fingerprint images taken from the same fingerprint, respective partial images match at the same position in most cases.

Preferably, the calculated feature of the partial image is one of three different values. Accordingly, the comparison can be prevented from being complicated.

Preferably, in the case where the feature value is determined by displacing the partial image in the upward/downward and leftward/rightward directions, the three different values respectively indicate that the pattern of the fingerprint in the partial image is along the vertical direction, along the horizontal direction and any except for the aforementioned ones. In the case where the feature value is determined by displacing the partial image in the right oblique direction and the left oblique direction, the three different values respectively indicate that the pattern of the fingerprint in the partial image is along the right oblique direction, along the left oblique direction and any except for the aforementioned ones.

Preferably, the feature values of the partial image are three different values. However, the number of different values is not limited to this. Any number, for example, four different values may be used.

Preferably, the pattern along the vertical direction is vertical stripe, the pattern along the horizontal direction is horizontal stripe, the pattern along the right oblique direction is right oblique stripe, and the pattern along the left oblique direction is left oblique stripe. Therefore, in the case for example where the image is an image of a fingerprint, the fingerprint can be identified as the one having one of the vertical, horizontal, left oblique and right oblique stripes.

Preferably, in the case where the second feature value of the partial image indicates that the pattern of the partial image is not along the third opposite directions or the fourth opposite directions, the feature calculating unit outputs the first feature value instead of the second feature value for the partial image. Further, in the case where the first feature value of the partial image indicates that the pattern of the partial image is not along the first opposite directions or the second opposite directions, the feature calculating unit outputs the second feature value instead of the first feature value.

Thus, the feature of the partial image that is output by the feature calculating unit may be one of five different values to achieve high accuracy in comparison.

Preferably, the five different values are respectively a value indicating that the pattern of the partial image is along the vertical direction, a value indicating that it is along the horizontal direction, a value indicating that it is along the left oblique direction, a value indicating that it is along the right oblique direction and a value indicating that it is any except for the aforementioned directions.

Preferably, the pattern along the vertical direction is vertical stripe, the pattern along the horizontal direction is horizontal stripe, the pattern along the left oblique direction is left oblique stripe, and the pattern along the right oblique direction is right oblique stripe. Therefore, in the case for example where the image is an image of a fingerprint, the pattern of the fingerprint can be identified using feature values representing vertical stripe, horizontal stripe, stripes in upper/lower left oblique directions and stripes in upper/lower right oblique directions.

Preferably, partial images having a feature value indicating that the pattern is any except for the defined ones are excluded from the scope of search by the position searching unit. Thus, partial images having a pattern along an obscure direction that cannot be identified as any of the vertical, horizontal, right oblique and left oblique directions are excluded from the scope of search. Accordingly, deterioration in accuracy in comparison can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an image comparing apparatus in accordance with an embodiment of the present invention.

FIG. 2 shows a configuration of a computer to which the image comparing apparatus of the present invention is mounted.

FIG. 3 is a flowchart of a procedure for comparing two images with each other by the image comparing apparatus in accordance with the present invention.

FIG. 4 schematically illustrates calculation of a partial image feature value in accordance with Embodiment 1 of the present invention.

FIG. 5 is a flowchart of a process for calculating a partial image feature value in accordance with Embodiment 1 of the present invention.

FIG. 6 is a flowchart of a process for calculating the maximum number of consecutive black pixels in the horizontal direction in a partial image in accordance with Embodiment 1 of the present invention.

FIG. 7 is a flowchart of a process for calculating the maximum number of consecutive black pixels in the vertical direction in the partial image in accordance with Embodiment 1 of the present invention.

FIG. 8 is a flowchart of a process for calculating a similarity score in accordance with Embodiment 1 of the present invention.

FIGS. 9A to 9C illustrate a specific example of a comparing process in accordance with Embodiment 1 of the present invention.

FIGS. 10A to 10C illustrate a specific example of the comparing process in accordance with Embodiment 1 of the present invention.

FIGS. 11A to 11F illustrate a specific example of the comparing process in accordance with Embodiment 1 of the present invention.

FIG. 12 shows a configuration of an image comparing apparatus in accordance with Embodiment 2 of the present invention.

FIG. 13 is a flowchart of an image comparing process in accordance with Embodiment 2 of the present invention.

FIG. 14 is a flowchart of a process for calculating to determine an image category in accordance with Embodiment 2 of the present invention.

FIG. 15 shows exemplary contents of a table in accordance with Embodiment 2 of the present invention.

FIGS. 16A to 16F illustrate the category determination using macro partial images in accordance with Embodiment 2 of the present invention.

FIGS. 17A to 17E illustrate an example of the calculation to determine a category in accordance with Embodiment 2 of the present invention.

FIGS. 18A to 18E illustrate another example of the calculation to determine a category in accordance with Embodiment 2 of the present invention.

FIG. 19 is a flowchart of a process for similarity score calculation, comparison and determination in accordance with Embodiment 2 of the present invention.

FIG. 20 shows a configuration of an image comparing apparatus in accordance with Embodiment 3 of the present invention.

FIG. 21 schematically illustrates calculation of an image feature value in accordance with Embodiment 3 of the present invention.

FIG. 22 is a flowchart of an image comparing process in accordance with Embodiment 3 of the present invention.

FIG. 23 is a flowchart of a process for calculating a partial image feature value in accordance with Embodiment 3 of the present invention.

FIG. 24 is a flowchart of a process for calculating the number of changes in pixel value in the horizontal direction in a partial image in accordance with Embodiment 3 of the present invention.

FIG. 25 is a flowchart of a process for calculating the number of changes in pixel value in the vertical direction in the partial image in accordance with Embodiment 3 of the present invention.

FIG. 26 shows a configuration of an image comparing apparatus in accordance with Embodiment 4 of the present invention.

FIG. 27 is a flowchart of an image comparing process in accordance with Embodiment 4 of the present invention.

FIGS. 28A to 28F schematically illustrate a process for calculating an image feature value in accordance with Embodiment 4 of the present invention.

FIGS. 29A to 29C show a flowchart and partial images to be referred to in a process for calculating a partial image feature value in accordance with Embodiment 4 of the present invention.

FIG. 30 is a flowchart of a process for calculating an amount of pixel increase in the case where a partial image is displaced to the left and right in accordance with Embodiment 4 of the present invention.

FIG. 31 is a flowchart of a process for calculating an amount of pixel increase in the case where a partial image is displaced upward and downward in accordance with Embodiment 4 of the present invention.

FIG. 32 is a flowchart of a process for calculating a difference in accordance with Embodiment 4 of the present invention.

FIG. 33 shows a configuration of an image comparing apparatus in accordance with Embodiment 5 of the present invention.

FIG. 34 is a flowchart of an image comparing process in accordance with Embodiment 5 of the present invention.

FIGS. 35A to 35F schematically illustrate a process for calculating an image feature value in accordance with Embodiment 5 of the present invention.

FIGS. 36A to 36C show a flowchart and partial images to be referred to in a process for calculating a partial image feature value in accordance with Embodiment 5 of the present invention.

FIG. 37 is a flowchart of a process for determining an amount of pixel increase in the case where a partial image is displaced in the upper and lower right oblique directions in accordance with Embodiment 5 of the present invention.

FIG. 38 is a flowchart of a process for determining an amount of pixel increase in the case where a partial image is displaced in the upper and lower left oblique directions in accordance with Embodiment 5 of the present invention.

FIG. 39 is a flowchart of a process for calculating a difference in accordance with Embodiment 5 of the present invention.

FIG. 40 shows a configuration of an image comparing apparatus in accordance with Embodiment 6 of the present invention.

FIG. 41 is a flowchart of an image comparing process in accordance with Embodiment 6 of the present invention.

FIG. 42 is a flowchart of a process for calculating a partial image feature value in accordance with Embodiment 6 of the present invention.

FIG. 43 is a flowchart of a process for calculating to determine an image category in accordance with Embodiment 6 of the present invention.

FIG. 44 shows exemplary contents of a table in accordance with Embodiment 6 of the present invention.

FIGS. 45A and 45B show respective positions of partial images and macro partial images.

FIGS. 46A to 46J illustrate the category determination using macro partial images in accordance with Embodiment 6 of the present invention.

FIGS. 47A to 47E illustrate an example of the calculation to determine a category in accordance with Embodiment 6 of the present invention.

FIGS. 48A to 48E illustrate another example of the calculation to determine a category in accordance with Embodiment 6 of the present invention.

FIGS. 49A to 49E illustrate still another example of the calculation to determine a category in accordance with Embodiment 6 of the present invention.

FIGS. 50A to 50E illustrate a further example of the calculation to determine a category in accordance with Embodiment 6 of the present invention.

FIGS. 51A to 51E illustrate a still further example of the calculation to determine a category in accordance with Embodiment 6 of the present invention.

FIGS. 52A and 52B illustrate the image-to-image matching method as an example of conventional art.

FIG. 53 illustrates the image feature matching method as an example of conventional art.

FIG. 54 schematically illustrates minutiae as image feature used in the conventional art.

### DESCRIPTION OF THE PREFERRED EMBODIMENTS

Embodiments of the present invention will be described with reference to the drawings. Here, two image data are compared with each other. Although fingerprint image data will be described as exemplary image data to be compared, the image data is not limited thereto. The present invention may be applied to image data of other biometrics features that are similar among samples (individuals) but not identical, or image data of linear patterns.

In each embodiment, it is supposed that an image or a partial image is a rectangular image. Further, it is supposed that one of two perpendicular sides of the rectangle is x coordinate axis and the other side is y coordinate axis. Then, the image (partial image) corresponds to the space at plane coordinates determined by the x coordinate axis and the y coordinate axis perpendicular to each other.

In each embodiment, upward/downward direction and leftward/rightward direction respectively correspond, in the case where the image is an image of a fingerprint, to the upward/downward direction and the leftward/rightward direction with respect to the fingerprint. In other words, the upward/downward direction is represented by the vertical direction of the image at plane coordinates, namely the direction of the y-axis. The leftward/rightward direction is represented by the horizontal direction of the image at plane coordinates, namely the direction of the x-axis.

Further, in each embodiment, left oblique direction and right oblique direction respectively correspond, in the case where the image is an image of a fingerprint, to the left oblique direction and the right oblique direction with respect to the fingerprint. In other words, in the case where the above-described x-axis and y-axis perpendicular to each other are rotated counterclockwise by 45 degrees about the crossing point of the axes (without rotating the image itself), the left oblique direction and the right oblique direction are represented respectively by the y and x axes rotated on the x-y plane of the image.

Embodiment 1

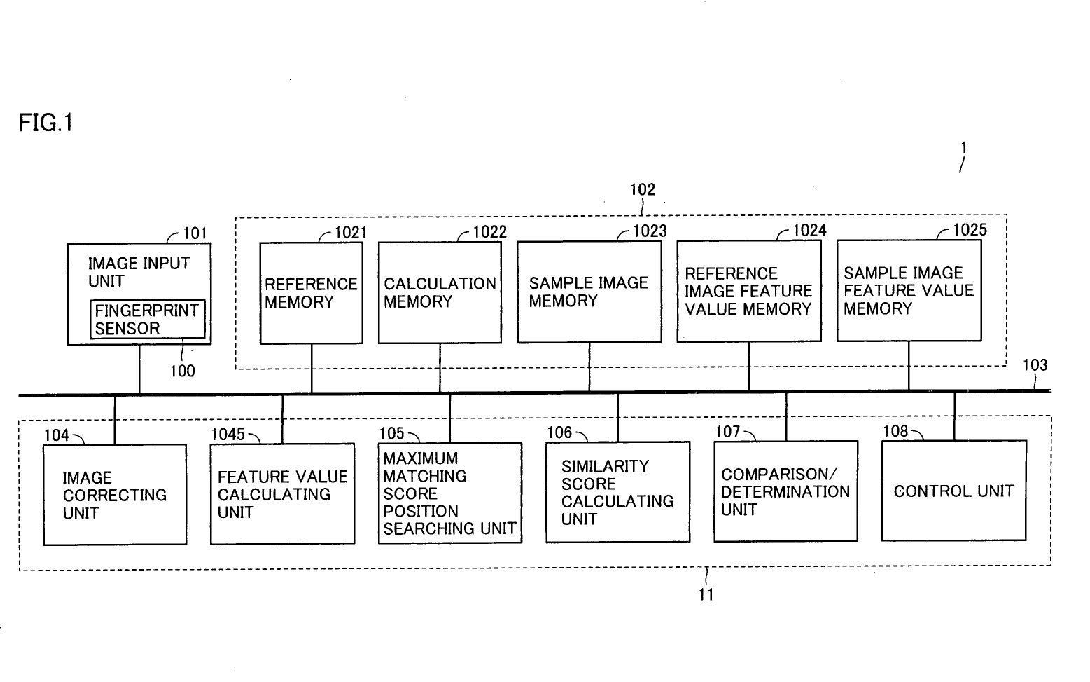

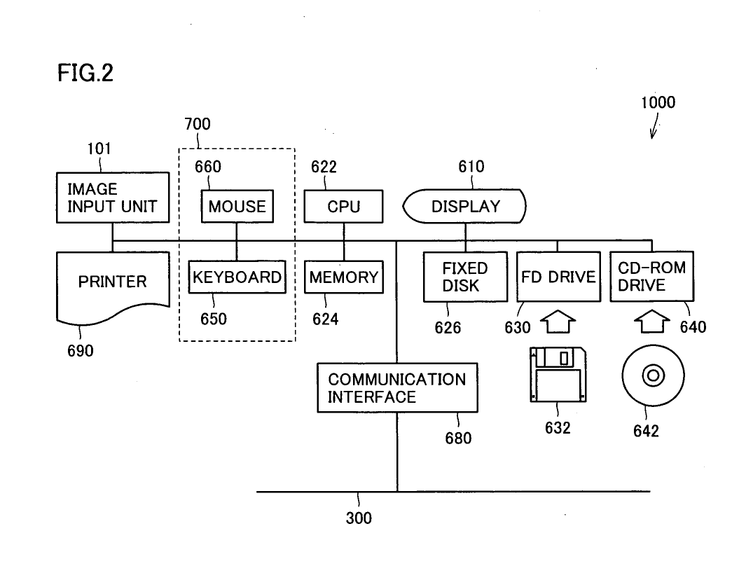

FIG. 1 is a block diagram of an image comparing apparatus 1 in accordance with Embodiment 1. FIG. 2 shows a configuration of a computer 1000 to which the image comparing apparatus in accordance with each embodiment is mounted. Referring to FIG. 2, computer 1000 includes an image input unit 101, a display 610 such as a CRT (Cathode Ray Tube) or a liquid crystal display, a CPU (Central Processing Unit) 622 for central management and control of computer 1000 itself, a memory 624 including a ROM (Read Only Memory) or a RAM (Random Access Memory), a fixed disk 626, an FD drive 630 to which an FD (flexible disk) 632 is detachably mounted and which accesses the mounted FD 632, a CD-ROM drive 640 to which a CD-ROM (Compact Disc Read Only Memory) is detachably mounted and which accesses the mounted CD-ROM 642 a communication interface 680 for connecting computer 1000 to a communication network 300 for establishing communication, a printer 690, and an input unit 700 having a keyboard 650 and a mouse 660. These components are connected through a bus for communication.

The computer may be provided with a magnetic tape apparatus accessing a cassette-type magnetic tape that is detachably mounted thereto.

Referring to FIG. 1, image comparing apparatus 1 includes an image input unit 101, a memory 102 that corresponds to memory 624 or fixed disk 626 shown in FIG. 2, a bus 103 and a comparing unit 11. Memory 102 includes a reference memory 1021, a calculation memory 1022, a sample image memory 1023, a reference image feature value memory 1024, and a sample image feature value memory 1025. Comparing unit 11 includes an image correcting unit 104, a feature value calculating unit 1045, a maximum matching score position searching unit 105, a similarity score calculating unit 106, a comparison/determination unit 107, and a control unit 108. Functions of these units of comparing unit 11 are realized by execution of corresponding programs read from memory 624.

Image input unit 101 includes a fingerprint sensor 100 and outputs fingerprint image data that corresponds to a fingerprint read by fingerprint sensor 100. Fingerprint sensor 100 may be any of sensors of other types, for example, optical, pressure, static-capacitance sensors. Memory 102 stores image data and various calculation results. Specifically, reference memory 1021 stores data of a plurality of partial areas of template fingerprint images. Calculation memory 1022 stores results of various calculations. Sample image memory 1023 stores fingerprint image data output from image input unit 101. Reference image feature value memory 1024 and sample image feature value memory 1025 store the results of calculation by feature value calculating unit 1045, which will be herein described. Bus 103 is used for transferring control signals and data signals between these units.

Image correcting unit 104 makes density correction to the fingerprint image data input from image input unit 101. Feature value calculating unit 1045 calculates, for each of a plurality of partial area images defined in the image, a value corresponding to a pattern of the partial image, and outputs, as partial image feature value, the result of calculation corresponding to reference memory 1021 to reference image feature value memory 1024, and the result of calculation corresponding to sample image memory 1023 to sample image feature value memory 1025.

Maximum matching score position searching unit 105 reduces the scope of search in accordance with the partial image feature value calculated by feature value calculating unit 1045, uses a plurality of partial areas of one fingerprint image as templates, and searches for a position in the other fingerprint image that attains to the highest score of matching with the templates. Namely, this unit serves as a so-called template matching unit.

Similarity score calculating unit 106 uses the information on the result obtained by maximum matching score position searching unit 105 stored in memory 102, and calculates a similarity score based on movement vectors which will be described hereinlater. Comparison/determination unit 107 determines a match/mismatch, based on the similarity score calculated by similarity score calculating unit 106. Control unit 108 controls processes performed by the units of comparing unit 11.

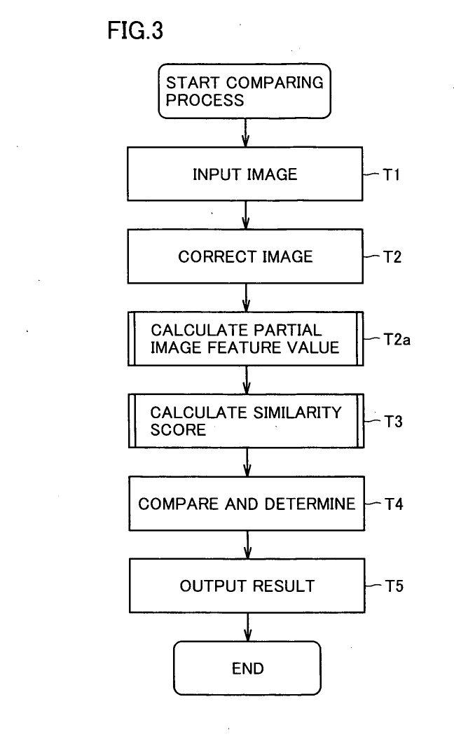

The procedure of comparing images “A” and “B” corresponding to two pieces of fingerprint image data for comparing two fingerprint images in image comparing apparatus 1 shown in FIG. 1 will be described with reference to the flowchart of FIG. 3.

First, control unit 108 transmits an image input start signal to image input unit 101, and thereafter waits until receiving an image input end signal. Image input unit 101 receives input image “A” and stores the image at a prescribed address of memory 102 through bus 103 (step T1). In the present embodiment, it is assumed that the image is stored at a prescribed address of reference memory 1021. After the input of image “A” is completed, image input unit 101 transmits the image input end signal to control unit 108.

Receiving the image input end signal, control unit 108 again transmits the image input start signal to image input unit 101, and thereafter waits until receiving the image input end signal. Image input unit 101 receives input image “B” and stores the image at a prescribed address of memory 102 through bus 103 (step T1). In the present embodiment, it is assumed that input image “B” is stored at a prescribed address of sample image memory 1023. After the input of image “B” is completed, image input unit 101 transmits the image input end signal to control unit 108.

Then, control unit 108 transmits an image correction start signal to image correcting unit 104, and thereafter waits until receiving an image correction end signal. In most cases, the input image has uneven image quality, as tones of pixels and overall density distribution vary because of variations in characteristics of image input unit 101, dryness of fingerprints themselves and pressure with which fingers are pressed. Therefore, it is not appropriate to use the input image data directly for comparison. Image correcting unit 104 corrects the image quality of the input image to suppress variations in conditions under which the image is input (step T2). Specifically, for the overall image corresponding to the input image data or each small areas into which the image is divided, histogram planarization, as described in Computer GAZOU SHORI NYUMON (Introduction to computer image processing), SOKEN SHUPPAN, p. 98, or image thresholding (binarization), as described in Computer GAZOU SHORI NYUMON (Introduction to computer image processing), SOKEN SHUPPAN, pp. 66-69, is performed, on images stored in memory 102, that is, images “A” and “B” stored in reference memory 1021 and sample image memory 1023.

After the end of image correcting process on images “A” and “B”, image correcting unit 104 transmits the image correction end signal to control unit 108.

Thereafter, on the image that has been image-corrected by image correcting unit 104, the process for calculating a partial image feature value (step T2a) is performed. It is assumed here that the partial image is a rectangular image.

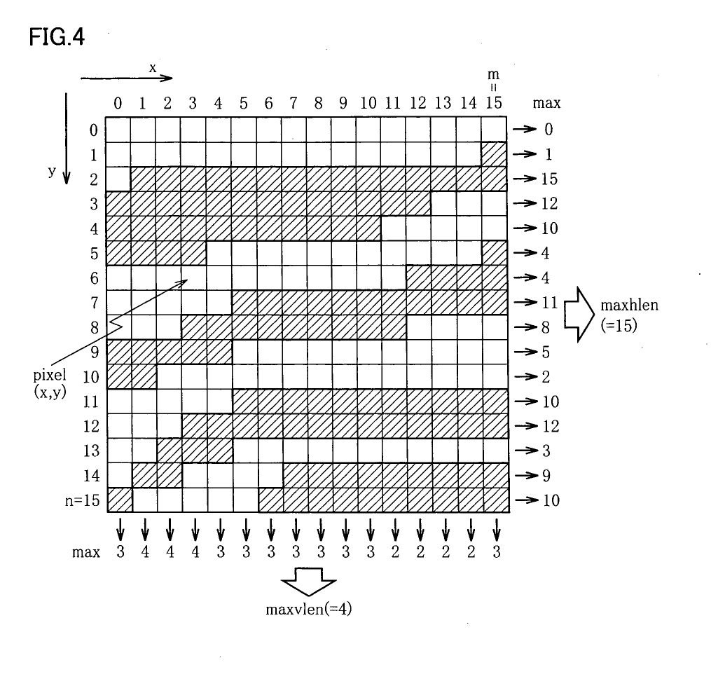

Calculation of the partial image feature value will be described generally with reference to FIG. 4. FIG. 4 shows a partial image together with the maximum number of pixels in the horizontal/vertical direction. The partial image as shown in FIG. 4 consists of 16 pixels×16 pixels (=m×n), that is, a partial area having 16 pixels in each of the horizontal direction (x direction) and vertical direction (y direction). In FIG. 4, an arbitrary pixel value (x, y) is depicted. The x direction and y direction respectively represent directions in parallel with two perpendicular sides of the rectangular partial image.

In the calculation of the partial image feature value in accordance with Embodiment 1, a value corresponding to the pattern of the partial image on which the calculation is performed is output as the partial image feature value. Specifically, a comparison is made between the maximum number of consecutive black pixels in the horizontal direction “maxhlen” (a value indicating the degree of tendency of the pattern to extend in the horizontal direction (such as horizontal stripe)) and the maximum number of consecutive black pixels in the vertical direction “maxvlen” (a value indicating the degree of tendency of the pattern to extend in the vertical direction (such as vertical stripe)). When the maximum number of consecutive black pixels in the horizontal direction is relatively larger than that in the vertical direction, “H” representing “horizontal” (horizontal stripe) is output. If the maximum number of consecutive black pixels in the vertical direction is relatively larger than that in the horizontal direction, “V” representing “vertical” (vertical stripe) is output. Otherwise, “X” is output. Even when the determined value is “H” or “V”, “X” is output if the maximum number of consecutive black pixels is not equal to or larger than the lower limit value “hlen0” or “vlen0” that is set in advance for both directions. These conditions can be given by the following expressions. If maxhlen>maxvlen and maxhlen≧hlen0, then “H” is output. If maxvlen>maxhlen and maxvlen≧vlen0, then “V” is output. Otherwise, “X” is output.

FIG. 5 shows a flowchart of the process for calculating the partial image feature value in accordance with Embodiment 1 of the present invention. The process flow is repeated for partial images “Ri” that are “n” partial area images of the reference image stored in reference memory 1021 that is an images on which the calculation is performed, and the resultant calculated values are stored, in reference image feature value memory 1024, in the state correlated with respective partial images “Ri”. Similarly, the process flow is repeated for “n”0 partial images “Ri” of the sample image stored in sample image memory 1023, and the resultant calculated values are stored, in sample image feature value memory 1025, in the state correlated with respective partial images “Ri”. Details of the process for calculating the partial image feature value will be described with reference to the flowchart of FIG. 5.

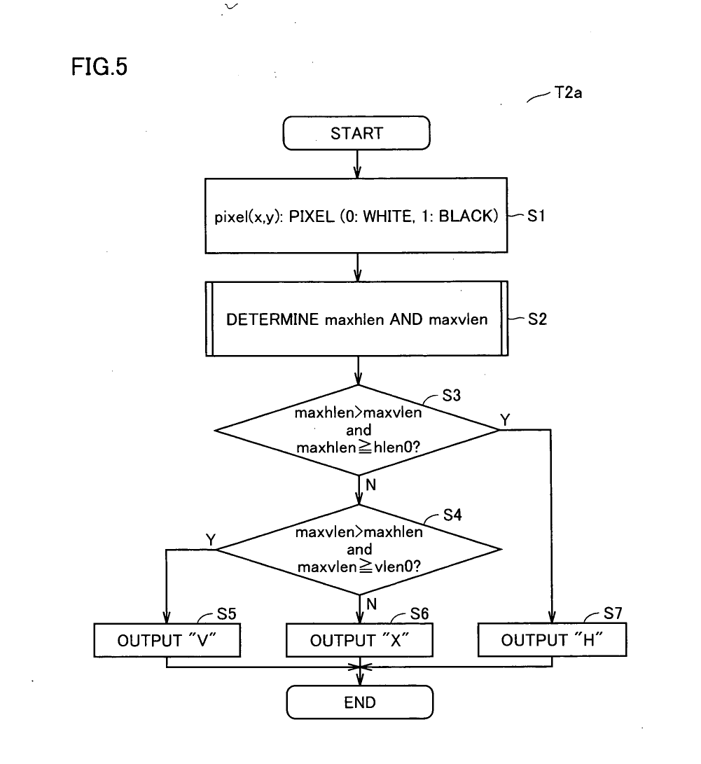

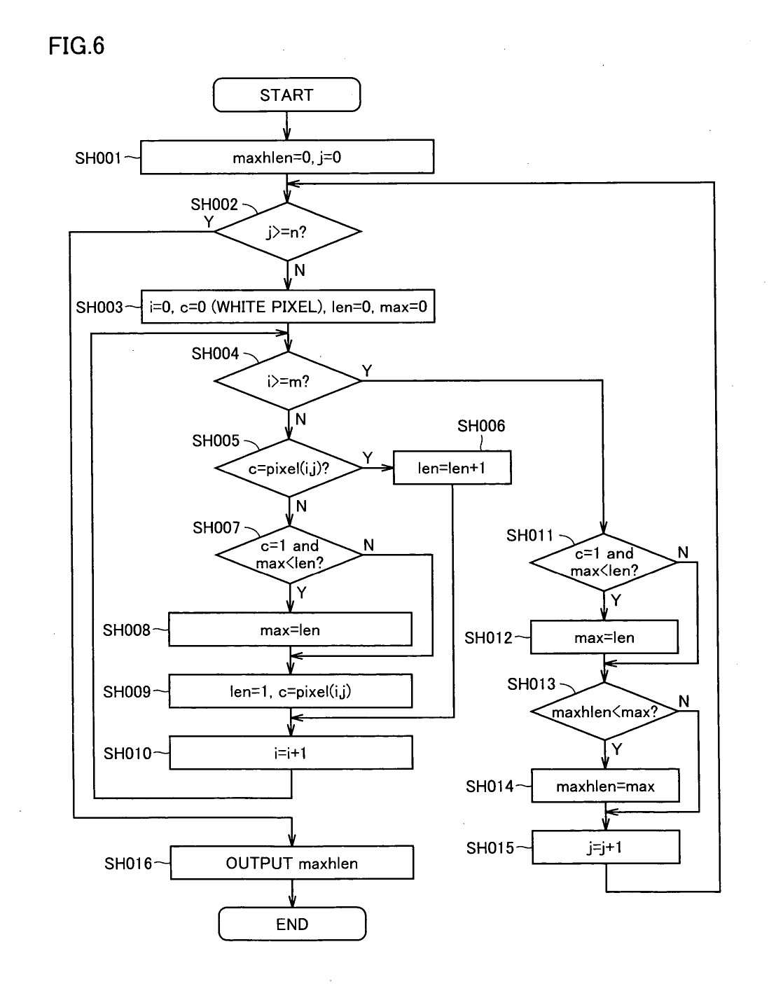

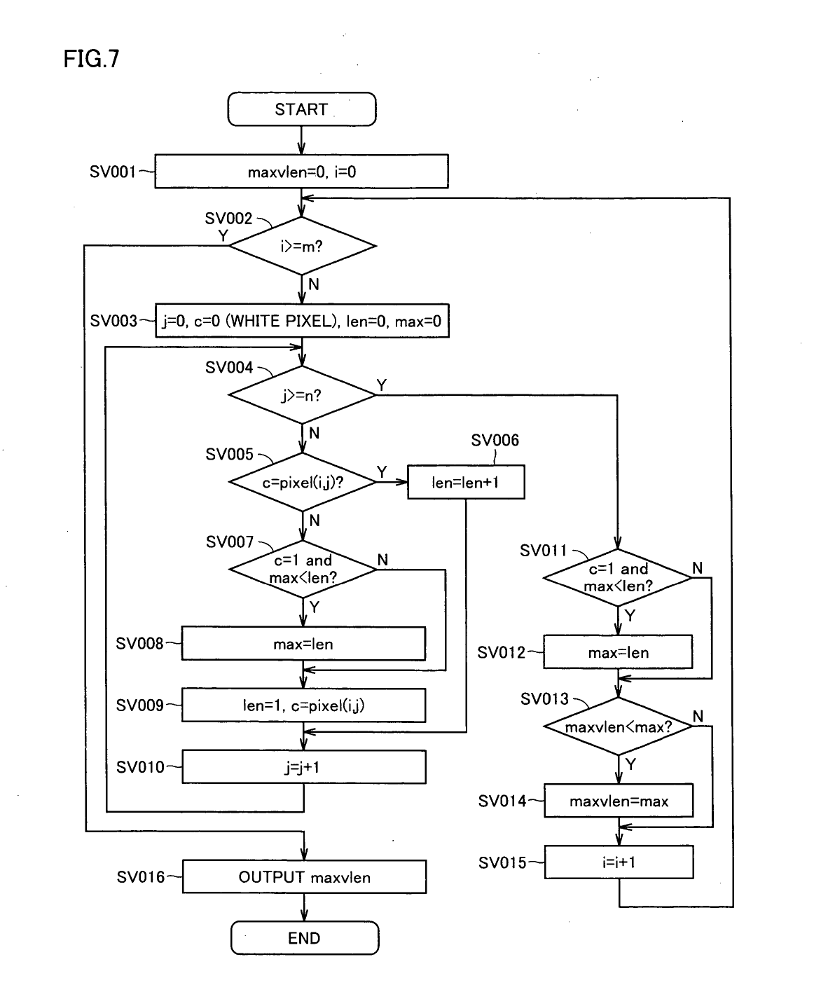

Control unit 108 transmits a partial image feature value calculation start signal to feature value calculating unit 1045, and thereafter waits until receiving a partial image feature value calculation end signal. Feature value calculating unit 1045 reads the data of partial image “Ri” on which calculation is performed from reference memory 1021 or from sample image memory 1023, and temporarily stores the same in calculation memory 1022 (step S1). Feature value calculating unit 1045 reads the stored data of partial image “Ri”, and calculates the maximum number of consecutive black pixels in the horizontal direction “maxhlen” and the maximum number of consecutive black pixels in the vertical direction “maxvlen” (step S2). The process for calculating the maximum number of consecutive black pixels in the horizontal direction “maxhlen” and the maximum number of consecutive black pixels in the vertical direction “maxvlen” will be described with reference to FIGS. 6 and 7.

FIG. 6 is a flowchart of a process (step S2) for calculating the maximum number of consecutive black pixels in the horizontal direction “maxhlen” in the process for calculating the partial image feature value (step T2a) in accordance with Embodiment 1 of the present invention. Feature value calculating unit 1045 reads data of the partial image “Ri” from calculation memory 1022, and initializes the maximum number of consecutive black pixels in the horizontal direction “maxhlen” and a pixel counter “j” for the vertical direction. Namely, maxhlen=0 and j=0 (step SH001).

Thereafter, the value of pixel counter “j” for the vertical direction is compared with the maximum number of pixels “n” in the vertical direction (step SH002). If j≧n, step SH016 is executed, and otherwise, step SH003 is executed. In Embodiment 1, the number “n” is set (stored) in advance as n=15 and, at the start of processing, j=0. Therefore, the flow proceeds to step SH003.

In step SH003, a pixel counter “i” for the horizontal direction, previous pixel value “c”, the present number of consecutive pixels “len”, and the maximum number of consecutive black pixels “max” in the present row are initialized. Namely, i=0, c=0, len=0 and max=0 (step SH003). Thereafter, the value of pixel counter “i” for the horizontal direction is compared with the maximum number of pixels “m” in the horizontal direction (step SH004). If i≧m, step SH011 is executed, and otherwise, step SH005 is executed. In Embodiment 1, the number “m” is set (stored) in advance as m=15 and, at the start of processing, i=0. Therefore, the flow proceeds to step SH005.

In step SH005, the previous pixel value “c” is compared with the pixel value “pixel (i, j)” at the coordinates (i, j) on which the comparison is currently performed. If c=pixel (i, j), step SH006 is executed, and otherwise, step SH007 is executed. In Embodiment 1, “c” has been initialized to “0” (white pixel) and pixel (0, 0) is “0” (white pixel) in FIG. 4. Therefore, c=pixel (i, j). Then, the flow proceeds to step SH006. In step SH007, whether or not the condition “c=1” and “max<len” holds is determined. If it is YES, the value of “len” is input to “max” in step SH008, and the flow proceeds to step SH009. If it is NO in step SH007, “len” is replaced by “1” and “c” is replaced by “pixel (i, j)” in step SH009.

In step SH006, the calculation len=len+1 is performed. In Embodiment 1, “len” has been initialized to len=0, and therefore, the addition of 1 provides len=1. Thereafter, the flow proceeds to step SH010.

In step SH010, the calculation i=i+1 is performed, that is, the value “i” of the horizontal pixel counter is incremented. In Embodiment 1, “i” has been initialized to i=0, and therefore, the addition of 1 provides i=1. Then, the flow returns to step SH004. Thereafter, with reference to FIG. 4, as the pixels in the 0th row, that is, “pixel (i, 0)” are all white pixels and “0”, steps SH004 to SH010 are repeated until i attains to i=15. At the time when i attains to i=15 after performing step SH010, respective values are i=15, c=0 and len=15. In this state, the flow proceeds to step SH004. As m=15 and i=15, the flow further proceeds to step SH011.

In step SH011, if the condition “c=1” and “max<len” is satisfied, “max” is replaced by the value of “len” in step SH012. Otherwise, the flow proceeds to step SH013. At this time, the values are c=0, len=15 and max=0. Therefore, the flow proceeds to step SH013.

In step SH013, the maximum number of consecutive black pixels “maxhlen” in the horizontal direction that was previously obtained is compared with the maximum number of consecutive black pixels “max” of the present row. If “maxhlen<max”, “maxhlen” is replaced by the value of “max” in step SH014. Otherwise, step SH015 is executed. At this time, the values are maxhlen=0 and max=0, and therefore, the flow proceeds to step SH015.

In step SH015, the calculation j=j+1 is performed, that is, the value of pixel counter “j” for the vertical direction is incremented by 1. Since j=0 at this time, the result of the calculation is j=1, and the flow returns to SH002.

Thereafter, steps SH002 to SH015 are repeated for j=1 to 14. At the time when j attains to j=15 after step SH015 is performed, the value of pixel counter “j” for the vertical direction is compared with the maximum number of pixels “n” in the vertical direction. As a result of comparison, if j≧n, step SH016 is thereafter executed. Otherwise, step SH003 is executed. At this time, the values are j=15 and n=15, and therefore, the flow proceeds to step SH016.

In step SH016, “maxhlen” is output. As can be seen from the foregoing description and FIG. 4, the value of “max” of row “2” (y=2), namely “15” that is the maximum number of consecutive black pixels in the horizontal direction is stored as “maxhlen”. Therefore, “maxhlen=15” is output.

FIG. 7 is a flowchart of the process (step S2) for calculating the maximum number of consecutive black pixels “maxvlen” in the vertical direction, in the process (step T2a) for calculating the partial image feature value in accordance with Embodiment 1 of the present invention. It is apparent that the processes of steps SV001 to SV016 in FIG. 7 are basically the same as the processes shown in the flowchart of FIG. 6 described above, and therefore, a detailed description will not be repeated. As a result of execution of steps SV001 to SV016, “4”, which is the value of “max” in the x direction in FIG. 4, is output as the maximum number of consecutive black pixels “maxvlen” in the vertical direction.

The subsequent processes to be performed on “maxhlen” and “maxvlen” that are output through the above-described procedures will be described in detail, returning to step S3 of FIG. 5.

In step S3 of FIG. 5, “maxhlen”, “maxvlen” and a prescribed lower limit “hlen0” of the maximum number of consecutive black pixels are compared with each other. If maxhlen>maxvlen and maxhlen≧hlen0, then step S7 is executed, and otherwise, step S4 is executed. At this time, maxhlen=15 and maxvlen=4. Then, if “hlen0” is set to “2”, then the flow proceeds to step S7. In this step, “H” is output to the feature value storing area of the partial image “Ri” for the original image of reference image feature value memory 1024 or sample image feature value memory 1025, and a partial image feature value calculation end signal is transmitted to control unit 108.

If “hlen0” has been set to “5” in the above-described step, the flow next proceeds to step S4. If maxvlen>maxhlen and maxvlen≧vlen0, step S5 is executed next. Otherwise, step S6 is executed next. Here, since the values are maxhlen=15, maxvlen=4 and hlen0=5, the flow proceeds to step S6. “X” is output to the feature value storing area of the partial image “Ri” for the original image of reference image feature value memory 1024 or sample image feature value memory 1025, and the partial image feature value calculation end signal is transmitted to control unit 108.

Assuming that the output values in step S2 are maxhlen=4, maxvlen=15 and hlen0=2, if maxhlen>maxvlen and maxhlen≧hlen0 in step S3, step S7 is executed next, and otherwise, step S4 is executed next.

In step S4, if maxvlen>maxhlen and maxvlen≧vlen0, step S5 is executed next, and otherwise, step S6 is executed next.

In step S5, “V” is output to the feature value storing area of the partial image “Ri” for the original image of reference image feature value memory 1024 or sample image feature value memory 1025, and the partial image feature value calculation end signal is transmitted to control unit 108.

As described above, feature value calculating unit 1045 in accordance with Embodiment 1 extracts (specifies) each of pixel strings in the horizontal and vertical directions of the partial image “Ri” of the image on which the calculation is performed (see FIG. 4) and, based on the number of consecutive black pixels in each extracted string of pixels, determines whether the pattern of the partial image has a tendency to extend in the horizontal direction (for example, tendency to be horizontal stripes) or a tendency to extend in the vertical direction (for example, tendency to be vertical stripes) or neither of these them, so as to output a value corresponding to the result of the determination (any of “H”, “V” and “X”). The output value represents the feature value of the partial image. Although the feature value is calculated here based on the number of consecutive black pixels, the feature value may be calculated in a similar manner based on the number of consecutive white pixels.

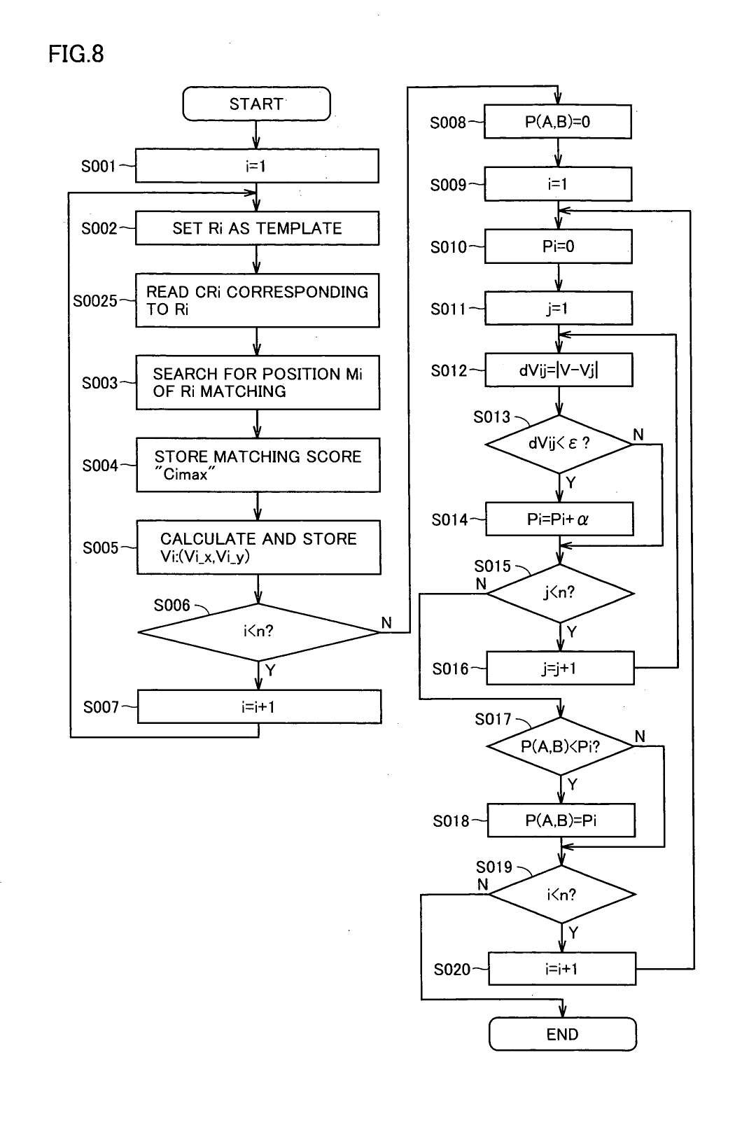

On images “A” and “B” which have been image-corrected by image correcting unit 104 and for which partial image feature values have been calculated by feature value calculating unit 1045 in the manner described above, similarity score calculation, that is, a comparing process (step T3) is performed. The process will be described with reference to the flowchart of FIG. 8.

Control unit 108 transmits a template matching start signal to maximum matching score position searching unit 105, and waits until receiving a template matching end signal. Maximum matching score position searching unit 105 starts a template matching process represented by steps S001 to S007. In step S001, a counter variable “i” is initialized to “1”. In step S002, an image of a partial area defined as a partial image “Ri” of image “A” is set as a template to be used for the template matching. Although the partial image “Ri” is rectangular in shape for simplifying the calculation, the shape is not limited thereto.

In step S0025, the result of the calculation of the feature value “CRi” (hereinafter simply referred to as feature value CRi) for a reference partial image corresponding to the partial image “Ri”, which is obtained through the process in FIG. 5, is read from memory 1024.

In step S003, a location of image “B” having the highest score of matching with the template set in step S002, that is, a portion, within the image, at which the data matches with the template to the highest degree, is searched for. In order to reduce the burden of the search process, the following calculation is performed only on a partial area having the result of calculation of the feature value “CM” (hereinafter simply referred to as feature value CM), which is obtained through the process in FIG. 5, of a sample image corresponding to image “B”, and which is the same as the feature value “CRi” of the partial image “Ri” of image “A”. Here, the pixel density of coordinates (x, y) relative to the upper left corner of the partial image “Ri” used as the template is represented as “Ri (x, y)”, the pixel density of coordinates (s, t) relative to the upper left corner of image “B” is represented as “B (s, t)”, the width and height of the partial image “Ri” are represented as “w” and “h” respectively, and a possible maximum density of each pixel in images “A” and “B” is represented as “V0”. Then, the matching score “Ci (s, t)” at coordinates (s, t) of image “B” is calculated according to the following equation (1) for example, based on the difference in density between pixels.

$$Ci ( s , t ) = {\sum }_{y = 1}^{h} {\sum }_{x = 1}^{w} ( V 0 - \vert Ri ( x , y ) - B ( s + x , t + y ) \vert ) \qquad ( 1 )$$

In image “B”, coordinates (s, t) are successively updated and the matching score “C (s, t)” at the coordinates (s, t) is calculated. A position having the highest matching score is considered as the position with the maximum matching score, the image of the partial area at that position is represented as partial area “Mi”, and the matching score at that position is represented as maximum matching score “Cimax”. In step S004, the maximum matching score “Cimax” in image “B” relative to the partial image “Ri” that is calculated in step S003 is stored in a prescribed address of memory 102. In step S005, a movement vector “Vi” is calculated in accordance with the following equation (2) and stored at a prescribed address of memory 102.

Here, it is supposed that, based on the partial image “Ri” at a position “P” that is set in image “A”, image “B” is scanned to locate a partial area “Mi” at a position “M” having the highest score of matching with the partial image “Ri”. Then, a directional vector from position “P” to position “M” is herein referred to as a movement vector “Vi”. This is because image “B” seems to have moved relative to the other image, namely image “A” for example, as the finger may be placed differently on fingerprint sensor 100.
Vi=(Vix, Viy)=(Mix−Rix, Miy−Riy) (2)

In equation (2), variables “Rix” and “Riy” are x and y coordinates of the reference position of partial image “Ri”, that correspond, by way of example, to the coordinates of the upper left corner of partial image “Ri” in image “A”. Variables “Mix” and “Miy” are x and y coordinates of the position of the maximum matching score “Cimax” that is obtained as a result of the search for the aforementioned partial area “Mi”, which corresponds, by way of example, to the coordinates of the upper left corner of partial area “Mi” at the matching position in image “B”. It is supposed here that the total number of partial images “Ri” in image “A” is variable “n” that is set (stored) in advance.

In step S006, it is determined whether or not the counter variable “i” is equal to or smaller than the total number of partial areas “n”. If the variable “i” is equal to or smaller than the total number “n” of partial areas, the flow proceeds to step S007, and otherwise, the flow proceeds to step S008. In step S007, “1” is added to variable “i”. Thereafter, while variable “i” is equal to or smaller than the total number “n” of partial areas, steps S002 to S007 are repeated. Namely, for all partial images “Ri”, the template matching is performed on limited partial areas that have feature value “CM” in image “B” identical to feature value “CRi” of partial image “Ri” in image “A”. Then, for each partial image “Ri”, the maximum matching score “Cimax” and movement vector “Vi” are calculated.

Maximum matching score position searching unit 105 stores the maximum matching score “Cimax” and movement vector “Vi” for every partial image “Ri” calculated successively as described above, at prescribed addresses of memory 102, and thereafter transmits the template matching end signal to control unit 108 to end this process.

Thereafter, control unit 108 transmits a similarity score calculation start signal to similarity score calculating unit 106, and waits until receiving a similarity score calculation end signal. Similarity score calculating unit 106 calculates the similarity score through the process of steps S008 to S020 of FIG. 8, using such information as movement vector “Vi” and the maximum matching score “Cimax” for each partial image “Ri” obtained by the template matching and stored in memory 102.

In step S008, similarity score “P (A, B)” is initialized to 0. Here, similarity score “P (A, B)” is a variable for storing the degree of similarity between images “A” and “B”. In step S009, an index “i” of movement vector “Vi” to be uses as a reference is initialized to “1”. In step S010, similarity score “Pi” concerning the reference movement vector “Vi” is initialized to “0”. In step S011, an index “j” of movement vector “Vj” is initialized to “1”. In step S012, a vector difference “dVij” between reference movement vector “Vi” and movement vector “Vj” is calculated in accordance with the following equation (3).
dVij=|Vi−Vj|=sqrt(Vix−Vjx)ˆ2+(Viy−Vjy)ˆ2) (3)

Here, variables “Vix” and “Viy” represent “x” direction and “y” direction components, respectively, of movement vector “Vi”, variables “Vjx” and “Vjy” represent “x” direction and “y” direction components, respectively, of movement vector “Vj”, variable “sqrt (X)” represents square root of “X” and “Xˆ2” represents an expression for calculating the square of “X”.

In step S013, vector difference “dVij” between movement vectors “Vi” and “Vj” is compared with a prescribed constant value “ε”, so as to determine whether movement vectors “Vi” and “Vj” can be regarded as substantially the same vectors. If vector difference “dVij” is smaller than constant “ε”, movement vectors “Vi” and “Vj” are regarded as substantially the same vectors, and the flow proceeds to step S014. If the difference is larger than the constant, the movement vectors are not regarded as substantially identical, and the flow proceeds to step S015. In step S014, similarity score “Pi” is incremented in accordance with equations (4) to (6).
Pi=Pi+α (4)
α=1 (5)
α=Cjmax (6)

In equation (4), variable “α” is a value for incrementing similarity score “Pi”. If “α” is set to 1, namely “α=1” as represented by equation (5), similarity score “Pi” represents the number of partial areas that have the same movement vector as reference movement vector “Vi”. If “α” is set to Cjmax, namely “α=Cjmax” as represented by equation (6), similarity score “Pi” represents the total sum of the maximum matching scores obtained through the template matching of partial areas that have the same movement vector as reference movement vector “Vi”. The value of variable “α” may be made smaller, in accordance with the magnitude of vector difference “dVij”.

In step S015, it is determined whether or not the value of index “j” is smaller than the total number “n” of partial areas. If the value of index “j” is smaller than the total number “n” of partial areas, the flow proceeds to step S016, and if larger, the flow proceeds to step S017. In step S016, the value of index “j” is incremented by 1. By the process from steps S010 to S016, similarity score “Pi” is calculated, using the information about partial areas determined to have the same movement vector as reference movement vector “Vi”. In step S017, similarity score “Pi” using movement vector “Vi” as a reference is compared with variable “P (A, B)”. If the result of the comparison shows that similarity score “Pi” is larger than the highest similarity score (value of variable “P (A, B)”) obtained by that time, the flow proceeds to step S018, and otherwise the flow proceeds to step S019.

In step S018, the value of similarity score “Pi” relative to movement vector “Vi” is set as variable “P (A, B)”. In steps S017 and S018, if similarity score “Pi” relative to movement vector “Vi” is larger than the maximum value of the similarity score (value of variable “P (A, B)”) calculated by that time relative to other movement vectors, reference movement vector “Vi” is regarded as the most appropriate reference vector among movement vectors “Vi” indicated by the value of index “i” that have been used.

In step S019, the value of index “i” of reference movement vector “Vi” is compared with the number (value of variable “n”) of partial areas. If the value of index “i” is smaller than the number “n” of partial areas, the flow proceeds to step S020. In step S020, the value of index “i” is incremented by 1.

Through steps S008 to S020, the degree of similarity between images “A” and “B” is calculated as the value of variable “P (A, B)”. Similarity score calculating unit 106 stores the value of variable “P (A, B)” calculated in the above described manner at a prescribed address of memory 102, and transmits the similarity score calculation end signal to control unit 108 to end the process.

Thereafter, control unit 108 transmits a comparison/determination start signal to comparison/determination unit 107, and waits until receiving a comparison/determination end signal. Comparison/determination unit 107 makes a comparison and a determination (step T4). Specifically, the similarity score represented by the value of variable “P (A, B)” stored in memory 102 is compared with a predetermined comparison threshold “T”. As a result of the comparison, if the relation P (A, B)≧T is satisfied, it is determined that images “A” and “B” are taken from the same one fingerprint, a value, for example, “1”, indicating a “match” is written to a prescribed address of calculation memory 1022 as a result of the comparison, and if not, the images are determined to be taken from different fingerprints and a value, for example, “0”, indicating a “mismatch” is written to a prescribed address of calculation memory 1022, as a result of the comparison. Thereafter, the comparison determination end signal is transmitted to control unit 108 to end the process.

Finally, control unit 108 outputs the result of the comparison (“match” or “mismatch”) stored in calculation memory 1022 through display 610 or printer 690 (step T5), and the image comparing process is completed.

In the present embodiment, a part of or all of the image correcting unit 104, feature value calculating unit 1045, maximum matching score position searching unit 105, similarity score calculating unit 106, comparison/determination unit 107 and control unit 108 may be implemented by a ROM such as memory 624 storing the process procedure as a program and a processor such as CPU 622.

A specific example of the comparing process in accordance with Embodiment 1 and effects attained thereby will be described. As described above, the comparing process which is characteristic of the present embodiment is the partial image feature value calculating process (T2a) and the similarity score calculating process (T3) of the flowchart in FIG. 3. Therefore, in the following, a description is given of images on which the image input (T1) and the image correction (T2) steps have already been performed.

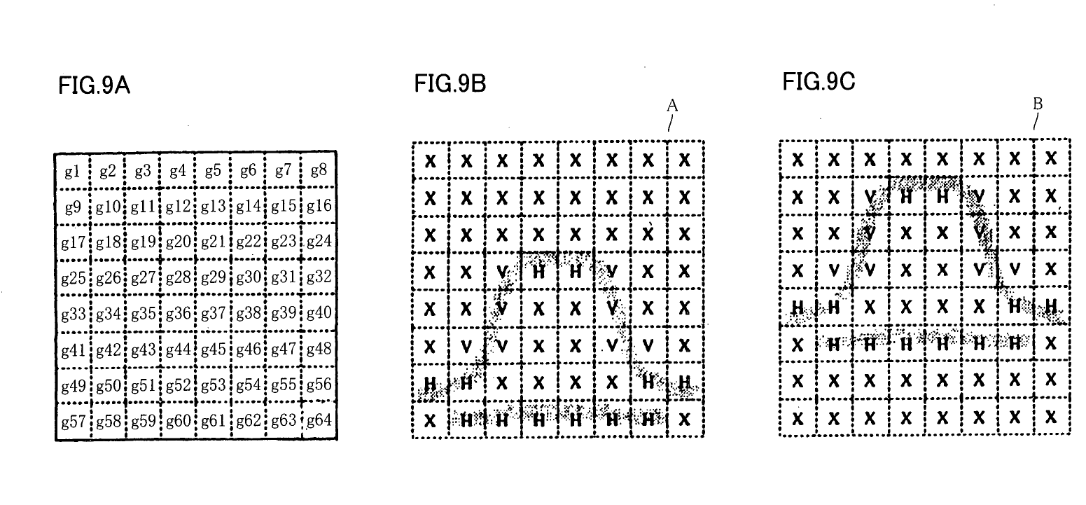

FIG. 9B shows an image “A” that has been subjected to the steps of image input (T1) and image correction (T2) and then stored in sample image memory 1023. FIG. 9C shows an image “B” that has been subjected to the steps of image input (T1) and image correction (T2) and then stored in reference image memory 1021. The comparing process described above will be applied to images “A” and “B”, in the following manner.

First, referring to FIG. 9A, how to specify the positions of partial images in an image will be described. The shape (form, size) of the image in FIG. 9A is the same as that of images “A” and “B” in FIGS. 9B and 9C. The image in FIG. 9A is divided like a mesh into 64 partial images each having the same (rectangular) shape. Numerical values 1 to 64 are allocated to these 64 partial images from the upper right one to the lower left one of FIG. 9A, to identify the positions of 64 partial images in the image. Here, 64 partial images are identified using the numerical values indicating the corresponding positions, such as partial images “g1”, “g2”, . . . “g64”. As the images of FIGS. 9A, 9B and 9C are identical in shape, the images “A” and “B” of FIGS. 9B and 9C may also be divided into 64 partial images and the positions can be identified similarly as partial images “g1”, “g2”, . . . “g64”.

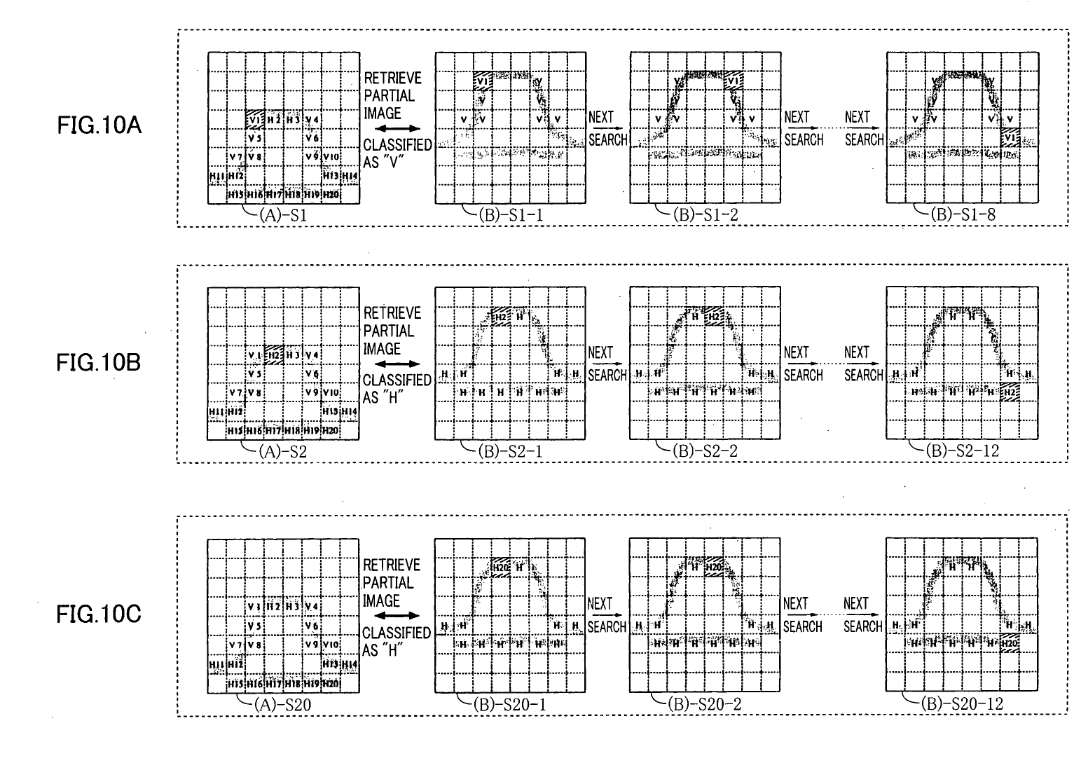

FIGS. 10A to 10C illustrate the procedure for comparing images “A” and “B” with each other. As described above, in Embodiment 1, image “B” is searched for a partial image having its feature value corresponding to feature value “H” or “V” of a partial image in image “A”. Therefore, among the partial images of image “A”, the first partial image having the partial image feature value “H” or “V” is the first partial image for which the search is conducted. The image (A)-S1 shown in FIG. 10A is an image having partial image “g27” that is first identified as a partial image with feature value “H” or “V” when respective feature values of partial images “g1” to “g64” of image “A” are successively read from the memory in this order, and the identified partial image, namely “V1”, is indicated by hatching.

As can be seen from this image (A)-S1, the first partial image feature value is “V”. Therefore, among partial images of image “B”, the partial images having the partial image feature value “V” are to be searched for. The image (B)-S1-1 of FIG. 10A shows image “B” in which partial image “g11” that is first identified as a partial image having feature value “V”, that is, “V1” is hatched. On this identified partial image, the process of steps S002 to S007 of FIG. 8 is performed. Thereafter, the process is performed on partial image “g14” having feature value “V” subsequently to partial image “g11”, that is, “V1” (image (B)-S1-2 of FIG. 10A), and thereafter performed on partial images “g19”, “g22”, “g26”, “g27”, “g30” and “g31” (image (B)-S1-8 of FIG. 10A). Thus, the process is completed for partial image “g27” that is first identified as a partial image having feature value “H” or “V” in image “A”. Then the process of steps S002 to S007 of FIG. 8 is performed similarly for partial image “g28” that is next identified as a partial image having feature value “H” or “V” (image (A)-S2 of FIG. 10B). As the feature value of partial image “g28” is “H”, the process is performed on partial image “g12” (image (B)-S2-1 of FIG. 10B), image “g13” (image (B)-S2-2 of FIG. 10B) and “g33”, “g34”, “g39”, “g40”, “g42” to “g46” and “g47” (image (B)-S2-12 of FIG. 10B) that have feature value of“H” in image “B”. Thereafter, for partial images “g29”, “g30”, “g35”, “g 3838 , “g42”, “g43”, “g46”, “g47”, “g49”, “g50”, g55”, “g56”, “g58” to “g62”and “g63” (image (A)-S20 of FIG. 10C) that have feature value “H” or “V” in image “A”, the process is performed similarly to the one described with reference to image (B)-S20-1, image (B)-S20-2, . . . image (B)-S20-12.

The number of partial images for which the search is conducted in images “A” and “B” in the present embodiment is given by the expression: (the number of partial images in image “A” that have partial image feature value “V”×the number of partial images in image “B” that have partial image feature value “V”+the number of partial images in image “A” that have partial image feature value “H”×the number of partial images in image “B” that have partial image feature value “H”).

The number of partial images searched by the procedure of Embodiment 1 in the example shown in FIGS. 10A to 10C is 8×8+12×12=208.

Since the partial image feature value in accordance with the present embodiment depends also on the pattern of the image, an example having a pattern different from that of FIGS. 9B and 9C will be described. FIGS. 11A and 11B show a sample image “A” and a reference image “B” different from images “A” and “B” of FIGS. 9B and 9C, and FIG. 11C shows a reference image “C” different in pattern from reference image “B” of FIG. 9C.

FIGS. 11D, 11E and 11F show respective feature values of partial images “g1” to “g64” of images “A”, “B” and “C” shown respectively in FIGS. 11A, 11B and 11C.

For sample image “A” shown in FIG. 11A, the number of partial images to be searched for in reference image “C” shown in FIG. 11C is similarly given by the expression: (the number of partial images in image “A” having feature value “V”×the number of partial images in image “C” having feature value “V” +the number of partial images in image “A” having feature value “H”×the number of partial images in image “C” having feature value “H”). Referring to FIGS. 11D and 11F, the number of partial images to be searched for is 8×12+12×16=288.

Although the areas having the same partial image feature value are searched for according to the description above, the present invention is not necessarily applied to this. When the feature value of a reference partial image is “H”, the areas of a sample image that have partial image feature values “H” and “X” may be searched for and, when the feature value of a reference partial image is “V”, the areas of a sample image that have the partial image feature values “V” and “X” may be searched for, so as to improve accuracy in the comparing process.

Feature value “X” means that the correlated partial image has a pattern that cannot be specified as vertical stripe or horizontal stripe. In order to increase the speed of the comparing process, partial areas having feature value “X” may be excluded from the scope of search by maximum matching score position searching unit 105.

Embodiment 2

In accordance with Embodiment 2, a technique is shown that enables faster comparison when a large number of reference images are prepared for comparison with a sample image. Specifically, a large number of reference images are classified into a plurality of categories in advance. When the sample image is input, it is determined which category the sample image belongs to, and the sample image is compared with each of the reference images belonging to the category selected in view of the category known from the determination.

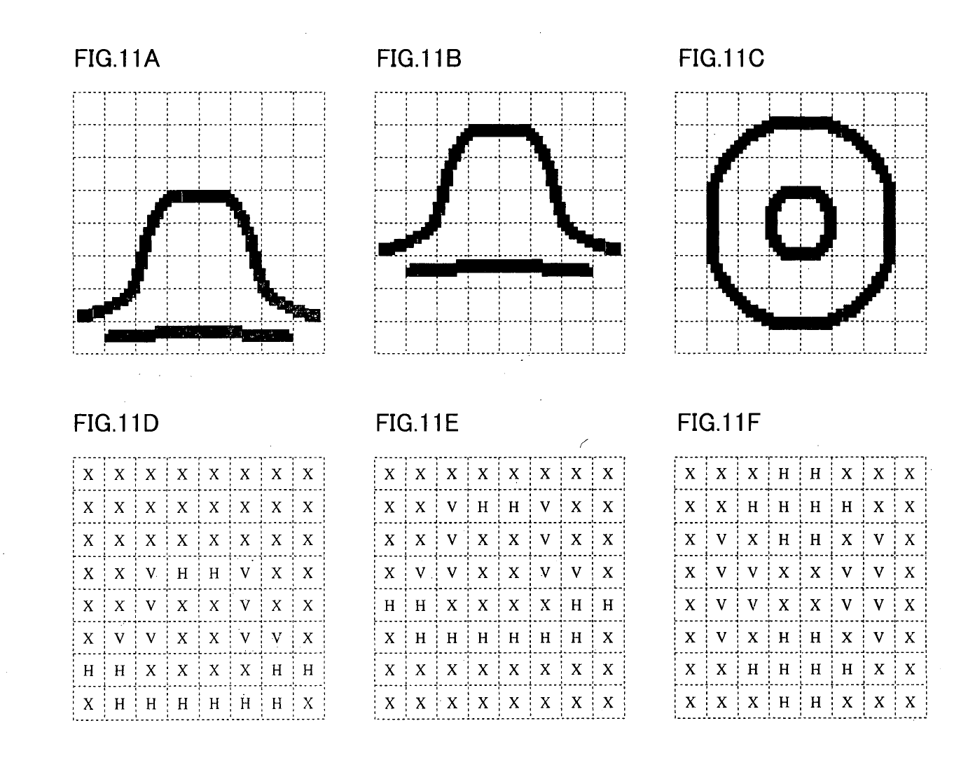

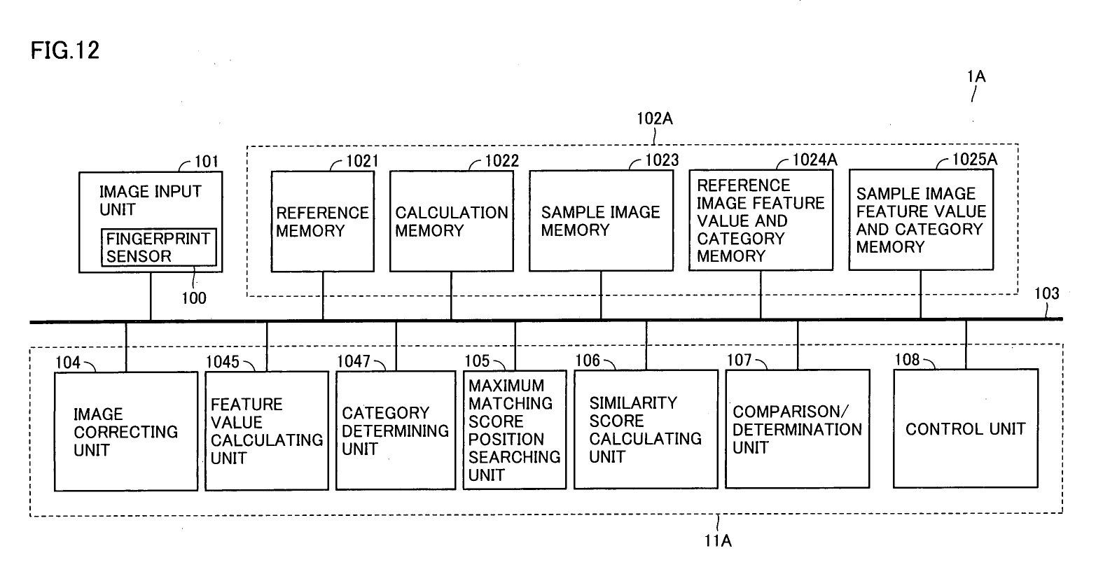

FIG. 12 shows a configuration of an image comparing apparatus 1A in accordance with Embodiment 2. Image comparing apparatus 1A of FIG. 12 differs from image comparing apparatus 1 of FIG. 1 in that comparing unit 11A has, in addition to the components of comparing unit 11 shown in FIG. 1, a category determining unit 1047, and that a memory 102A has, instead of reference image feature value memory 1024 and sample image feature value memory 1025, a reference image feature value and category memory 1024A (hereinafter simply referred to as memory 1024A) and a sample image feature value and category memory 1025A (hereinafter simply referred to as memory 1025A). Other portions of memory 102A are the same as those of memory 102 shown in FIG. 1. Functions of feature value calculating unit 1045, category determining unit 1047 and maximum matching score position searching unit 105 are those as will be described in the following. The functions of other portions of comparing unit 11A are the same as those of comparing unit 11. The function of each component in comparing unit 11A is implemented through reading of a relevant program from memory 624 and execution thereof by CPU 622.

Feature value calculating unit 1045 calculates, for each of a plurality of partial area images set in an image, a value corresponding to the pattern of the partial image, and stores in memory 1024A the result of the calculation related to the reference memory as a partial image feature value and stores in memory 1025A the result of calculation related to the sample image memory as a partial image feature value.

Category determining unit 1047 performs the following process beforehand. Specifically, it performs a calculation to classify a plurality of reference images into categories. At this time, the images are classified into categories based on a combination of feature values of partial images at specific portions of respective reference images, and the result of classification is registered, together with image information, in memory 1024A.

When an image to be compared is input, category determining unit 1047 reads partial image feature values from memory 1025A, finds a combination of feature values of partial images at specific positions, and determines which category the combination of feature values belongs to. Information on the determination result is output, which indicates that only the reference images belonging to the same category as the determined one should be searched by maximum matching score position searching unit 105, or indicates that maximum matching score position searching unit 105 should search reference images with the reference images belonging to the same category given highest priority.

Maximum matching score position searching unit 105 specifies at least one reference image as an image to be compared, based on the information on the determination that is output from category determining unit 1047. On each of the input sample image and the specified reference image, the template matching process is performed in a similar manner to the one described above, with the scope of search limited in accordance with the partial image feature values calculated by feature value calculating unit 1045.

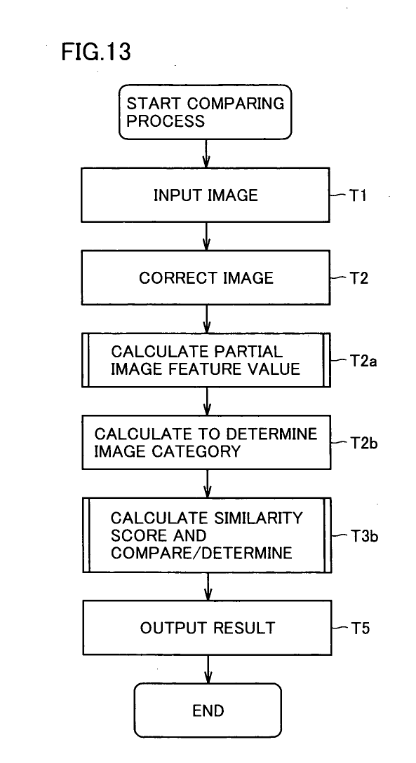

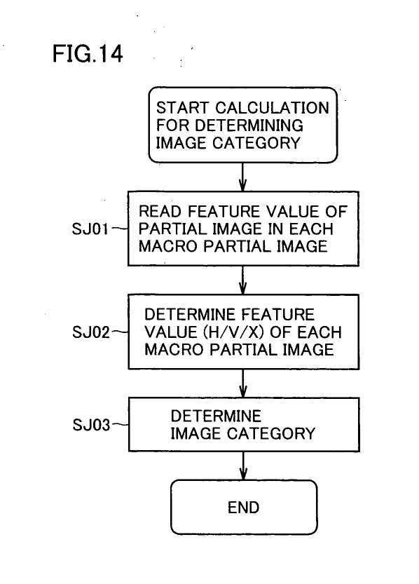

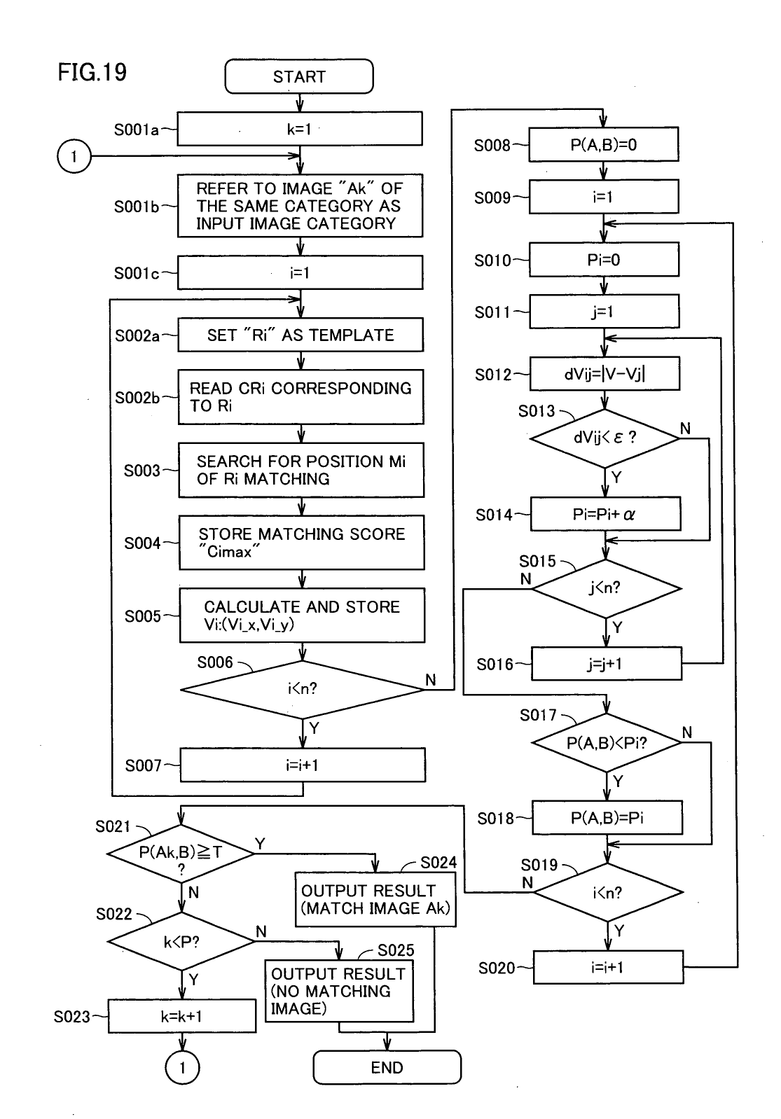

FIG. 13 is a flowchart showing the procedure of a comparing process in accordance with Embodiment 2. Compared with the flowchart of FIG. 3, the flow of FIG. 13 is different in that in place of the processes for calculating similarity score (T3) and for comparison and determination (T4), the processes for calculation to determine image category (T2b) and for calculating similarity score and comparison/determination (T3b) are provided. Other process steps of FIG. 13 are the same as those of FIG. 3. FIG. 19 is a flowchart showing the process for calculating similarity score and making comparison and determination (T3b), and FIG. 14 is a flowchart showing the process for calculation to determine image category (T2b).

In the image comparing process, image correction is made on a sample image by image correcting unit 104 (T2) in a similar manner to that in Embodiment 1, and thereafter, the feature value of each partial image is calculated for the sample and reference images by feature value calculating unit 1045. The process for determining image category (T2b) is performed on the sample image and the reference image on which the above-described calculation is performed, by category determining unit 1047. This procedure will be described in accordance with the flowchart of FIG. 14.

First, the partial image feature value of each macro partial image is read from memory 1025A (step (hereinafter simply denoted by SJ) SJ01). Specific operations are as follows.

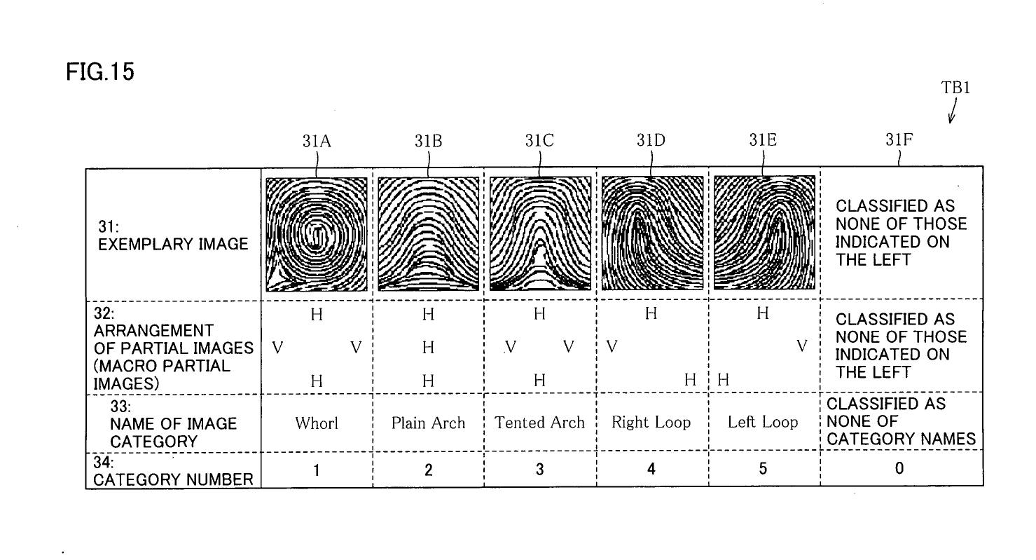

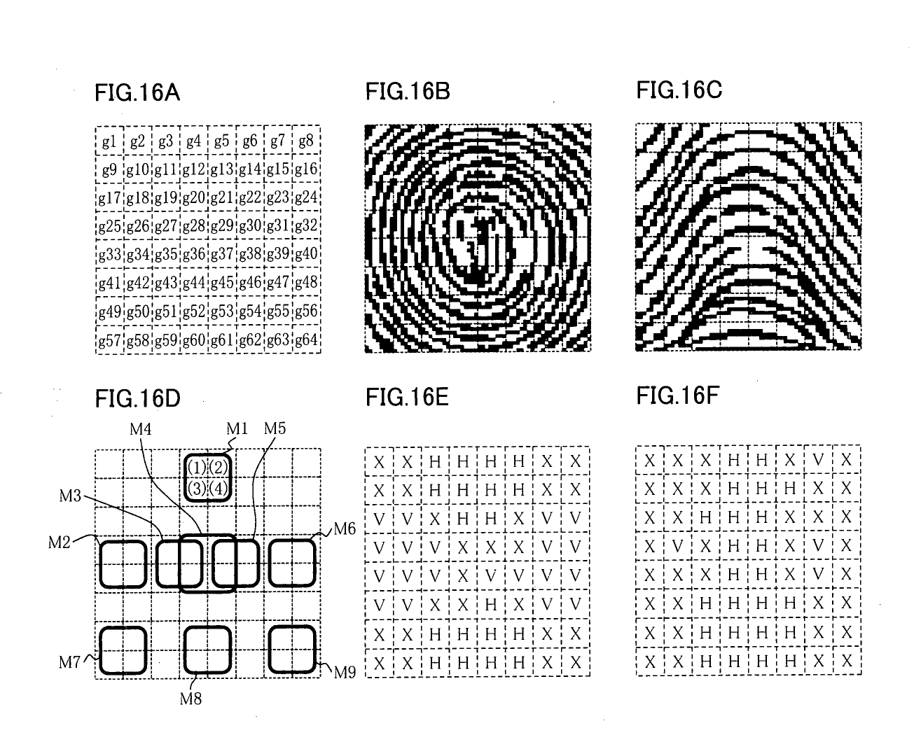

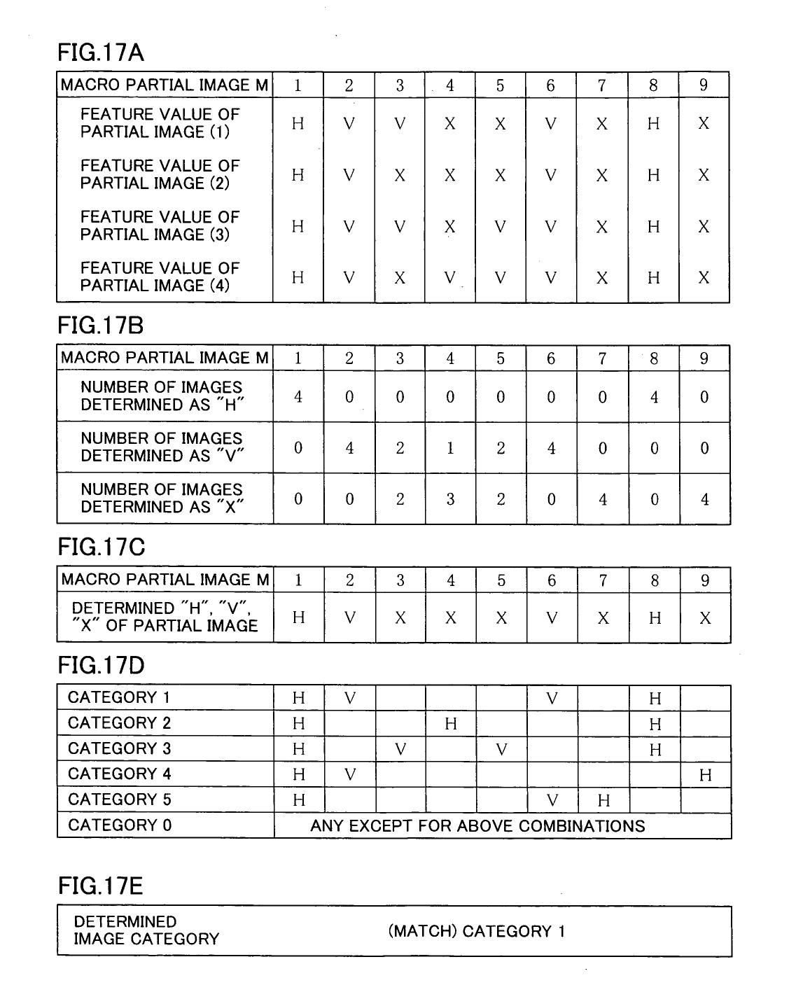

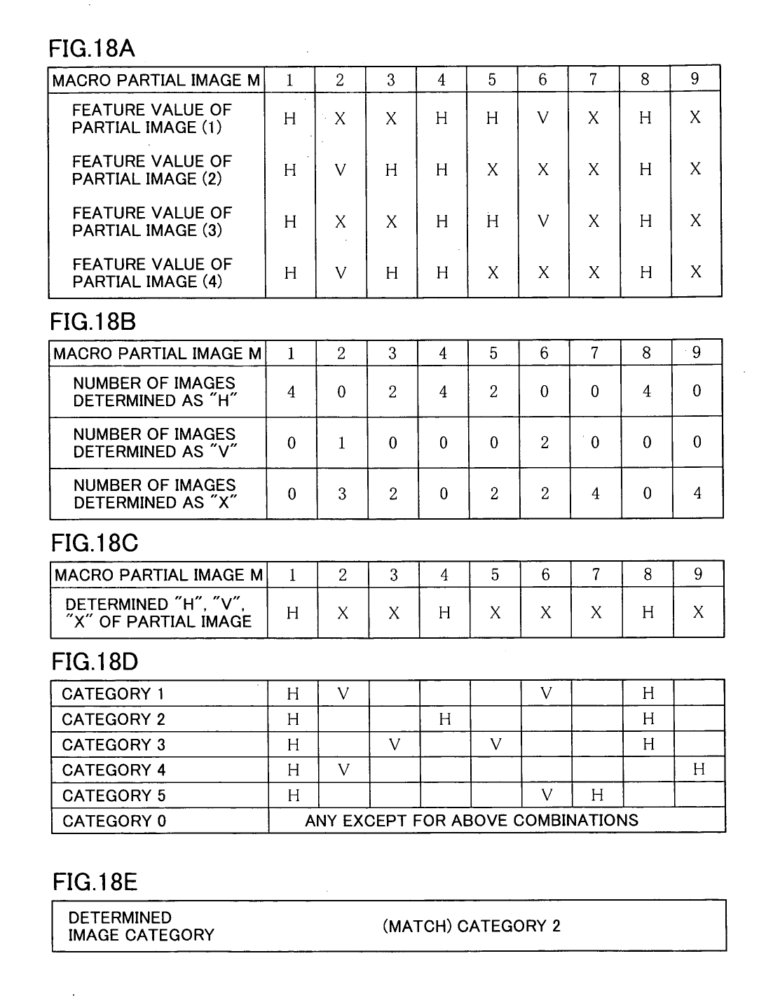

It is supposed here that images to be processed are fingerprint images. In this case, as is already known, fingerprint patterns are classified, by way of example, into five categories like those shown in FIG. 15. In Table TB1 of FIG. 15, data 32 to 34 respectively representing the arrangement of partial images (macro partial images), the image category name and the category number are registered for each of data 31 representing known image examples of fingerprints. Table TB1 is stored in advance in memory 624, and referred to as needed by image category determining unit 1047 for determining the category. Data 32 is also shown in FIGS. 17D and 18D, which will be described later.

In table TB1, data 31 of fingerprint image examples are registered, which include whorl image data 31A, plain arch image data 31B, tented arch image data 31C, right loop image data 31D, left loop image data 31E and image data 31F that does not correspond to any of these types of data. When the characteristics of these data are utilized and both of reference and sample images to be compared are limited to those in the same category, the amount of processing necessary for the comparison would be reduced. If the feature values of partial images can be utilized for the categorization, the categorization would be achieved with a smaller amount of processing.

Referring to FIGS. 16A to 16F, the contents registered in table TB1 of FIG. 15 will be described. FIGS. 16B and 16C schematically illustrate an input (sample) image and a reference image, respectively, which are each divided into 8 sections in the vertical and horizontal directions each. Namely, each image is shown to be comprised of 64 partial images. FIG. 16A defines, as FIG. 9A described above, positions “g1” to “g64” for each of the partial images of FIGS. 16B and 16C.

FIG. 16D defines macro partial images M1 to M9 of the image in accordance with the present embodiment. In the present embodiment, the macro partial image refers to a combination of a plurality of specific partial images indicated by positions “g1” to “g64” of the sample image or the reference image. In the present embodiment, each of macro partial images M1 to M9 shown in FIG. 16D is a combination of four partial images (in FIG. 16D, partial images (1) to (4) of macro partial image M1 for example). In the present embodiment, it is supposed that there are nine macro partial images M1 to M9 per image. The number of macro partial images per image is not limited to nine, and the number of partial images constituting one macro partial image is not limited to four. Partial images constituting macro partial images M1 to M9 are those shown below using partial images “g1” to “g64 ”.
Macro partial image M1 [symbol] g4, g5, g12, g13
Macro partial image M2 [symbol] g25, g26, g33, g34
Macro partial image M3 [symbol] g27, g28, g35, g36
Macro partial image M4 [symbol] g28, g29, g36, g37
Macro partial image M5 [symbol] g29, g30, g37, g38
Macro partial image M6 [symbol] g31, g32, g39, g40
Macro partial image M7 [symbol] g49, g50, g57, g58
Macro partial image M8 [symbol] g52, g53, g60, g61
Macro partial image M9 [symbol] g55, g56, g63, g64

For each of macro partial images M1 to M9, respective feature values of partial images constituting the macro image are read from memory 1025A (SJ01). Respective feature values of the partial images of the images shown in FIGS. 16B and 16C respectively are given in FIGS. 16E and 16F respectively. FIG. 17A shows feature values of four partial images (1) to (4) read for each of macro partial images M1 to M9 of the image corresponding to FIGS. 16B and 16E.

Thereafter, the feature value of each macro partial image is identified as “H”, “V” or “X” (SJ02). This procedure will be described.

In the present embodiment, if three or four partial images among the four partial images (1) to (4) constituting each macro partial image all have feature value “H”, the feature value of the macro partial image is determined to be “H”. If they all have the feature value “V”, it is determined to be “V”, and otherwise, “X”.

A specific example will be described. Regarding the image shown in FIG. 16B, four partial images (1) to (4) constituting macro partial image M1 have feature values “H”, “H”, “H” and “H”, and there is no partial image that has feature value “V” or “X” (see FIGS. 17A, 17B). Therefore, macro partial image M1 is determined to have feature value “H” (see FIG. 17C). Similarly, feature values of macro partial images M2 to M9 are determined to be “V”, “X”, “X”, “X”, “V”, “X”, “H” and “X”, respectively (see FIG. 17C).

Thereafter, referring to the result of the determination for each macro partial image, image category is determined (SJ03). The procedure of the determination will be described. First, a comparison is made with the arrangement of partial image groups having the fingerprint image features shown by image data 31A to 31F in FIG. 15. FIG. 17D shows feature values of macro partial images M1 to M9 of image data 31A to 31F, correlated with data 34 of category numbers.

From a comparison between FIGS. 17C and 17D, it can be seen that image data having macro partial images M1 to M9 with respective feature values identical to those of macro partial images Ml to M9 in FIG. 17C is image data 31A with category number data 34, “1”. In other words, a sample image (input image) corresponding to the image in FIG. 16B belongs to category “1”, namely the fingerprint image having the whorl pattern.

Similarly, an image corresponding to the image in FIG. 16C is processed as shown in FIGS. 18A to 18E, and determined to belong to category “2”. In other words, the image is determined to be a fingerprint image having the plain arch pattern.

Returning back to FIG. 13, the process for calculating the similarity score and making comparison and determination (T3b) is performed, taking into consideration the result of image category determination described above. This process will be described with reference to the flowchart of FIG. 19.

Control unit 108 transmits a template matching start signal to maximum matching score position searching unit 105, and waits until receiving a template matching end signal. Maximum matching score position searching unit 105 starts the template matching process represented by steps S001a to S001c, S002a to S002b and S003 to S007.

First, counter variable “k” (here, variable “k” represents the number of reference images that belong to the same category) is initialized to “1” (S001a). Next, a reference image “Ak” is referred to (S001b) that belongs to the same category as the category of the input image indicated by the result of determination which is output through the process of calculation for determining the image category (T2b). Then, counter variable “i” is initialized to “1” (S001c). An image of a partial area defined as partial image “Ri” in reference image “Ak” is set as a template to be used for the template matching (S002a, S002b). Thereafter, processes similar to those described with reference to FIG. 8 are performed on this reference image “Ak” and on the input image, in steps S003 to S020.

Thereafter, control unit 108 transmits a comparison/determination start signal to comparison/determination unit 107, and waits until receiving a comparison/determination end signal. Comparison/determination unit 107 makes comparison and determination. Specifically, the similarity score represented by the value of variable “P (Ak, B)” stored in memory 102 is compared with a predetermined comparison threshold “T” (step S021). If the result of the comparison is P (Ak, B)≧T, it is determined that reference image “Ak” and input image “B” are taken from the same fingerprint, and a value indicating a match, for example, “1” is written as the result of comparison at a prescribed address of memory 102 (S204). Otherwise, the images are determined to be taken from different fingerprints (N in S021). Subsequently, it is determined whether the condition, variable k<p (“p” represents the total number of reference images of the same category) is satisfied. If k<p is satisfied (Y in S022), that is, if there remains any reference image “Ak” of the same category that has not been compared, variable “k” is incremented by “1” (S023), the flow returns to step S001b to perform the similarity score calculation and the comparison again, using another reference image of the same category.

After the comparing process using that another reference image, the similarity score represented by the value of “P (Ak, B)” stored in memory 102 is compared with predetermined comparison threshold “T”. If the result is P (Ak, B)≧T (Y in step S021), it is determined that these images “Ak” and “B” are taken from the same fingerprint, and a value indicating a match, for example, “1” is written as the result of comparison at a prescribed address of memory 102 (S024). The comparison/determination end signal is transmitted to control unit 108, and the process is completed. In contrast, if P (Ak, B)≧T is not satisfied (N in step S021) and k<p is not satisfied (N in S022), which means there remains no reference image “Ak” of the same category that has not been compared, a value indicating a mismatch, for example, “0” is written as the result of comparison at a prescribed address of memory 102 (S025). Thereafter, the comparison/determination end signal is transmitted to control unit 108, and the process is completed. Thus, the similarity score calculation and comparison/determination process is completed.

Returning back to FIG. 13, finally, the result of comparison stored in memory 102 is output by control unit 108 to display 610 or to printer 690 (step T5), and the image comparison is completed.

In the present embodiment, a part of or all of image correcting unit 104, partial image feature value calculating unit 1045, image category determining unit 1047, maximum matching score position searching unit 105, similarity score calculating unit 106, comparison/determination unit 107 and control unit 108 may be implemented by a ROM such as memory 624 storing the process procedure as a program and a processor such as CPU 622.

A specific example of the comparing process in accordance with Embodiment 2 and effects attained thereby will be described.

As described above, the comparing process that is characteristic of the present embodiment is the process of calculation to determine the image category (T2b) and the process of calculating the similarity score and making comparison/determination (T3b) of the flowchart shown in FIG. 13. Therefore, in the following, description will be given assuming that images have been subjected in advance to the processes of image input (T1), image correction (T2) and partial image feature value calculation (T2a).

Here, it is supposed that 100 pieces of reference image data are stored in reference memory 1021 in the image comparing system, and that the patterns of the 100 reference images substantially evenly belong to the image categories of the present embodiment. With this supposition, it follows that 20 reference images belong to each category of Embodiment 2.

In Embodiment 1, it is expected that “match” as a result of the determination is obtained when an input image is compared with about 50 reference images on average, that is, a half of the total number of 100 reference images. According to Embodiment 2, the reference images to be compared are limited to those belonging to one category, by the calculation for determining the image category (T2b), prior to the comparing process. Therefore, in Embodiment 2, it is expected that “match” as a result of the determination is obtained when an input image is compared with about 10 reference images, that is, a half of the total number of reference images in each category.

Therefore, the amount of processing is considered to be (amount of processing for the similarity score determination and the comparison in Embodiment 2/amount of processing for the similarity score determination and the comparison in Embodiment 1)≈(1/number of categories). It is noted that, although Embodiment 2 requires an additional amount of processing for the calculation to determine the image category (T2b) prior to the comparing process, the source information used for this calculation, namely the feature values of partial images (1) to (4) belonging to each of macro partial images (see FIGS. 17A and 18A) is also used in Embodiment 1, and therefore, the amount of processing is not increased in Embodiment 2 relative to Embodiment 1.

The determination of the feature value for each macro partial image (see FIGS. 17C and 18C) and the determination of the image category (see FIGS. 17E and 18E) correspond to the comparing process requiring a small processing amount, as seen from a comparison between FIGS. 17D and 17E (or a comparison between FIGS. 18D and 18E), which is performed only once prior to the comparison with many reference images. Thus, apparently, the processing amount is practically negligible.

Although a plurality of reference images are stored in reference memory 1021 in advance in Embodiment 2, the reference images may be provided by using snap-shot images.

Embodiment 3

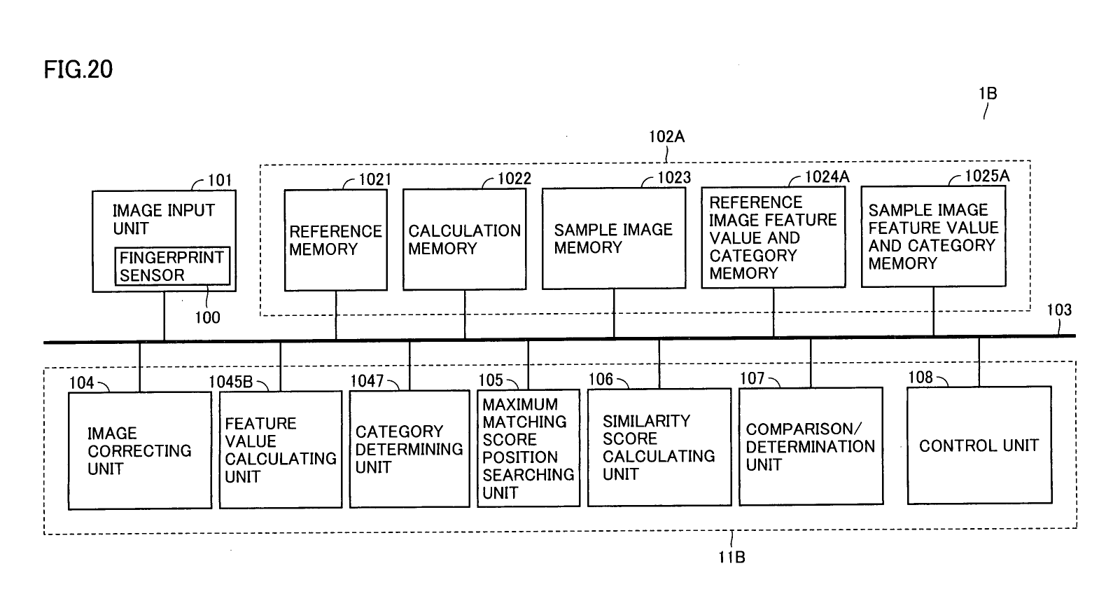

In accordance with Embodiment 3, the partial image feature value may be calculated in the configuration of FIG. 20 through the following procedure different from that of Embodiment 1. The configuration of FIG. 20 differs from that of FIG. 12 in that comparing unit 11A in FIG. 12 is replaced with a comparing unit 11B. Comparing unit 11B includes a feature value calculating unit 1045B instead of feature value calculating unit 1045. The configuration of FIG. 20 is similar to that of FIG. 12 except for feature value calculating unit 1045B.

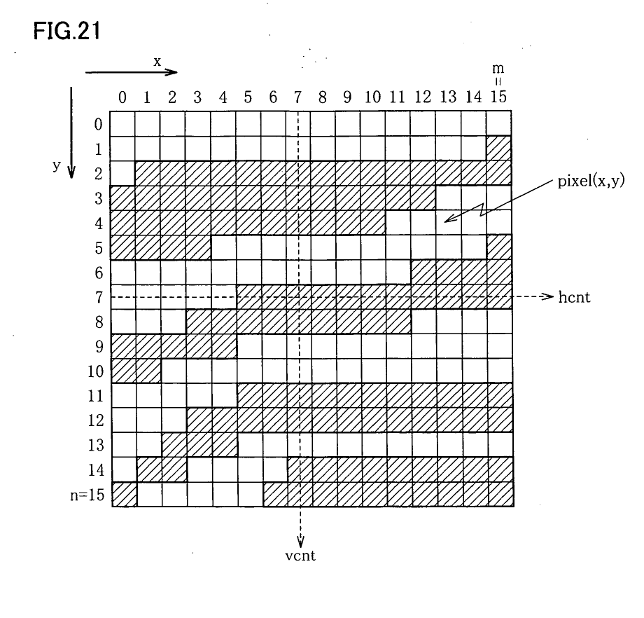

Outline of the calculation of the partial image feature value in accordance with Embodiment 3 will be described with reference to FIG. 21. FIG. 21 shows a partial image comprised of m×n pixels together with representative pixel strings respectively in the horizontal and vertical directions. Specifically, in the present embodiment, the pixel string of y=7 is the representative string in the horizontal direction (x direction) and the pixel string of x=7 is the representative string in the vertical direction (y direction). For each pixel string, there is shown for example the number of changes in value of pixel “pixel (x, y)”, namely, in one pixel string, the number of portions where adjacent pixels have different pixel values. In FIG. 21, the white pixel and the hatched pixel have different pixel values from each other. In the partial image shown in FIG. 21, the number of pixels in the horizontal direction and that in the vertical direction are each 16.

According to Embodiment 3, for the partial image on which the calculation is to be performed, the feature value is calculated by feature value calculating unit 1045B in the following manner. The number of changes “hcnt” in pixel value along the horizontal direction and the number of changes “vcnt” in pixel value along the vertical direction are detected, the detected number of changes “hcnt” in pixel value along the horizontal direction is compared with the detected number of changes “vcnt” in pixel value along the vertical direction. If the number of changes in the vertical direction is relatively larger, value “H” indicating “horizontal” is output. If the number of changes in the horizontal direction is relatively larger, value “V” indicating “vertical” is output, and otherwise, “X” is output.

Even if the value is determined to be “H” or “V” and output in the process described above, “X” is output if the number of changes in pixel value is smaller than a lower limit “cnt0” set in advance for both directions for determining changes in pixel value. The fact that lower limit “cnt0” is small means that the absolute value of changes in pattern within the partial image is small. In the extreme example in which cnt0=0, the partial area as a whole has a value or no value. In such a case, it is practically appropriate not to make the determination in terms of the horizontal and vertical. These conditions can be given by the following expressions. Namely, if hcnt<vcnt and max (hcnt, vcnt)≧cnt0, “H” is output; if hcnt>vcnt and max (hcnt, vcnt)≧cnt0, “V” is output. Otherwise, “X” is output. Here, max (hcnt, vcnt) represents the larger one of the number of changes “hcnt” and the number of changes “vcnt”.

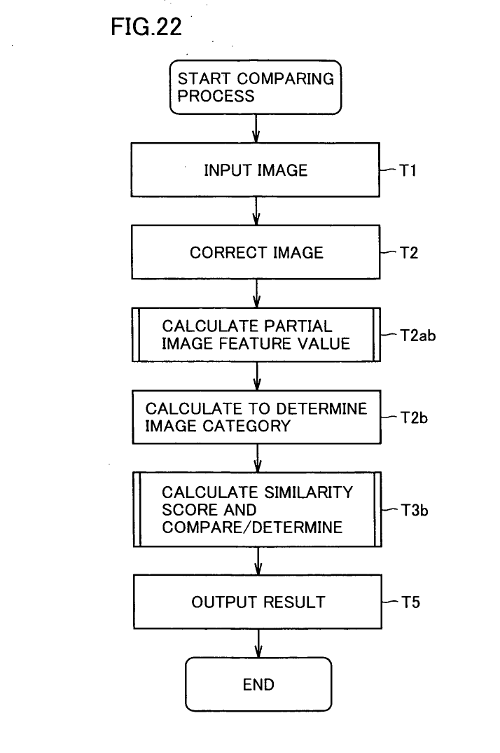

FIG. 22 shows a flowchart of the whole image comparing process in Embodiment 3. The procedure in FIG. 22 differs from that in FIG. 13 in that the partial image feature value calculation (T2a) in FIG. 13 is replaced with a partial image feature value calculation (T2ab). The procedure in FIG. 22 is similar to that in FIG. 13 except for this.

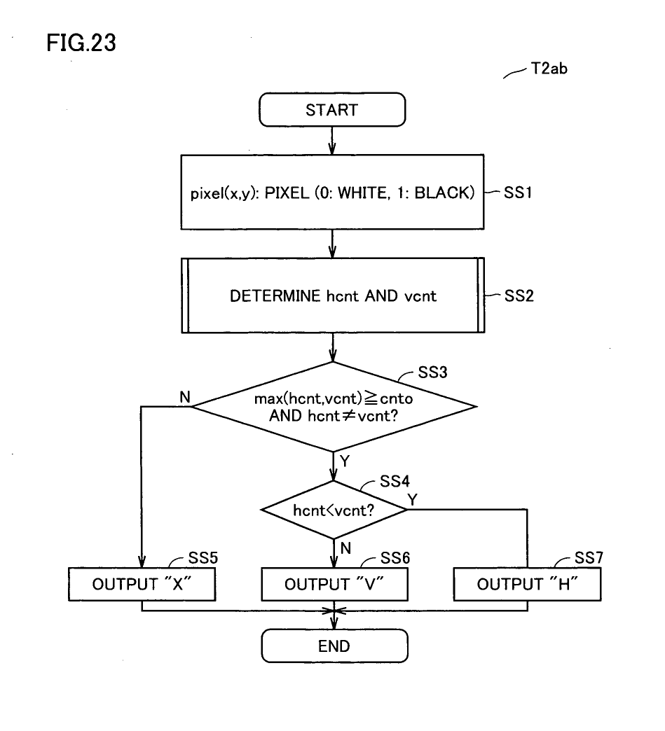

FIG. 23 is a flowchart showing the process for calculating the partial image feature value (T2ab) in accordance with Embodiment 3. The process of this flowchart is repeated respective times for “n” partial images “Ri” of a reference image in reference memory 1021 on which the calculation is to be performed, and the resultant values are stored in memory 1024A in correspondence with respective partial images “Ri”. Similarly, the process of this flowchart is repeated respective times for “n” partial images “Ri” of a sample image in sample image memory 1023, and the resultant values are stored in feature value memory 1025A, in correspondence with respective partial images “Ri”. In the following, details of the process for calculating the partial image feature value will be described with reference to the flowchart of FIG. 23.

Control unit 108 transmits a partial image feature value calculation start signal to feature value calculating unit 1045B, and then waits until receiving a partial image feature value calculation end signal. Feature value calculating unit 1045B reads partial image “Ri” for which the calculation is to be performed, from reference memory 1021 or from sample image memory 1023, and stores the same temporarily in calculation memory 1022 (step SS1).

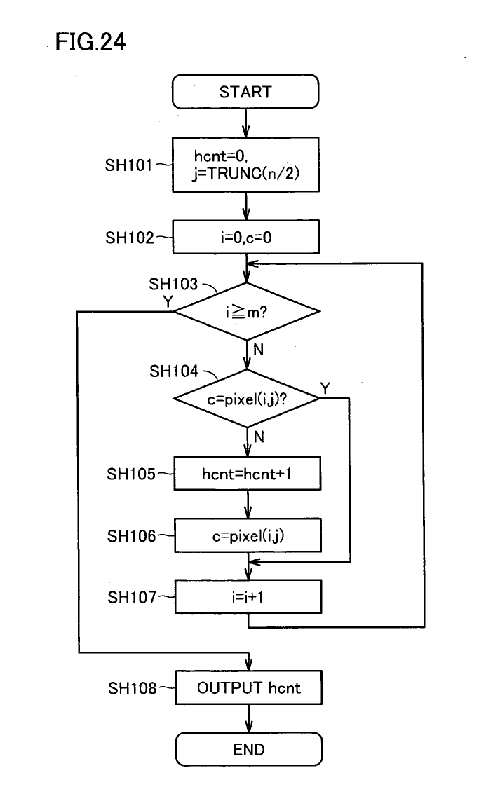

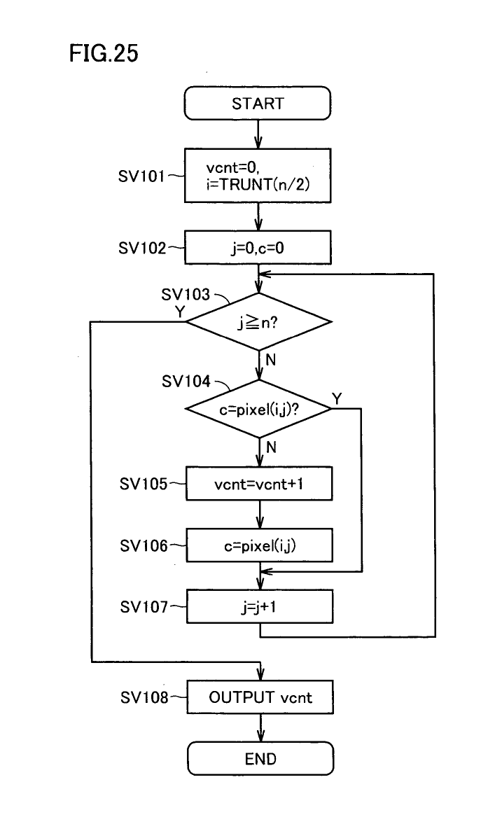

Feature value calculating unit 1045B reads the stored partial image “Ri”, and detects the number of changes in pixel value “hcnt” in the horizontal direction and the number of changes in pixel value “vcnt” in the vertical direction (step SS2). Here, the process for detecting the number of changes in pixel value “hcnt” in the horizontal direction and the number of changes in pixel value “vcnt” in the vertical direction will be described with reference to FIGS. 24 and 25.

FIG. 24 is a flowchart showing the process for detecting the number of changes in pixel value “hcnt” in the horizontal direction (step SS2) in the process for calculating the partial image feature value (step T2ab) in accordance with Embodiment 3 of the present invention. Referring to FIG. 24, feature value calculating unit 1045B reads partial image “Ri” from calculation memory 1022, initializes the number of changes in pixel value “hcnt” in the horizontal direction to hcnt=0, and determines coordinate “j” of a representative pixel string in the horizontal direction, in the present embodiment, to be half the maximum coordinate value “n” on the “y” axis truncated after the decimal point, namely j=TRUNC (n/2). Specifically, the coordinate is determined to be TRUNC (15/2)=7 (step SH101).

Thereafter, parameter “i” representing a coordinate value along the x axis and parameter “c” representing the pixel value are initialized to i=0 and c=0 (step SH102).

Then, parameter “i” representing the coordinate value along the x axis is compared with the maximum coordinate value “m” along the “x” axis (step SH103). If i≧m, step SH108 is executed, and otherwise, step SH104 is executed. In Embodiment 3, m=15 and i=0 at the start of processing, and therefore, the flow proceeds to step SH104.

Next, pixel (i, j) is compared with the parameter “c” representing the pixel value. If c=pixel (i, j), step SH107 is executed, and otherwise, step SH105 is executed. At present, i=0 and j=7. With reference to FIG. 21, this coordinate is pixel (0, 7)=0, which is equal to “c”. Thus, the flow proceeds to step SH107.

In step SH107, parameter “i” representing a coordinate value along the x axis is incremented by 1, and the flow proceeds to step SH103. Thereafter, the same process is repeatedly performed while i=1 to 4, and the flow again proceeds to step SH103 under the condition i=5. In this state, the relation i≧m is satisfied. Therefore, the flow proceeds to step SH104.

In step SH104, pixel (i, j) is compared with parameter “c” representing the pixel value, and if c=pixel (i, j), step SH107 is executed. Otherwise, step SH105 is executed next. At present, i=5, j=7 and c=0. With reference to FIG. 21, at this coordinate, pixel (5, 7)=1. Then, the flow proceeds to step SH105.

Next, in step SH105, since the pixel value in the horizontal direction changes, “hcnt” is incremented by 1. In order to further detect changes in pixel value, the present pixel value pixel (5, 7)=1 is input to parameter “c” representing the pixel value (step SH106).

Next, in step SH107, parameter “i” representing the coordinate value along the x axis is incremented by 1, and the flow proceeds to step SH103 with i=6.

Thereafter, while i=6 to 15, process steps SH103→SH104→SH107 are performed in a similar manner. When i attains to i=16, i≧m is satisfied in step SH103, so that the flow proceeds to step SH108 to output hcnt=1.

In FIG. 25, steps SV101 to SV108 are performed in the process for detecting the number of changes in pixel value “vcnt” in the vertical direction (step SS2) in the process of calculating the partial image feature value in accordance with Embodiment 3 of the present invention. Here, it is apparent that steps SV101 to SV108 are basically similar to the steps as shown in the flowchart of FIG. 24, and therefore, detailed description will not be repeated.

The output number of changes in pixel value “hcnt” in the horizontal direction and the number of changes in pixel value “vcnt” in the vertical direction are hcnt=1 and vcnt=7, as can be seen from FIG. 21. The processes performed on the output values “hcnt” and “vcnt” will be described in the following, returning to step SS3 and the following steps of FIG. 23.

In step SS3, from the values “hcnt”, “vcnt” and “cnt0”, it is determined whether or not the condition (max (hcnt, vcnt)≧cnt0 and hcnt≠vcnt) is satisfied. At present, hcnt=1 and vcnt=7, and if cnt0 is set to 2, the flow proceeds to step SS4. In step SS4, the condition hcnt<vcnt is satisfied, and therefore, the flow proceeds to step SS7, in which “H” is output to the feature value storage area of partial image “Ri” of the original image in memory 1024A or in memory 1025A, and the partial image feature value calculation end signal is transmitted to control unit 108.

If the output values of step SS2 are hcnt=7, vcnt=1 and cnt0=2, the condition of step SS3 is satisfied and the condition of step SS4 is not satisfied, and therefore, the flow proceeds to step SS6, in which “V” is output to the feature value storage area of partial image “Ri” of memory 1024A or in memory 1025A, and the partial image feature value calculation end signal is transmitted to control unit 108.

If the output values of step SS2 are, by way of example, hcnt=7, vcnt=7 and cnt0=2, or hcnt=2, vcnt=1 and cnt0=5, the condition of step SS3 is not satisfied, so that the flow proceeds to step SS5, in which “X” is output to the feature value storage area of partial image “Ri” of the original image in memory 1024A or memory 1025A, and the partial image feature value calculation end signal is transmitted to control unit 108.

As described above, partial image feature value calculating unit 1045B in accordance with Embodiment 3 extracts (specifies) representative strings of pixels in the horizontal and vertical directions (pixel strings denoted by dotted arrows in FIG. 21) of partial image “Ri” of the image on which the calculation is to be performed, based on the number of changes (1→0 or 0→1) in pixel value in each of the extracted pixel strings, determines whether the pattern of the partial image has a tendency to extend along the horizontal direction (tendency to be horizontal stripe), along the vertical direction (tendency to be vertical stripe) or no such tendency, and outputs a value reflecting the result of determination (any of “H”, “V” and “X”). The output value represents the feature value of the corresponding partial image.

Embodiment 4

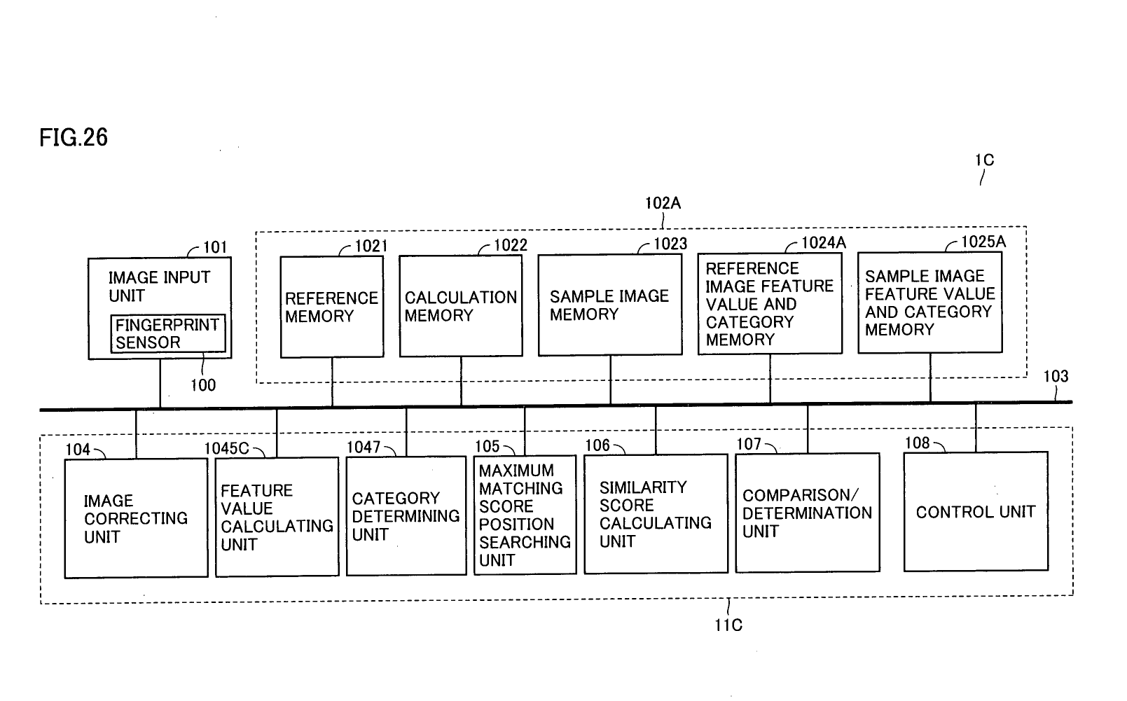

FIG. 26 shows an image comparing apparatus 1C in accordance with Embodiment 4. Image comparing apparatus 1C in FIG. 26 differs in configuration from the one in FIG. 12 in that the former apparatus includes a comparing unit 11C having a feature value calculating unit 1045C instead of comparing unit 11A. Other components of comparing unit 11C are identical to those of comparing unit 11A.

The procedure for calculating the partial image feature value is not limited to those described in connection with Embodiments 1 and 2, and the procedure of Embodiment 4 as will be described in the following may be employed.

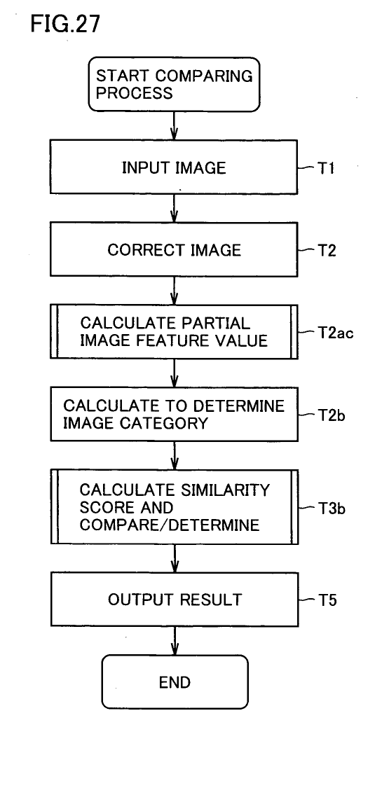

FIG. 27 shows a flowchart of the entire process in accordance with Embodiment 4. The flowchart in FIG. 27 is identical to that in FIG. 13 except that calculation of the partial image feature value (T2a) in FIG. 13 is replaced with calculation of the partial image feature value (T2ac).

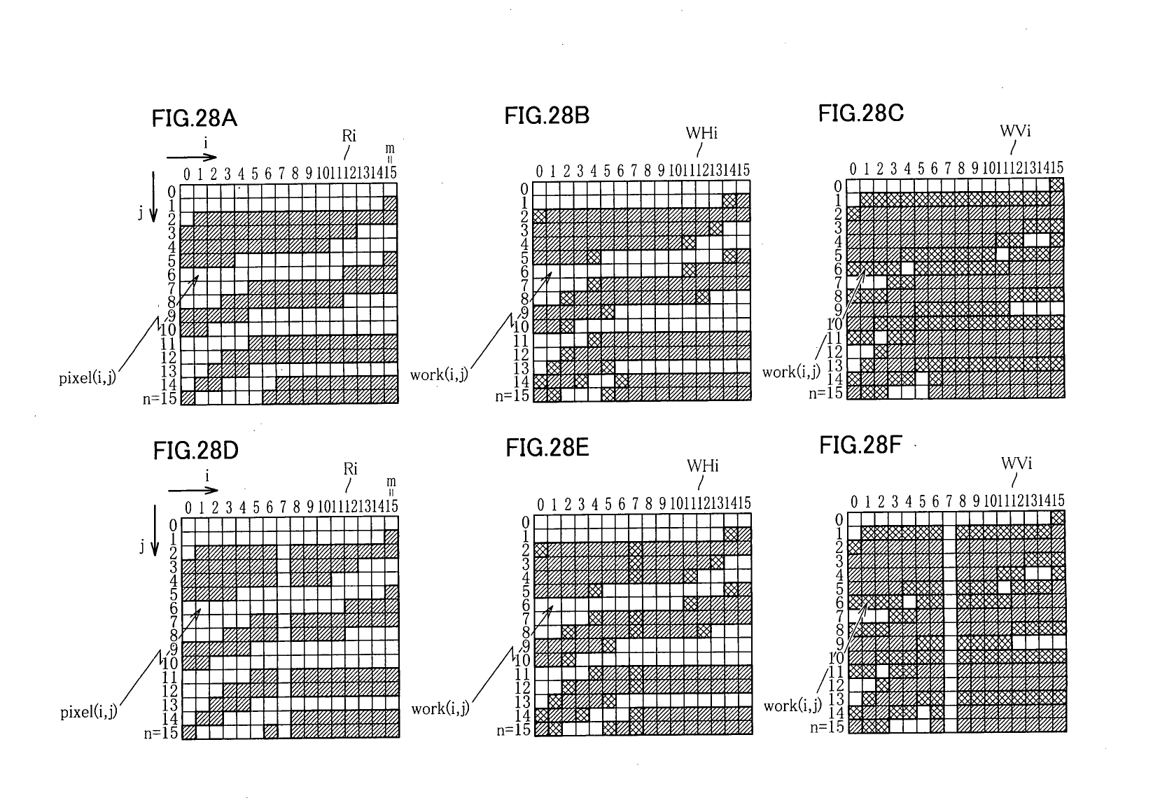

Outline of the partial image feature value calculation in accordance with Embodiment 4 will be described with reference to FIGS. 28A to 28F. FIGS. 28A to 28F show partial image “Ri” with the indication for example of the total number of black pixels and white pixels. In these drawings, partial image “Ri” consists of 16 pixels×16 pixels, with 16 pixels in each of the horizontal and vertical directions. For the calculation of the partial image feature value in accordance with Embodiment 4, partial image “Ri” in FIG. 28A on which the calculation is to be performed is displaced leftward by 1 pixel and this partial image “Ri” is also displaced rightward by 1 pixel. The original partial image and the resultant displaced images are superimposed on each other to generate image “WHi”. The increase in number of black pixels in image “WHi” relative to image “Ri”, namely increase “hcntb” (corresponding to the crosshatched portions in image “WHi” of FIG. 28B) is determined. Then, the original partial image and the partial image displaced upward by 1 pixel and the partial pixel displaced downward by 1 pixel are superimposed on each other to generate image “WVi”. The increase in number of black pixels in image “WVi” relative to image “Ri”, namely increase “vcntb” (corresponding to the crosshatched portions in image “WVi” of FIG. 28C) is determined. The determined increases “hcntb” and “vcntb” are compared with g each other. Then, if increase “vcntb” is larger than twice the increase “hcntb”, “H” representing “horizontal” is output. If increase “hcntb” is larger than twice the increase “vcntb”, “V” representing “vertical” is output. Otherwise, “X” is output. It is noted, however, that even if the determined value is “H” or “V”, “X” is output when the amount of increase of black pixels is not equal to or larger than the lower limit value “vcntb0” or “hcntb0” set for respective directions beforehand. These conditions can be given by the following expressions. If (1) vcntb>2×hcntb and (2) vcntb≧vcntb0, then “H” is output. If (3) hcntb>2×vcntb and (4) hcntb≧hcntb0, then “V” is output, and otherwise, “X” is output.

In Embodiment 4, the value “H” representing “horizontal” is output when increase “vcntb” is larger than twice the increase “hcntb”. The condition “twice” may be changed to other value. The same applies to increase “hcntb”. If it is known in advance that the total number of black pixels is in a certain range (by way of example, 30 to 70% of the total number of pixels in partial image “Ri”) and the image is suitable for the comparing process, the conditions (2) and (4) described above may be omitted.

The total number of black pixels in partial image “Ri” in FIG. 28A is 125. Respective images “WHi” and “WVi” in FIGS. 28B and 28C are larger in number of black pixels than partial image “Ri” by 21 and 96 respectively. Further, the total number of black pixels in partial image “Ri” in FIG. 28D is 115. Respective images “WHi” and “WVi” in FIGS. 28E and 28F are larger in number of black pixels than partial image “Ri” by 31 and 91 respectively.

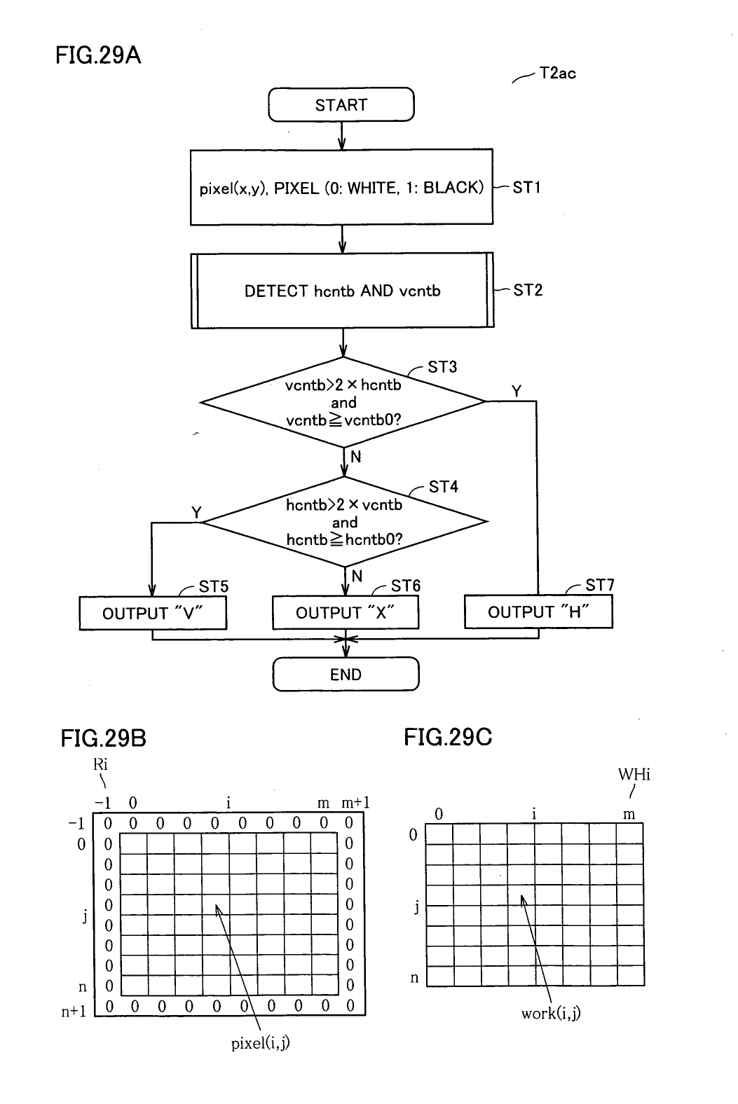

FIG. 29A is a flowchart of the process for calculating the partial image feature value in accordance with Embodiment 4. The process of this flowchart is repeated respective times for n partial images “Ri” of a reference image in reference memory 1021 on which the calculation is to be performed, and the resultant values are stored in memory 1024A in correspondence with respective partial images “Ri”. Similarly, the process is repeated respective times for n partial images “Ri” of a sample image in sample image memory 1023, and the resultant values are stored in memory 1025A in correspondence with respective partial images “Ri”. Details of the process for calculating the partial image feature value will be described with reference to the flowchart of FIG. 29A.

Control unit 108 transmits a partial image feature value calculation start signal to feature value calculating unit 1045C, and thereafter waits until receiving a partial image feature value calculation end signal.

Feature value calculating unit 1045C reads partial image “Ri” (see FIG. 28A) on which the calculation is performed, from reference memory 1021 or from sample image memory 1023, and temporarily stores the same in calculation memory 1022 (step ST1). Feature value calculating unit 1045C reads the stored data of partial image “Ri”, and calculates increase “hcntb” in the case where the partial image is displaced leftward and rightward as shown in FIG. 28B and increase “vcntb” in the case where the partial image is displaced upward and downward as shown in FIG. 28C (step ST2).

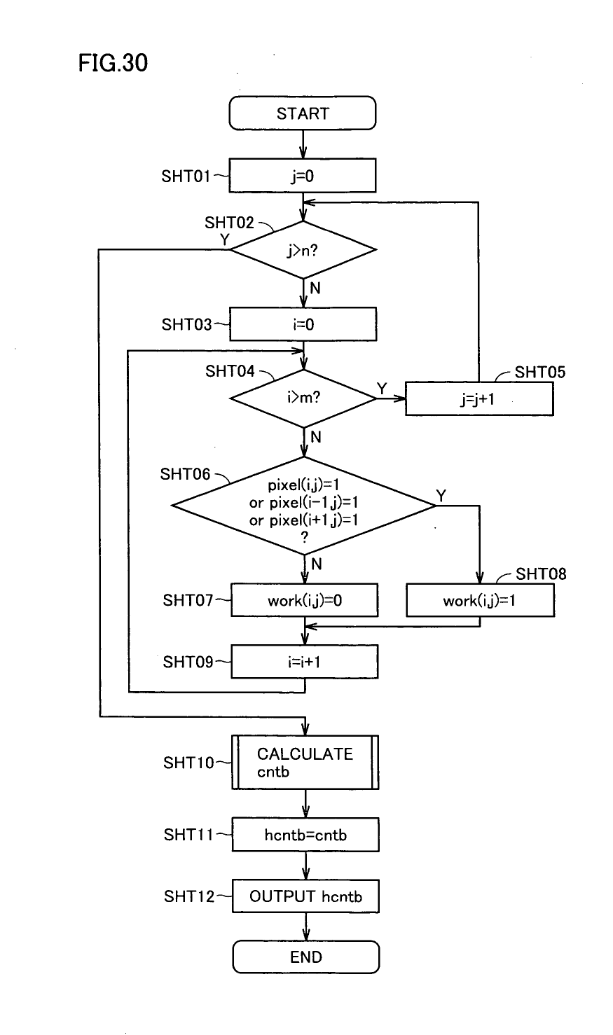

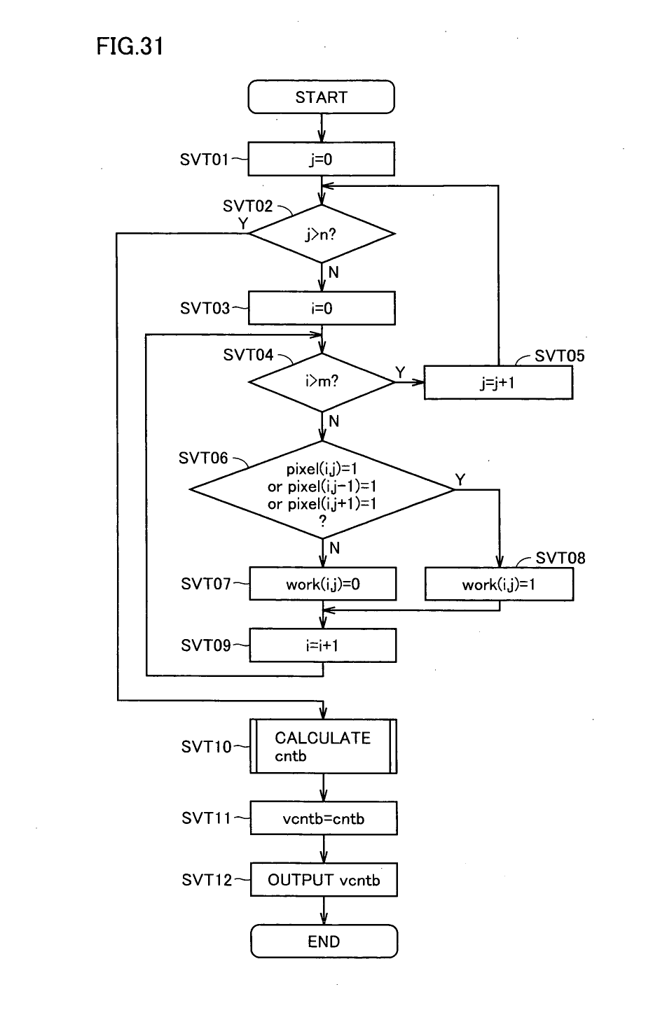

The process for detecting increase “hcntb” and increase “vcntb” will be described with reference to FIGS. 30 and 31. FIG. 30 is a flowchart representing the process (step ST2) for determining increase “hcntb” in the process (step T2ac) for calculating the partial image feature value in accordance with Embodiment 4.

Referring to FIG. 30, feature value calculating unit 1045C reads partial image “Ri” from calculation memory 1022 and initializes the value of counter “j” for the pixels in the vertical direction, namely j=0 (step SHT01). Thereafter, the value of counter “j” is compared with the maximum number “n” of pixels in the vertical direction (step SHT02). If j>n, step SHT10 is executed next, and otherwise, step SHT03 is executed next. In Embodiment 4, n=15 and j=0 at the start of processing, and therefore, the flow proceeds to step SHT03.

In step SHT03, the value of counter “i” for the pixels in the horizontal direction is initialized, namely i=0 (step SHT03). Thereafter, the value of counter “i” is compared with the maximum number of pixels “m” in the horizontal direction (step SHT04). If i>m, step STH05 is executed next, and otherwise, step SHT06 is executed. In Embodiment4, m=15 and i=0 at the start of processing, and therefore, the flow proceeds to SHT06.

In step SHT06, it is determined whether pixel value “pixel (i, j)” at coordinates (i, j) in partial image “Ri” is 1 (black pixel) or not, whether pixel value “pixel (i−1, j)” at coordinates (i−, 1j) that is one pixel to the left of coordinates (i, j) is 1 or not, or whether pixel value “pixel (i+1, j)” at coordinates (i+1, j) that is one pixel to the right of coordinates (i, j) is 1 or not. If pixel (i, j)=1, or pixel (i−1, j)=1 or pixel (i+1, j)=1, then step SHT08 is executed, and otherwise, step SHT07 is executed.

Here, it is assumed that pixel values in the scope of one pixel above, one pixel below, one pixel to the left and one pixel to the right of partial image “Ri”, that is, the range of Ri (−1 to m+1, −1), Ri (−1, −1 to n+1), Ri (m+1, −1 to n+1) and Ri (−1 to m+1, n+1) are all “0” (white pixel), as shown in FIG. 29B. In Embodiment 4, with reference to partial image “Ri” in FIG. 28A, pixel (0, 0)=0, pixel (−1, 0)=0 and pixel (1, 0)=0, and therefore, the flow proceeds to step SHT07.

In step SHT07, “0” is stored as pixel value work (i, j) at coordinate (i, j) of image “WHi” (see FIG. 29C), in a region provided in advance for image “WHi” in calculation memory 1022. Specifically, work (0, 0)=0. Then, the flow proceeds to step SHT09.

In step SHT09, the value of counter “i” for pixels in the horizontal direction is incremented by 1, that is, i=i+1. In Embodiment 4, the value has been initialized as i=0, and by the addition of 1, the value attains to i=1. Then, the flow returns to step SHT04. As the pixels in the 0-th row, that is, pixel (i, 0) are all white pixels and thus the pixel value is 0, steps SHT04 to SHT09 are repeated until “i” attains to i=15. Then, after step SHT09, “i” attains to i=16. At this time, m=15 and i=16. Therefore, the relation i>m is satisfied (Y in SHT04) and the flow proceeds to step SHT05.

In step SHT05, the value of counter “j” for pixels in the vertical direction is incremented by 1, that is, j=j+1. At present, j=0, and therefore, the increment generates j=1, and the flow returns to step SHT02. Here, it is the start of a new row, and therefore, as in the 0-th row, the flow proceeds though steps SHT03 and SHT04. Thereafter, steps SHT04 to SHT09 are repeated until the pixel of the first row and 14-th column, that is, i=14, j=1 having the pixel value of pixel (i+1, j)=1 is reached and, through the process of step SHT04, the flow proceeds to SHT06.

In step SHT06, the pixel value is determined, for partial image “Ri” in FIG. 28A, as pixel (i+1, j)=1, namely, pixel (14+1, 1)=1 (Y in SHT06), and therefore, the flow proceeds to step SHT08.

In step SHT08, 1 is stored, in calculation memory 1022, as pixel value work (i, j) at coordinates (i, j) of image “WHi” (see FIG. 28B). Specifically, work (14, 1)=1.

Then, after the subsequent processing, step STH09 provides i=16 and the flow proceeds to step SHT04 where it is determined that i>m is satisfied. Then the flow proceeds to SHT05 where j=2 is provided and the flow proceeds to step SHT02. Thereafter, the process of steps SHT02 to SHT09 is repeated while j=2 to 15. When value “j” attains to j=16 after step SHT09, the flow proceeds to step SHT02 where the value of counter “j” is compared with the maximum pixel number “n” in the vertical direction. As j>n is satisfied, step SHT10 is executed next. At this time, in calculation memory 1022, based on partial image “Ri” shown in FIG. 28A on which the calculation is now being performed, the data of image “WHi” in FIG. 28B is stored.

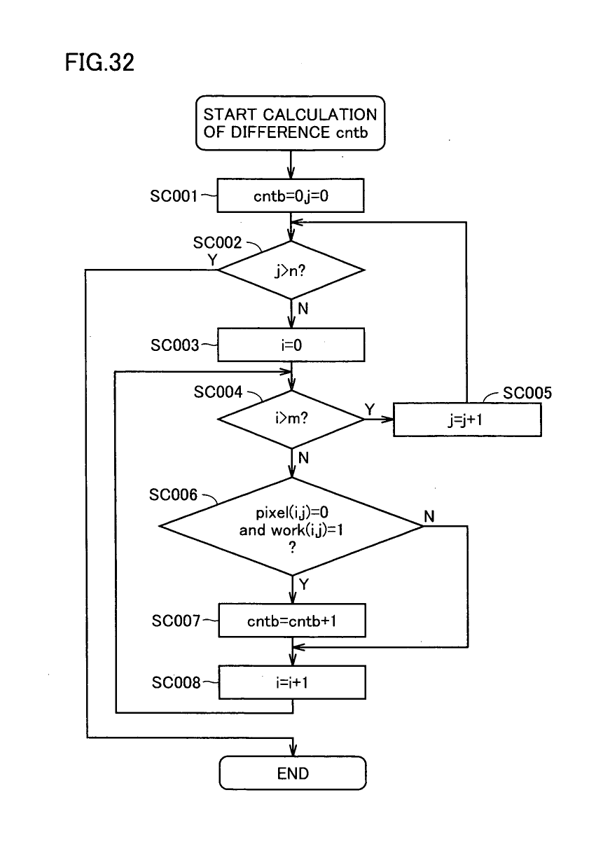

In step SHT10, difference “cntb” between each pixel value work (i, j) of image “WHi” stored in calculation memory 1022 and each pixel value pixel (i, j) of partial image “Ri” is calculated. The process for calculating difference “cntb” between “work” and “pixel” will be described with reference to FIG. 32.

FIG. 32 is a flowchart showing the calculation of difference “cntb” between pixel value pixel (i, j) of partial image “Ri” for which a comparison is now being made and pixel value work (i, j) of each of image “WHi” and image “WVi”. Feature value calculating unit 1045C reads partial image “Ri” and image “WHi” from calculation memory 1022, and initialize difference “cntb” and the value of counter “j” for the pixels in the vertical direction, that is, cntb=0 and j=0 (step SC001). Thereafter, the value of counter “j” is compared with the maximum number of pixels “n” in the vertical direction (step SC002). If j>n, the flow returns to the process shown in FIG. 30, step SHT11 is executed in which “cntb” is input to “hcntb”, and otherwise, step SC003 is executed next.

In Embodiment 4, n=15, and at the start of processing, j=0. Therefore, the flow proceeds to step SC003. In step SC003, the value of pixel counter “i” for the horizontal direction is initialized, namely i=0. Thereafter, the value of counter “i” is compared with the maximum number of pixels “m” in the horizontal direction (step SC004), and if i>m, step SC005 is executed next, and otherwise, step SC006 is executed. In Embodiment 4, m=15, and i=0 at the start of processing, and therefore, the flow proceeds to SC006.

In step SC006, it is determined whether or not pixel value pixel (i, j) at coordinates (i, j) of partial image “Ri” is 0 (white pixel) and pixel value work (i, j) of image “WHi” is 1 (black pixel). If pixel (i, j)=0 and work (i, j)=1 (Y in SC006), step SC007 is executed next, and otherwise, step SC008 is execute next. In Embodiment 4, pixel (0, 0)=0 and work (0, 0)=0, as shown in FIGS. 28A and 28B, and therefore, the flow proceeds to step SC008.

In step SC008, the value of counter “i” is incremented by 1, that is, i=i+1. In Embodiment 4, the value has been initialized to i=0, and the addition of 1, provides i=1. Then, the flow returns to step SC004. As the subsequent pixels of the 0-th row, namely pixel (i, 0) and work (i, 0) are all white pixels and the value is 0 as shown in FIGS. 28A and 28B, steps SC004 to SC008 are repeated until the value i attains to i=15. After step SC008, i=16 is satisfied. Accordingly, the difference is “cntb”=0. In this state, the flow proceeds to step SC004 where it is determined that i>m is satisfied. Then, the flow proceeds to step SC005.

In step SC005, the value of counter “j” is incremented by 1, that is, j=j+1. At present, j=0, and therefore, the value j attains to j=1, and the flow returns to step SC002. Here, it is the start of a new row, and therefore, as in the 0-th row, the flow proceeds to steps SC003 and SC004. Thereafter, steps SC004 to SC008 are repeated until the pixel of the first row and 14-th column, that is, i=14, j=1 is reached, and after the process of step SC008, the value i attains to i=14. Here, m=15 and i=14, and the flow proceeds to SC006.

In step SC006, the pixel values are determined as pixel (i, j)=0 and work (i, j)=1, that is, it is determined that pixel (14, 1)=0 and work (14, 1)=1, so that the flow proceeds to step SC007.

In step SC007, the value of difference “cntb” is incremented by 1, that is, cntb=cntb+1. In Embodiment 4, the value has been initialized to cntb=0 and the addition of 1, generates cntb=1.

Thereafter, the process of steps SC002 to SC007 is repeated while j=2 to 15, and when the value j attains to j=16 after the process of step SC005, the flow proceeds to step SC002, in which the value of counter “j” is compared with the maximum number of pixels “n” in the vertical direction. Since the condition j>n is satisfied, the flowchart in FIG. 32 comes to an end. Then, the flow returns to the flowchart in FIG. 30 to proceed to step SHT11. At this time, difference “cntb”=21.

In step STH11, the value of difference “cntb” calculated in accordance with the flowchart of FIG. 32 is input as increase “hcntb, that is, hcntb=cntb. Then, the flow proceeds to step SHT12. In step SHT12, increase “hcnt”=21 is output.

It is apparently seen that steps SVT01 to SVT12 in FIG. 31 in the process (step ST2) of determining the increase “vcntb” in the process (step T2ac) of calculating the partial image feature value in accordance with Embodiment 4 are basically the same as those steps in FIG. 30 described above that are performed on partial image “Ri” and the image “WVi”. Therefore, detailed description will not be repeated.

As increase “vcntb” to be output in the process in FIG. 3 1, the difference 96 between image “WVi” in FIG. 28C and partial image “Ri” in FIG. 28A is output.

The processes performed on the outputted increases “hcntb” and “vcntb” will be described in the following, returning to step ST3 and the following steps of FIG. 29A.

In step ST3, increases “hcntb”, “vcntb” and the lower limit “vcntb0” of increase in maximum number of black pixels in the upward and downward directions are compared with each other. If vcntb>2×hcntb and vcntb≧vcntb0, step ST7 is executed next, and otherwise step ST4 is executed. At present, vcntb=96, hcntb=21. Then, if vcntb0 is set to vcntb0=4, the flow proceeds to step ST7. In step ST7, “H” is output to the feature value storage area of partial image “Ri” of the original image in memory 1024A or in memory 1025A, and the partial image feature value calculation end signal is transmitted to control unit 108.

If the output values of step ST2 are increase “vcntb”=30, increase “hcntb”=20 and the lower limit “vcntb0”=4, then the flow proceeds to step ST3 and then to step ST4. Here, when it is determined that hcntb>2×vcntb and hcntb≧hcntb0, step ST5 is executed next, and otherwise step ST6 is executed.

Here, the flow proceeds to step ST6, in which “X” is output to the feature value storage area of partial image “Ri” of the original image in memory 1024A or memory 1025A, and the partial image feature value calculation end signal is transmitted to control unit 108.

When the output values of step ST2 are “vcntb”=30, “hcntb”=70 and “vcntb0”=4, then in step ST3, it is determined that vcntb>2×hcntb and vcntb≧vcntb0 is not satisfied. Then, step ST4 is executed.

Here, in ST4, it is determined that hcntb>2×vcntb and hcntb≧hcntb0 is satisfied. Then the flow proceeds to step ST5. In step ST5, “V” is output to the feature value storage area of the partial image “Ri” of the original image in memory 1024A or memory 1025A, and the partial image feature value calculation end signal is transmitted to control unit 108.

Regarding the partial image feature value calculation in Embodiment 4, assume that the reference image or the sample image has noise. By way of example, assume that the fingerprint image as the reference image or sample image is partially missing because of a furrow for example of the finger and as a result, the partial image “Ri” has a vertical crease at the center as shown in FIG. 28D. In such a case, as shown in FIGS. 28E and 28F, the increases are hcntb=31 and vcntb=91. Then, if vcntb0=4 is set, in step ST3 of FIG. 29A, vcntb>2×hcntb and vcntb≧vcntb0 is satisfied. Accordingly, in step ST7, value “H” representing “horizontal” is output. Namely, the calculation of partial image feature value in accordance with Embodiment 4 can maintain calculation accuracy against noise components included in the image.

It is noted here, regarding images “WHi” and “WVi” generated by leftward and rightward displacements and the upward and downward displacements of the partial image, the extent to which the image is displaced is not limited to one pixel.

As described above, feature value calculating unit 1045C in Embodiment 4 generates image “WHi” by displacing partial image “Ri” leftward and rightward by a prescribed number of pixels and superposing the resulting images, and image “WVi” by displacing the partial image “Ri” upward and downward by a prescribed number of pixels and superposing the resulting images, determines the increase of black pixels “hcntb” as a difference in number of black pixels between partial image “Ri” and image “WHi” and determines the increase of black pixels “vcntb” as a difference in number of black pixels between partial image “Ri” and image “WVi”. Then, based on these increases, it is determined that the pattern of partial image “Ri” has a tendency to extend in the horizontal direction (tendency to be horizontal stripe) or a tendency to extend in the vertical direction (tendency to be vertical stripe) or does not have any such tendency, and the value representing the result of the determination (any of “H”, “V” and “X”) is output. The output value is the feature value of the partial image “Ri”.

Embodiment 5

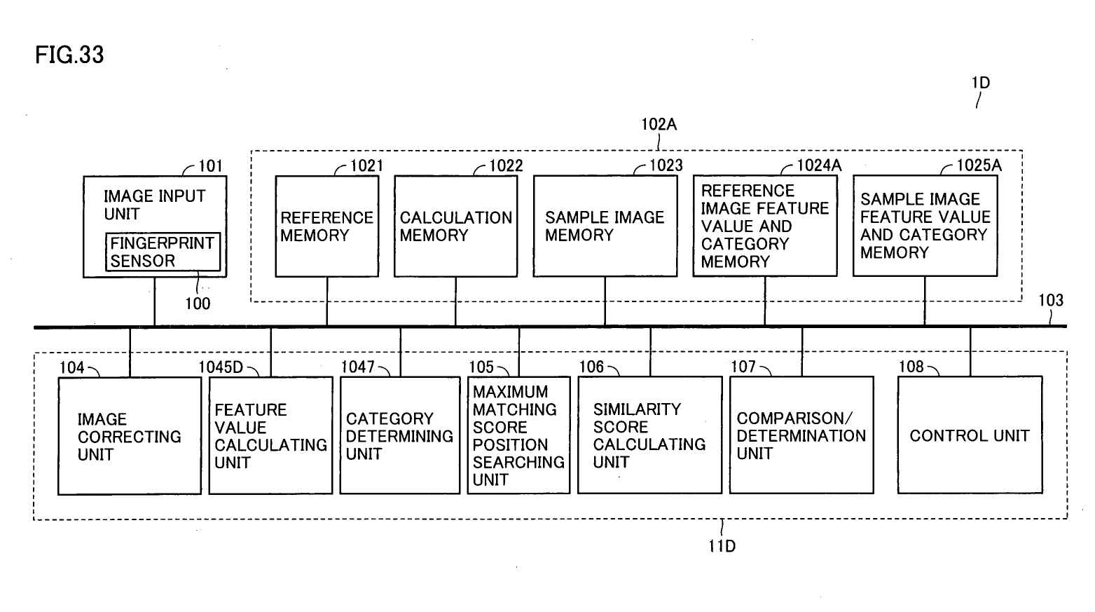

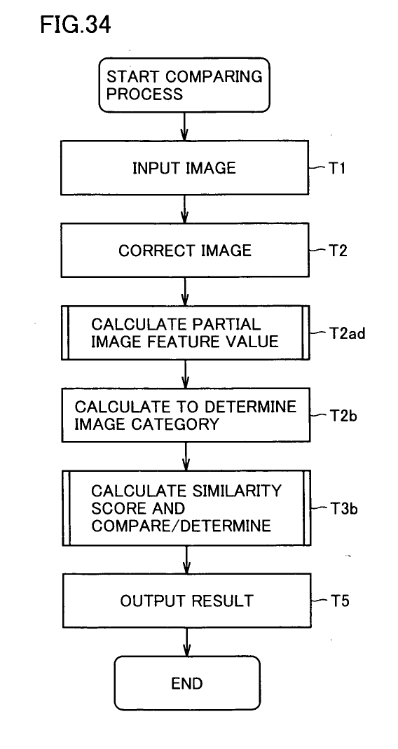

The procedure for calculating the partial image feature value is not limited to each of the above-described embodiments and may be the one in accordance with Embodiment 5. An image comparing apparatus 1D in Embodiment 5 shown in FIG. 33 differs in configuration from the one shown in FIG. 12 in that the former has a comparing unit 11D having a feature value calculating unit 1045D instead of comparing unit 11A. The configuration in FIG. 33 is similar to that in FIG. 12 except for feature value calculating unit 1045D. The flowchart in Embodiment 5 shown in FIG. 34 is similar to the one in FIG. 13 except that the calculation of the partial image feature value (T2a) is replaced with the calculation of the partial image feature value (T2ad).

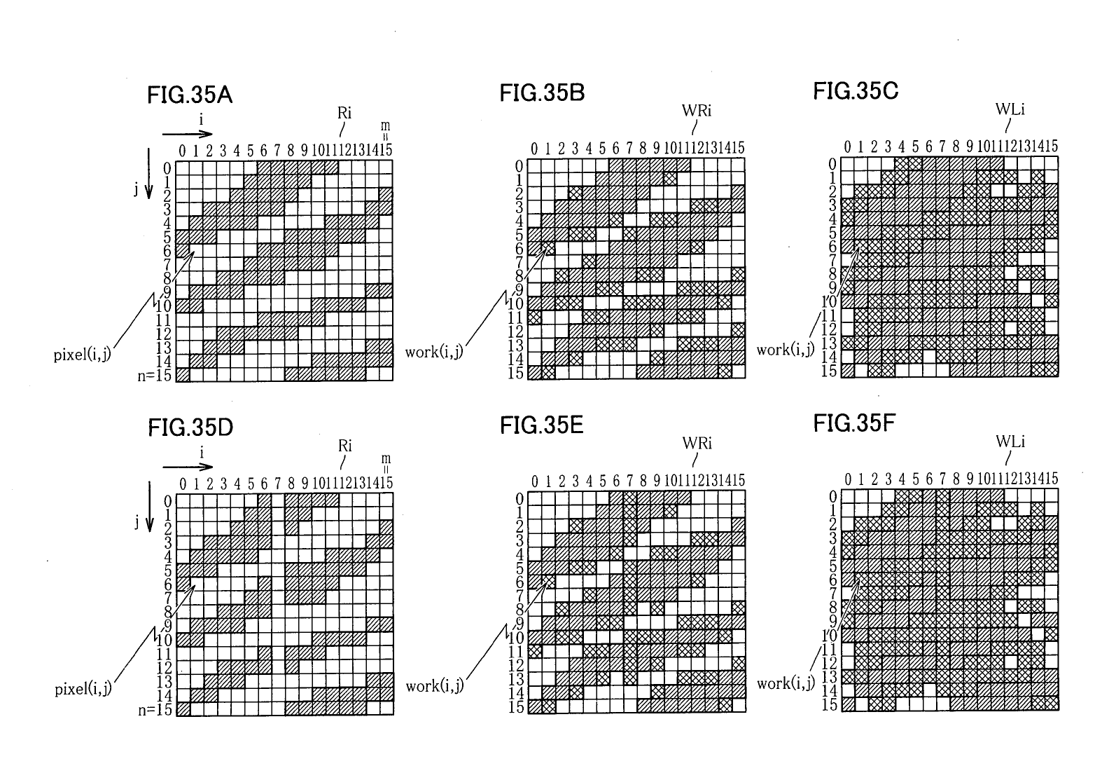

With reference to FIGS. 35A to 35F, outline is given of the calculation of the partial image feature value in accordance with Embodiment 5. FIGS. 35A to 35F each show a partial image “Ri” together with the total number of black pixels and white pixels for example. In these drawings, partial image “Ri” is comprised of 16 pixels×16 pixels with 16 pixels in each of the horizontal and vertical directions. The calculation of the partial image feature value in accordance with Embodiment 5 is performed in the following manner. Partial image “Ri” in FIG. 35A on which the calculation is to be performed is displaced in the upper right oblique direction by a predetermined number of pixels, for example, one pixel and partial image “Ri” is also displaced in the lower right oblique direction by the same predetermined number of pixels. The original partial image and the resultant two displaced images are superimposed on each other to generate an image “WRi”. Then, an increase in number of black pixels in the resultant image “WRi”, namely increase “rcnt” (the crosshatched portion in image “WRi” in FIG. 35B) relative to the number of black pixels in the original partial image “Ri” is detected. Similarly, partial image “Ri” is displaced in the upper left oblique direction by a predetermined number of pixels, for example, one pixel, and partial image “Ri” is also displaced in the lower left oblique direction by the predetermined number of pixels. The original partial image and the resultant two displaced images are superimposed on each other to generate an image “WLi”. Then, an increase in number of black pixels in the resultant image “WLi”, namely increase “lcnt” (the crosshatched portion in image “WLi”, in FIG. 35C) relative to the number of black pixels in the original partial image “Ri” is detected. The detected increases “rcnt” and “lcnt” are compared with each other. When increase “lcnt” is larger than twice the increase “rcnt”, value “R” representing “right oblique” is output. When increase “rcnt” is larger than twice the increase “lcnt”, value “L” representing “left oblique” is output. Otherwise, value “X” is output. It should be noted here that, even if the above-described determination is “R” or “L”, “X” is output when the above-described increase in number of black pixels is not equal to or larger than the lower limit “lcnt0” or “rcnt0”. These conditions may be mathematically represented in the following way. If the conditions (1) lcnt>2×rcnt and (2) lcnt≧lcnt0 are satisfied, “R” is output. If the conditions (3) rcnt>2×lcnt and (4) rcnt≧rcnt0 are satisfied, “L” is output. Otherwise, “X” is output.

In Embodiment 5, although value “R” representing “right oblique” is output under the condition that the increase in number of black pixels in the case where the image is displaced in the upper and lower left oblique directions is larger than twice the increase in the case where the image is displaced in the upper and lower right oblique directions, the numerical condition, twice, may be other numerical value. The same is applied to the increase in number of black pixels in the case where image is displaced in the upper and lower right oblique directions. In addition, if it is known in advance that the number of black pixels in partial image “Ri” is in a certain range (for example, the number of black pixels in partial image “Ri” is in the range of 30% to 70% relative to the total number of black pixels) and that the image is appropriate for the comparing process, the above-described conditions (2) and (4) may not be used.

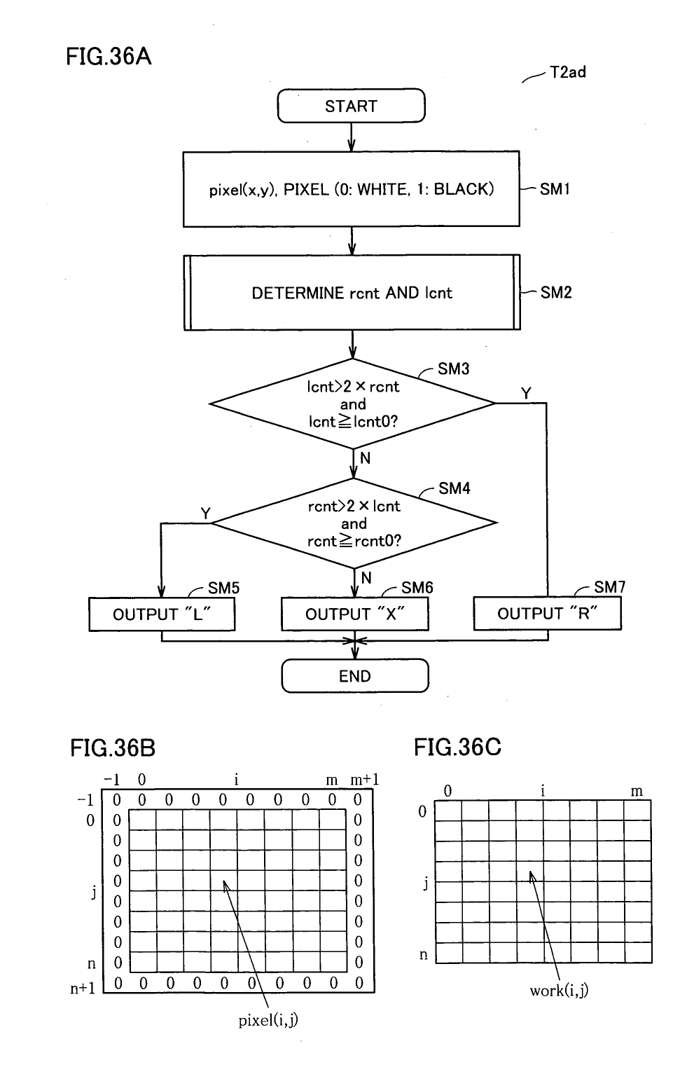

FIG. 36A is a flowchart showing the calculation of the partial image feature value in accordance with Embodiment 5 of the present invention. The flowchart is repeated respective times for “n” partial images “Ri” of a reference image on which the calculation is to be performed and which is stored in reference memory 1021. The resultant values determined by the calculation are correlated respectively with partial images “Ri” and stored in memory 1024A. Similarly, the flowchart is repeated respective times for “n” partial images “Ri” of a sample image in sample image memory 1023. The resultant values determined by the calculation are correlated respectively with partial images “Ri” and stored in memory 1025A. In the following, details of the feature value calculation are given according to the flowchart in FIG. 36A.

Control unit 108 transmits to feature value calculating unit 1045D the partial image feature value calculation start signal and thereafter waits until receiving the partial image feature value calculation end signal.

Feature value calculating unit 1045D reads partial image “Ri” on which the calculation is to be performed (see FIG. 35A) from reference memory 1021 or sample image memory 1023 and temporarily stores it in calculation memory 1022 (step SM1). Feature value calculating unit 1045D reads the stored partial image “Ri” to detect increase “rcnt” in the case where the partial image is displaced in the upper and lower right oblique directions as shown in FIG. 35B and detect increase “lcnt” in the case where the partial image is displaced in the upper and lower left oblique directions as shown in FIG. 35C (step SM2).

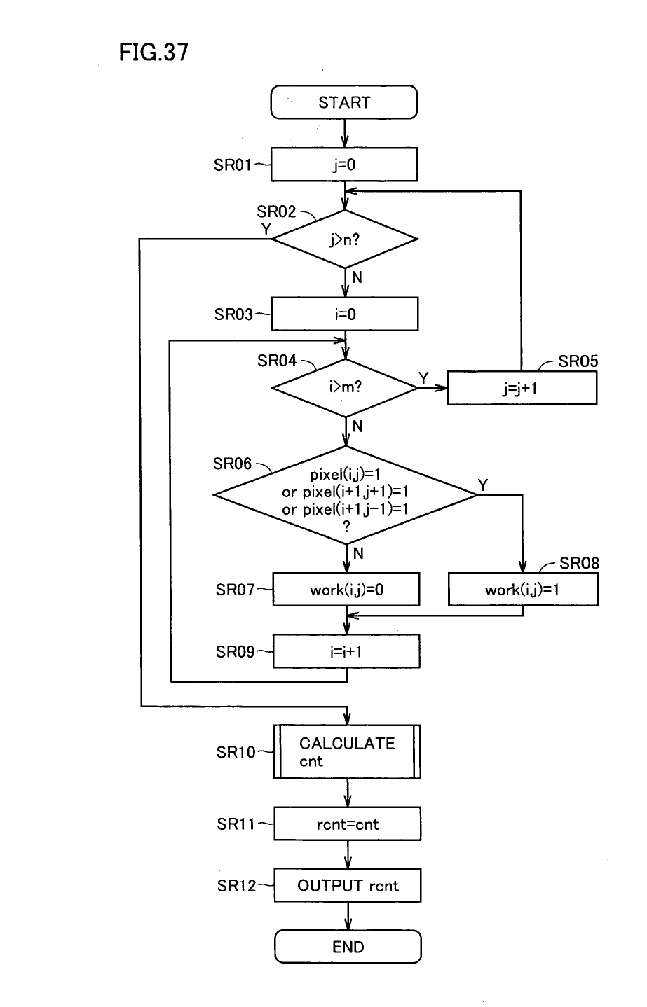

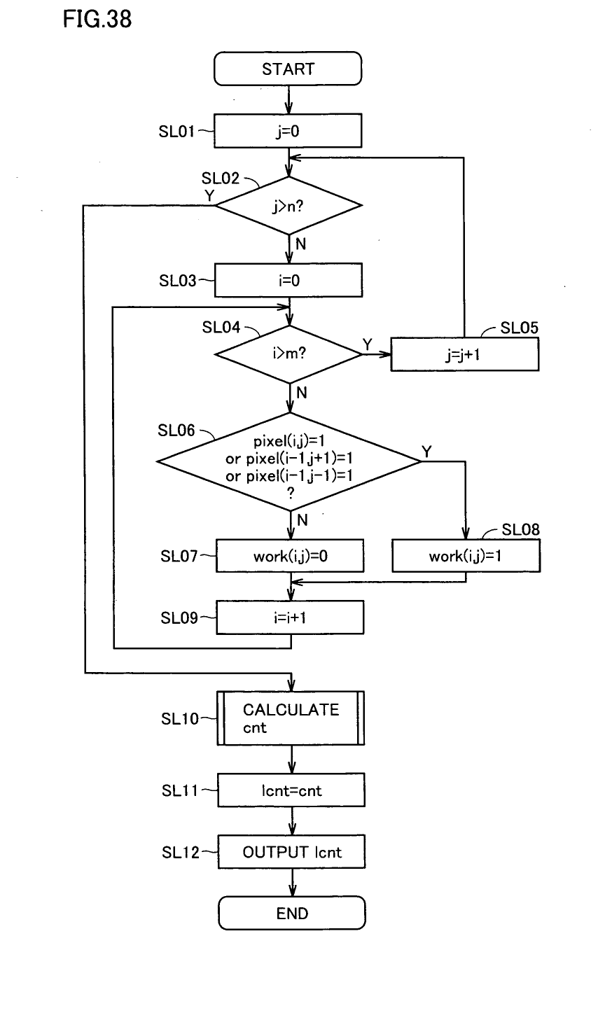

The step of detecting increase “rcnt” and increase “lcnt” is described with reference to FIGS. 37 and 38. FIG. 37 is a flowchart for the step (step SM2) of detecting increase “rcnt” in the step of calculating the partial image feature value (step T2ad) in Embodiment 5 of the present invention.

Referring to FIG. 37, feature value calculating unit 1045D reads partial image “Ri” from calculation memory 1022 and initializes the value of counter “j” for pixels in the vertical direction, namely j=0 (step SR01). Then, the value of counter “j” and the maximum number of pixels in the vertical direction “n” are compared with each other (step SR02). When the condition j>n is satisfied, step SR10 is subsequently performed. Otherwise, step SR03 is subsequently performed. In Embodiment 5, “n” is 15 (n=15) and “j” is 0 (j=0) at the start of this process. Then, the flow proceeds to step SR03.

In step SR03, the value of counter “i” for pixels in the horizontal direction is initialized, namely i=0. Then, the value of counter “i” for pixels in the horizontal direction and the maximum number of pixels in the horizontal direction “m” are compared with each other (step SR04). If the condition i>m is satisfied, step SR05 is subsequently performed. Otherwise, the following step SR06 is subsequently performed. In the present embodiment, “m” is 15 (m=15) and “i” is 0 (i=0) at the start of the process. Then, the flow proceeds to step SR06.

In step SR06, it is determined whether the pixel value, pixel (i, j), at coordinates (i, j) on which the comparison is made is 1 (black pixel), or the pixel value, pixel (i+1, j+1), at the upper right adjacent coordinates (i+1, j+1) relative to coordinates (i, j) is 1, or the pixel value, pixel (i+1, j−1); at the lower right adjacent coordinates (i+1, j−1) relative to coordinates (i, j) is 1. If pixel (i, j)=1, or pixel (i+1, j+1)=1 or pixel (i+1, j−1)=1, step SR08 is subsequently performed. Otherwise, step SR07 is subsequently performed.

It is supposed here that, as shown in FIG. 36B, those pixels directly adjacent to partial image “Ri” in the upper, lower, right and left directions, namely the pixels in the range Ri (−1 to m+1, −1), Ri (−1, −1 to n+1), Ri (m+1, −1 to n+1) and Ri (−1 n+1) have pixel value 0 (white pixels). In Embodiment 5, with reference to FIG. 35A, pixel values are pixel (0, 0)=0, pixel (1, 1)=0 and pixel (1, −1)=0. Then, the flow proceeds to step SR07.

In step SR07, 0 is stored as the pixel value, work (i, j), at coordinates (i, j) (see FIG. 36C) in the region of image “WRi” prepared in calculation memory 1022. Namely work (0, 0)=0. Then, the flow proceeds to step SR09.

In step SR09, the value of counter “i” is incremented by one, namely i=i+1. In Embodiment 5, the initialization has generated i=0. Therefore, the addition of 1, provides i=1. Then, the flow returns to step SR04. After this, steps SR04 to SR09 are repeated until i reaches 15 (i=15). After step SR09 and when i is 16 (i=16), from the fact that m is 15 (m=15), it is determined in step SR04 that the condition i>m is satisfied and the flow proceeds to step SR05.

In step SR05, the value of counter “j” for pixels in the vertical direction is incremented by one, namely j=j+1. At this time, j is 0 (j=0) and thus the initialization provides j=1. Then, the flow returns to SR02. Here, since the new row is now processed, the flow proceeds through steps SR03 and SR04 as does for the 0-th row. After this, steps SR04 to SR09 are repeated until i=4 and j=1. After step SR09, i is 4 (i=4). Since m is 15 (m=15) and i is 4 (i=4), the flow proceeds to step SR06.

In step SR06, since the condition pixel (i+1, j+1)=1, namely pixel (5, 2)=1 is met, the flow proceeds to step SR08.

In step SR08, 1 is stored as pixel value work (i, j) at coordinates (i, j) in image “WRi” (see FIG. 35B) in calculation memory 1022, namely, work (4, 1)=1.

After this, the flow proceeds to step SR09. When i=16 is reached, the flow proceeds through step SR04 to step SR05 where j is 2 (j=2). Then the flow proceeds to SR02. After this, steps SR02 to SR09 are similarly repeated for j=2 to 15. After step SR09 and when j is 16 (j=16), it is then determined in step SR02 that the condition j>n is satisfied. The flow then proceeds to step SR10. At this time, in calculation memory 1022, image “WRi” as shown in FIG. 35B is stored that is generated based on partial image “Ri” on which the comparison is currently made.

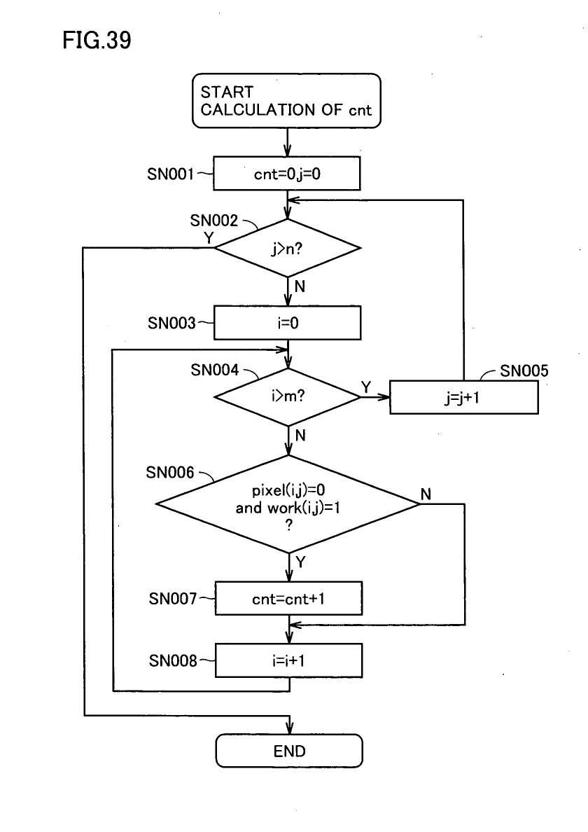

In step SR10, difference “rcnt” is calculated between pixel value work (i, j) of image “WRi” in calculation memory 1022 and pixel value pixel (i, j) of partial image “Ri” on which the comparison is currently made. The process for calculating difference “rcnt” between “work” and “pixel” is now described with reference to FIG. 39.

FIG. 39 is a flowchart for calculating difference “rcnt” or “lcnt” between pixel value pixel (i, j) of partial image “Ri” and pixel value work (i, j) of image “WRi” or image “WLi”, generated by superimposing images displaced in the right oblique direction or the left oblique direction. Image feature value calculating unit 1045D reads from calculation memory 1022 partial image “Ri” and image “WRi” and initializes difference “cnt” and the value of counter “j” for pixels in the vertical direction, namely cnt=0 and j=0 (step SN001). Subsequently, the value of counter for pixels in the vertical direction “j” and the maximum number of pixels in the vertical direction “n” are compared with each other (step SN002). If the condition j>n is met, the flow returns to the flowchart in FIG. 37 where “cnt” is input as “rcnt” in step SR11. Otherwise, step SN003 is subsequently performed.

In Embodiment 5, n is 15 (n=15) and, at the start of the process, j is 0 (j=0). Then, the flow proceeds to step SN003. In step SN003, the value of counter for pixels in the horizontal direction, “i”, is initialized, namely i=0. Then, the value of counter “i” and the maximum number of pixels in the horizontal direction “m” are compared with each other (step SN004). If the comparison provides condition i>m, step SN005 is subsequently performed. Otherwise, step SN006 is subsequently performed. In Embodiment 5, m is 15 (m=15) and, at the start of the process, i is 0 (i=0). Then, the flow proceeds to step SN006.

In step SN006, it is determined whether or not pixel value pixel (i, j) of partial image “Ri” at coordinates (i, j) on which the comparison is currently made is 0 (white pixel) and pixel value work (i, j) of image “WRi” is 1 (black pixel). When the determination provides the results, pixel (i, j)=0 and work (i, j)=1, step SN007 is subsequently performed. Otherwise, step SN008 is subsequently performed. In Embodiment 5, with reference to FIGS. 35A and 35B, the pixel values are pixel (0, 0)=0 and work (0, 0)=0, the flow proceeds to step SN008.

In step SN008, i=i+1, namely the value of counter “i” is incremented by one. In Embodiment 5, the initialization provides i=0 and thus the addition of 1 provides i=1. Then, the flow returns to step SN004. After this, steps SN004 to SN008 are repeated until i=15 is reached. After step SN008 and when i is 16 (i=16), the flow proceeds to SN004. As “m” is 15 (m=15) and “i” is 16 (i=16), the flow proceeds to step SN005.

In step SN005, j=j+1, namely the value of counter “j” for pixels in the vertical direction is incremented by one. Under the condition j=0, the addition of 1, provides j=1 and thus the flow returns to SN002. Since the new row is now processed, the flow proceeds through to SN003 and SN004. After this, steps SN004 to SN008 are repeated until the pixel in the first row and the 10th column, namely i=10 and j=1 are reached where the pixel values are pixel (i, j)=0 and work (i, j)=1. At this time, since “m” is 15 (m=15) and “i”10 (i=10), the condition i>m is not satisfied in step SN004. Then, the flow proceeds to step SN006.

In step SN006, since the pixel values are pixel (i, j)=0 and work (i, j)=1, namely pixel (10, 1)=0 and work (10, 1)=1, the flow proceeds to step SN007.

In step SN007, cnt=cnt+1, namely the value of difference “cnt” is incremented by one. In Embodiment 5, since the initialization provides cnt=0, the addition of 1, provides cnt=1. The flow continues until i=16 is reached, the flow proceeds through step SN004 to step SN005 where j is 2 (j=2) and then to step SN002.

After this, steps SN002 to SN008 are repeated for j=2 to 15. After step SN008 and when j is 16 (j=16), the condition j>n is met in the following step SN002. Then, the flowchart in FIG. 39 is ended and the process returns to the flowchart in FIG. 37 to proceed to step SR11. At this time, the difference counter has the value cnt=45.

In step SR11, rcnt=cnt, namely difference “cnt” calculated through the flowchart in FIG. 39 is input as increase “rcnt” in the case where the image is displaced in the right oblique direction and the flow subsequently proceeds to step SR12. In step SR12, increase “rcnt”=45 is output.

In FIG. 38, the process through steps SL01 to SL12 in the step (step SM2) of determining increase “lcnt” in the case where the image is displaced in the left oblique direction in the step (step T2ad) of calculating the partial image feature value in Embodiment 5 of the present invention is basically the same as the above-described process in FIG. 37, and the detailed description thereof is not repeated here.

As increase “lcnt”, the difference 115 between image “WLi”, in FIG. 35C and partial image “Ri” in FIG. 35A is output.

The process performed on the outputs “rcnt” and “lcnt” is described now, referring back to step SM3 and the following steps in FIG. 36A.

In step SM3, comparisons are made between “rcnt” and “lcnt” and the predetermined lower limit “lcnt0” of the increase in number of black pixels regarding the left oblique direction. When the conditions lcnt>2×rcnt and lcnt≧lcnt0 are satisfied, step SM7 is subsequently performed. Otherwise, step SM4 is subsequently performed. At this time, “lcnt” is 115 (lcnt=115) and “rcnt” is 45 (rcnt=45). Then, if “lcnt0” is set to 4 (lcnt0=4), the conditions in step SM3 are satisfied and the flow subsequently proceeds to step SM7. In step SM7, “R” is output to the feature value storage area for partial image “Ri” for the original image in memory 1024A or memory 1025A, and the partial image feature value calculation end signal is transmitted to control unit 108.

If the output values in step SM2 are lcnt=30 and rcnt=20 and lcnt0 is 4 (lcnt0=4), the conditions in step SM3 are not satisfied and the flow subsequently proceeds to step SM4. In step SM4, the conditions rcnt>2×lcnt and rcnt≧rcnt0 are not satisfied, and then the flow proceeds to step SM6. In step SM6, “X” is output to the feature value storage area for partial image “Ri” for the original image in memory 1024A or memory 1025A. Then, the partial image feature value calculation end signal is transmitted to control unit 108.

Further, if the output values in step SM2 are lcnt=30 and rcnt=70 and lcnt0=0 and rcnt0 is 4 (rcnt0=4), the conditions in step SM3 are met and the flow then proceeds to step SM4. The “rcnt0” is the predetermined lower limit of the increase in number of black pixels regarding the right oblique direction.

In step SM4, the conditions rcnt>2×lcnt and rcnt≧rcnt0 are met, and the flow proceeds to step SM5. In step SM5, “L” is output to the feature value storage area for partial image “Ri” for the original image in memory 1024A or memory 1025A.

Regarding the partial image feature value calculation in Embodiment 5, even if the reference image or the sample image has noise, for example, even if the fingerprint image as the reference image or sample image is partially missing because of a furrow for example of the finger and consequently partial image “Ri” has a vertical crease at the center as shown in FIG. 35D, the differences are detected as “rcnt”=57 and “lcnt”=124 as shown in FIGS. 35E and 35F. Then, if “lcnt0” is set to 4 (lcnt0=4), the conditions in step SM3 are satisfied. Value “R” representing “right oblique” is accordingly output. Thus, the calculation of partial image feature value in accordance with Embodiment 5 can maintain calculation accuracy against noise components included in the image.

It is noted that, when the partial image is displaced in the right oblique direction or the left oblique direction to generate image “WRi” or image “WLi”, the number of pixels by which the image is displaced is not limited to one pixel.

As discussed above, partial image feature value calculating unit 1045D in accordance with Embodiment 5 generates image “WRi” and image “WLi”, with respect to partial image “Ri”, detects increase “rcnt” in number of pixels that is the difference between image “WRi” and partial image “Ri” and detects increase “lcnt” in number of black pixels that is the difference between image “WLi”, and partial image “Ri” and, based on these increases, outputs the value (one of “R”, “L” and “X”) according to the determination as to whether the pattern of partial image “Ri” is the pattern with the tendency to be arranged in the right oblique direction (for example, right oblique stripe) or the pattern with the tendency to be arranged in the left oblique direction (for example the left oblique stripe) or any except for these patterns. The output value represents the feature value of partial image “Ri”.

Embodiment 6

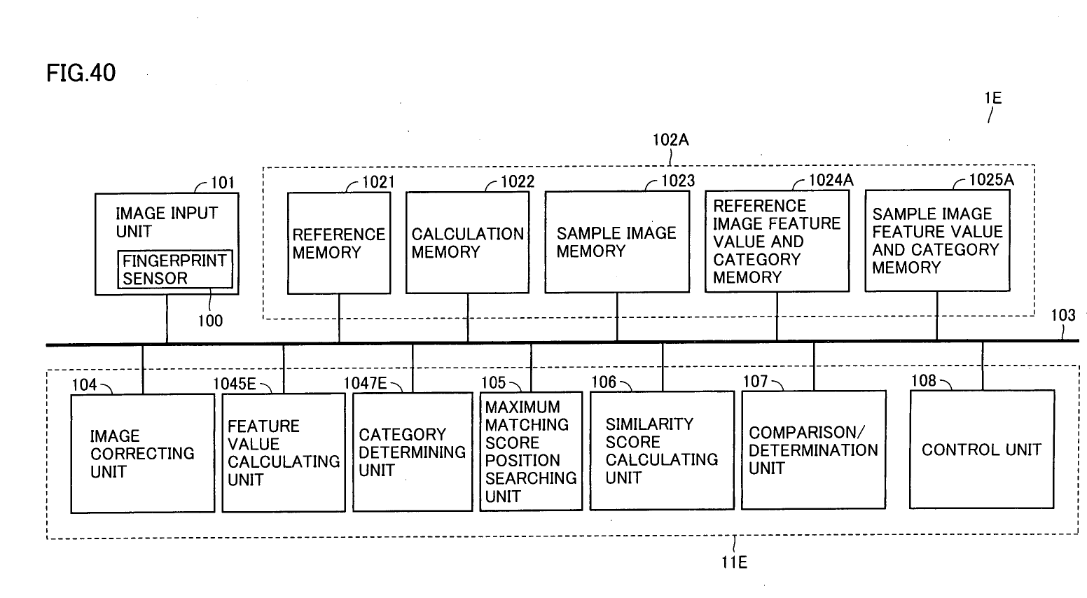

An image comparing apparatus 1E in Embodiment 6 shown in FIG. 40 is similar to the one in FIG. 12 except that comparing unit 11A of image comparing apparatus 1A in FIG. 12 is replaced with a comparing unit 11E including a feature value calculating unit 1045E and a category determining unit 1047E.

Feature value calculating unit 1045E has both of the feature value calculating functions in accordance with Embodiments 4 and 5. Specifically, feature value calculating unit 1045E generates, with respect to a partial image “Ri”, images “WHi”, “WVi”, “WLi”, and “WRi”, detects increase “hcntb” in number of black pixels that is the difference between image “WHi” and partial image “Ri”, increase “vcntb” in number of black pixels that is the difference between image “WVi” and partial image “Ri”, increase “rcnt” in number of black pixels between image “WRi” and partial image “Ri”, and increase “lcnt” in number of black pixels that is the difference between image “WLi”, and partial image “Ri”, determines, based on these increases, whether the pattern of partial image “Ri” is the pattern with the tendency to be arranged in the horizontal (lateral) direction (for example, horizontal stripe), or the pattern with the tendency to be arranged in the vertical direction (for example, vertical stripe), or the pattern with the tendency to be arranged in the right oblique direction (for example, right oblique stripe), or the pattern with the tendency to be arranged in the left oblique direction (for example, left oblique stripe), or any except for the aforementioned patterns, and then outputs any of the values according to the determination (one of “H”, “V”, “R”, “L” and “X”). The output value represents the feature value of this partial image “Ri”.

In the present embodiment, values “H” and “V” are used in addition to “R”, “L” and “X” as the feature value of the partial image “Ri”. Therefore, the classification is made finer, namely the number of categories is increased from three to five. Accordingly, the image data to be subjected to the comparing process can further be limited, and thus the processing can be made faster.

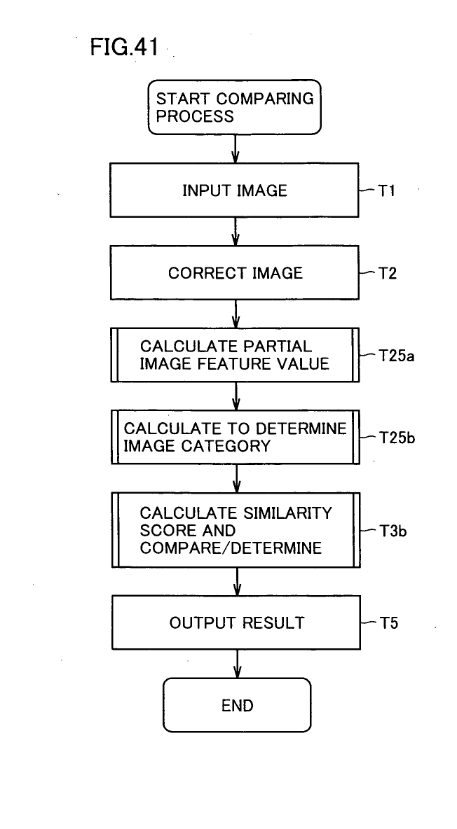

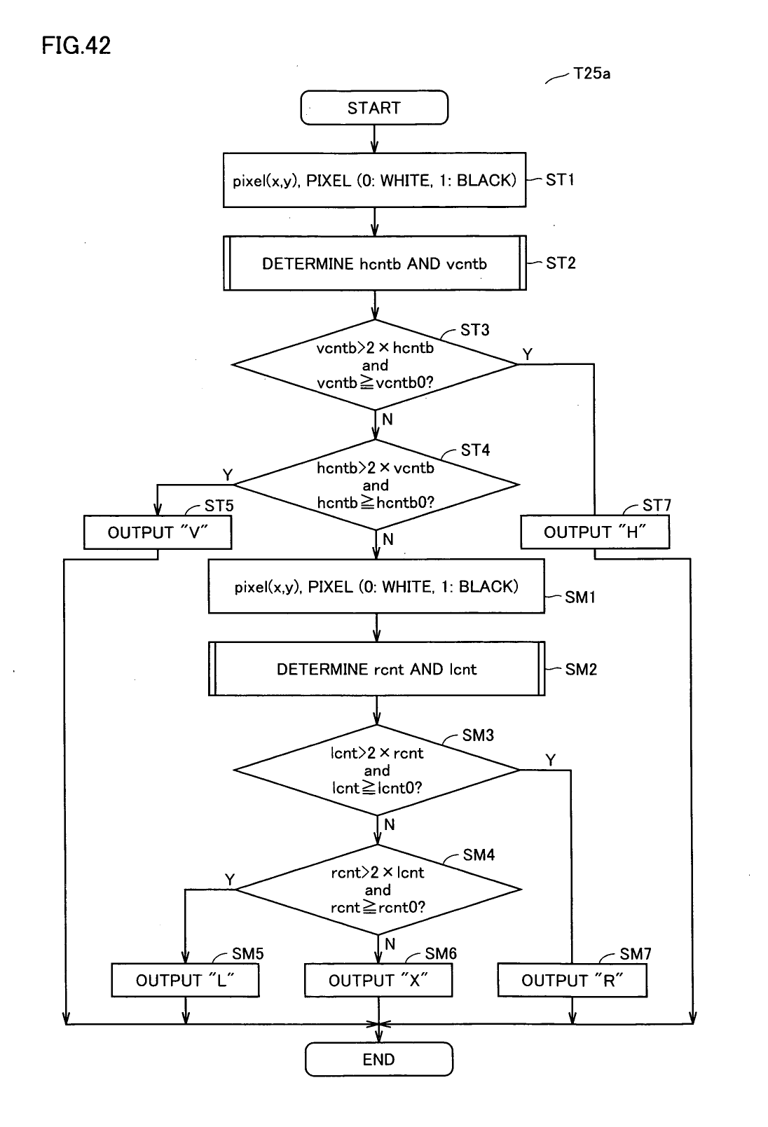

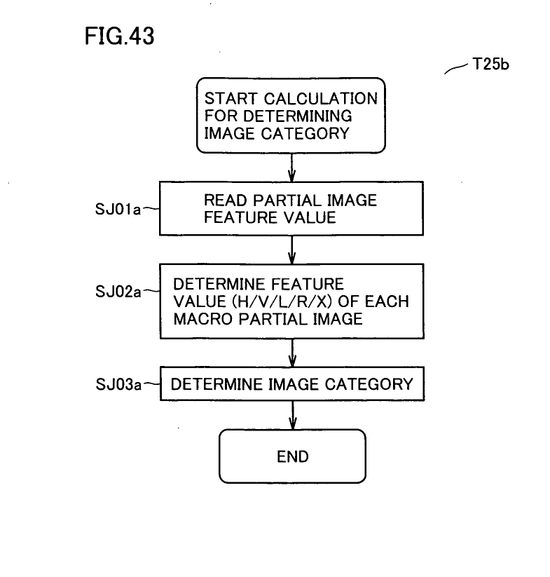

The procedure of the comparing process in accordance with Embodiment 6 is shown in the flowchart in FIG. 41. The flowcharts in FIGS. 41 and 13 differ in that the step of calculating partial image feature value (T2a) and the step of calculation for determining the image category (T2b) are replaced respectively with the step of calculating partial image feature value (T25a) and the step of calculation for determining image category (T25b). Other steps in FIG. 41 are identical to corresponding ones in FIG. 13. FIG. 42 shows a flowchart for the partial image feature value calculation (T25a) and FIG. 43 shows a flowchart for the calculation to determine the image category (T25b).

In the process of image comparison in the present embodiment, in a manner similar to the above-described one, image correcting unit 104 makes image corrections to a sample image (T2) and thereafter, feature value calculating unit 1045E calculates the feature value of the partial image of a sample image and a reference image (T25a). 0n the sample image and the reference image on which this calculation has been performed, category determining unit 1047E performs the step of calculation for determining the image category (T25b). The procedure is described with reference to the flowcharts in FIGS. 42 and 43.

In the step of calculating the partial image feature value (T25a) in FIG. 42, steps ST1 to ST4 in the partial image feature value calculation step (T2ac) shown in FIG. 29A are similarly performed to make the determination with the results “V” and “H” (ST5, ST7). In this case, if the result of the determination is neither “V” nor “H” (N in ST4), steps SM1 to SM7 for the image feature value calculation (T2ad) shown in FIG. 36A are similarly performed. Then, the results of the determination “L”, “X” and “R” are output. Accordingly, through the calculation of partial image feature value (T25a), one of the five different feature values “V”, “H”, “L”, “R” and “X” can be output as the feature values of partial images.

Here, in view of the fact that there is a notable tendency, for most of fingerprints to be identified, to have the vertical or horizontal pattern, the process shown in FIG. 29A is executed first. However, the order of execution is not limited to the above-described one. The process in FIG. 36A may be performed first and, in the case where it is determined that the feature value is neither “L” nor “R”, then the process in FIG. 29A may be performed.

Subsequently, the step of calculation for determining the image category (T25b) is performed according to FIG. 43. The step of the image category determining calculation (T25b) shown in FIG. 43 is carried out by category determining unit 1047E. The procedure is described below according to the flowchart in FIG. 43.

First, the partial image feature value of each macro partial image is read from memory 1025A (step SJ (hereinafter abbreviated as SJ)01a). Details are as follows.

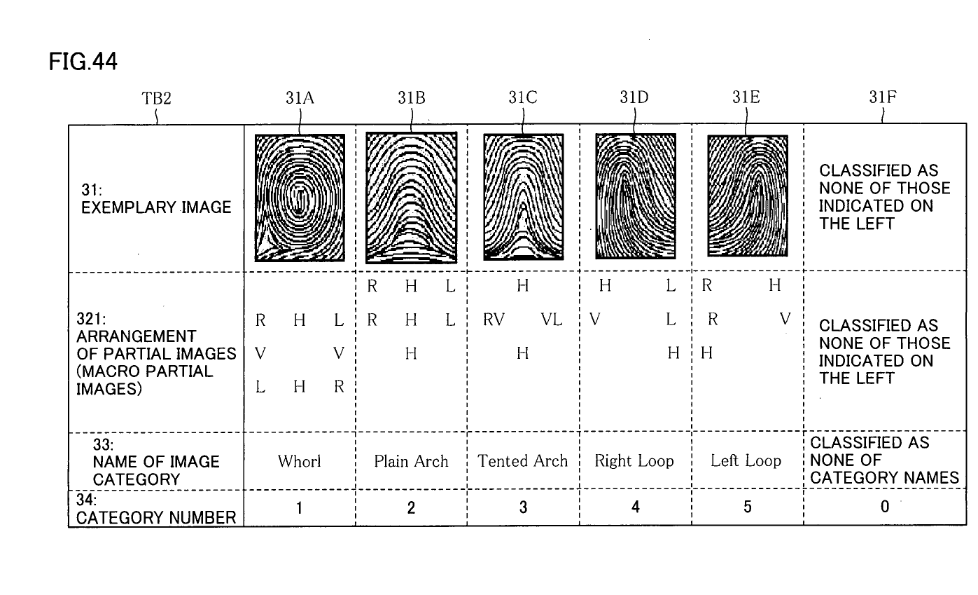

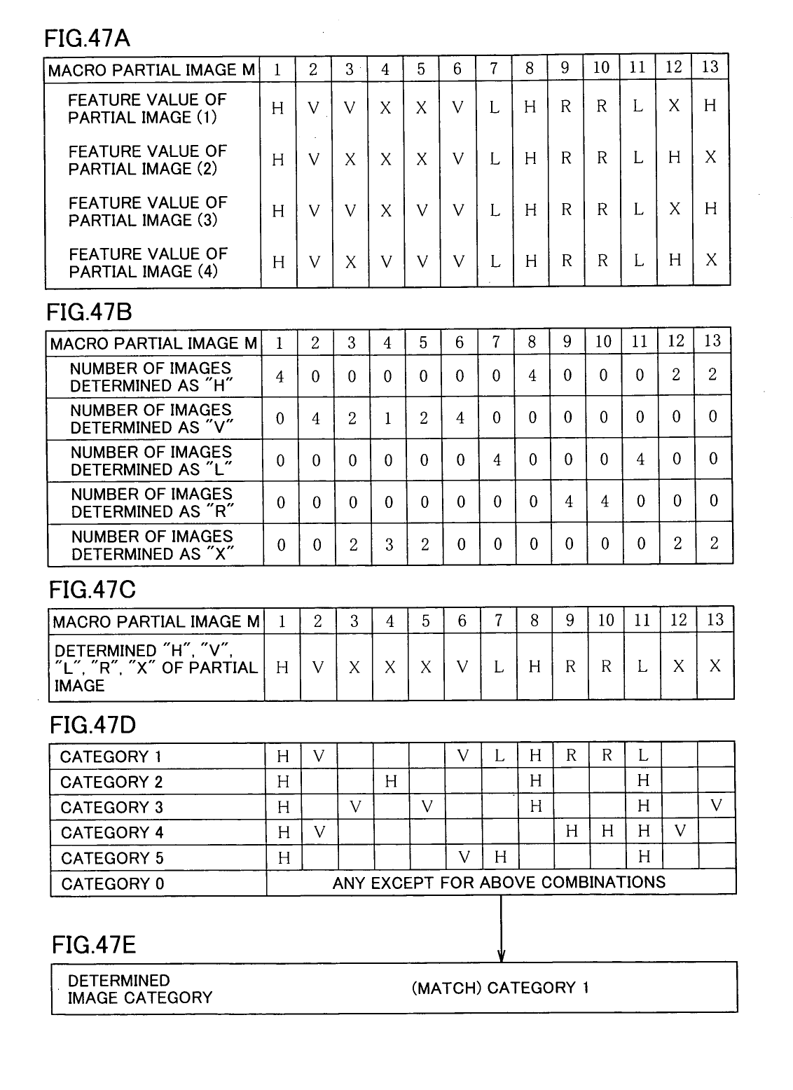

In the present embodiment, a table TB2 in FIG. 44 is referred to instead of the above-described table TB1 in FIG. 15. In table TB2, for each of data 31 showing exemplary fingerprint images, the arrangement of partial images (macro partial images) 321, the image category name 33 and the data representing the category number 34 are registered. Table TB2 is stored in advance in memory 624 and appropriately referenced for determining the category by category determining unit 1047E. Data 321 is also shown in FIGS. 47D, 48D, 49D, 50D and 51D described hereinlater.

In table TB2, like the above-described table TB1, image data 31A to 31F are registered. Characteristics of these image data may be used and reference images and sample images to be used for comparison may be limited to the same category, so as to reduce the amount of required processing. For the categorization, the feature value of the partial image can be used to achieve classification with a smaller amount of processing.

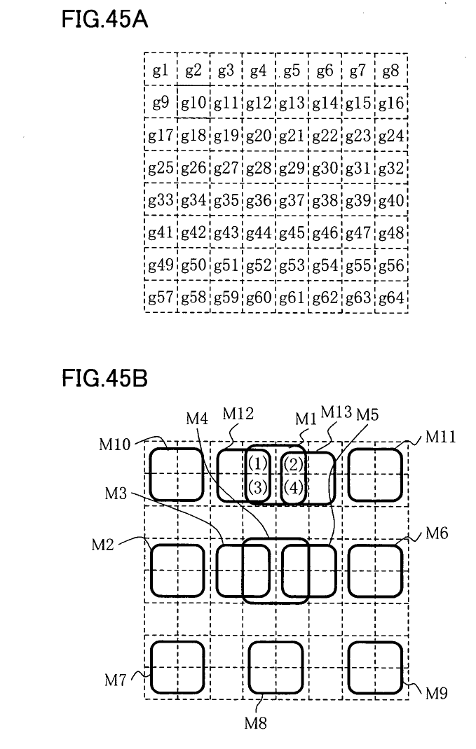

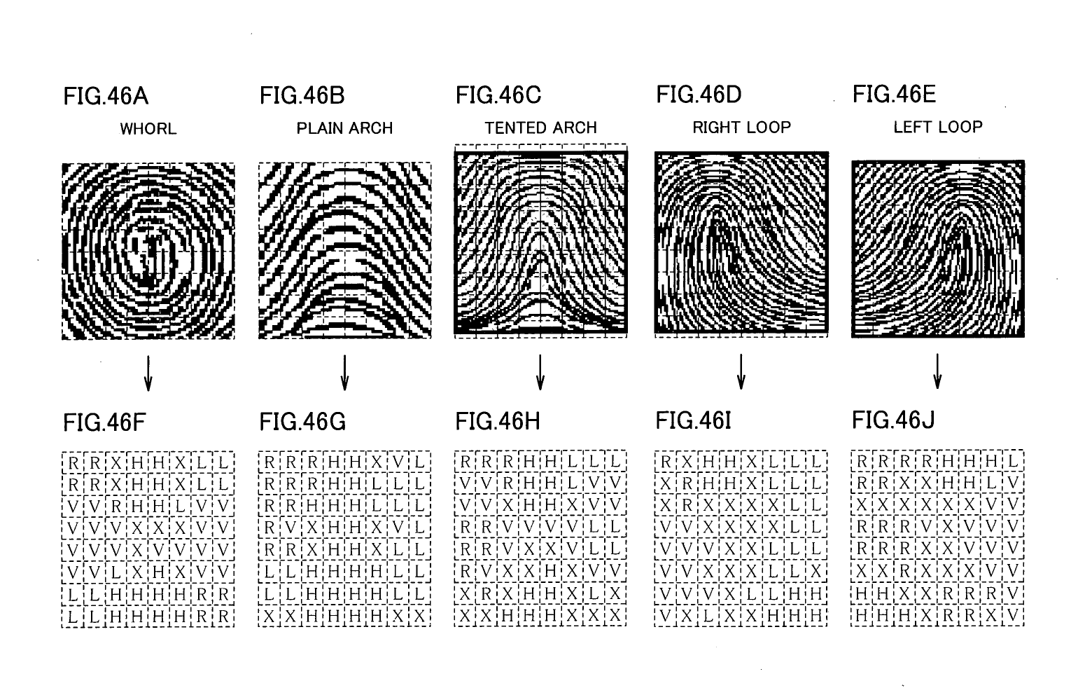

Referring to FIGS. 45A, 45B and 46A to 46J, a description is given of what is registered in table TB2 in FIG. 44. FIGS. 46A to 46E schematically show images (input (sample) images or reference images), each showing an image divided into eight sections in each of the vertical and horizontal directions, namely an image comprised of 64 partial images. FIG. 45A defines and shows, as FIG. 16A described above, partial images g1 to g64 of each of respective images in FIGS. 46A to 46E. FIG. 45B defines and shows macro partial images M1 to M13 of each image in the present embodiment. Each macro partial image is a combination of four partial images (1) to (4) (see macro partial image M1). In the present embodiment, one image has 13 macro partial images M1 to M13. However, the number of macro partial images per image is not limited to 13. Moreover, the number of partial images (1) to (4) constituting one macro partial image is not limited to four. Partial images constituting macro partial images M1 to M13 are represented using respective reference characters g1 to g64 of the partial images as shown below. It is noted that respective positions correlated with partial images constituting macro partial images M1 to M9 are identical to those described in connection with FIG. 16D. Therefore, the description thereof is not repeated. Here, macro partial images M10 to M13 are represented using the reference characters.

Macro partial image M10 [symbol] g1, g2, g9, g10

Macro partial image M11 [symbol] g7, g8, g15, g16

Macro partial image M12 [symbol] g3, g4, g11, g12

Macro partial image M13 [symbol] g5, g6, g13, g14

Accordingly, for each of these macro partial images M1 to M13, respective feature values of partial images (1) to (4) are read from memory 1025A (SJ01a). Partial image feature values of each of respective images in FIGS. 46A to 46E are shown in FIGS. 46F to 46J. FIG. 47A shows respective feature values of partial images (1) to (4) in each of macro partial images M1 to M13 in the image represented in FIGS. 46A and 46F. Then, for each of these macro partial images, the feature value is determined among the feature values “H”, “V”, “L”, “R” and “X” (SJ02a). A procedure of the determination is described in the following. It is supposed here that criteria data on which the determination is made as the one shown in FIG. 47D is stored in advance in memory 624.

In the present embodiment, in the case where three or four of the four partial images (1) to (4) constituting each macro partial image all have the feature value “H”, “V”, “L” or “R”, it is determined that this macro partial image has feature value “H”, “V”, “L” or “R”. Otherwise, it is determined that the macro partial image has feature value “X”.

A specific example is described. Regarding the image shown in FIG. 46A, respective feature values of four partial images (1) to (4) constituting macro partial image M1 are all “H”, namely no partial image has feature value “V”, “R”, “L” or “X” (see FIGS. 47A and 47B). Accordingly, it is determined that macro partial image M1 has feature value “H” (see FIG. 47C). In a similar manner, the determination is made for each of macro partial images M2 to M13 and the determined feature values are shown in FIG. 27C.

With reference to the results of the determination for respective macro partial images described above, the category of the image is determined (SJ03a). A procedure for this determination is described. First, a comparison is made with the arrangement of partial images representing the features of the images with the fingerprint patterns shown in image data 31A to 31F in FIG. 44. In FIG. 47D, respective feature values of macro partial images Ml to M13 of image data 31A to 31F are shown with correlation with data 34 of the category number.

From a comparison between FIGS. 47C and 47D, it is seen that the feature values of macro partial images M1 to M13 in FIG. 47C match those of image data 31A having data 34 of category number “1”. Accordingly, it is determined that the image in FIG. 46A of the sample (input) image belongs to category “1”, namely the whorl fingerprint image.

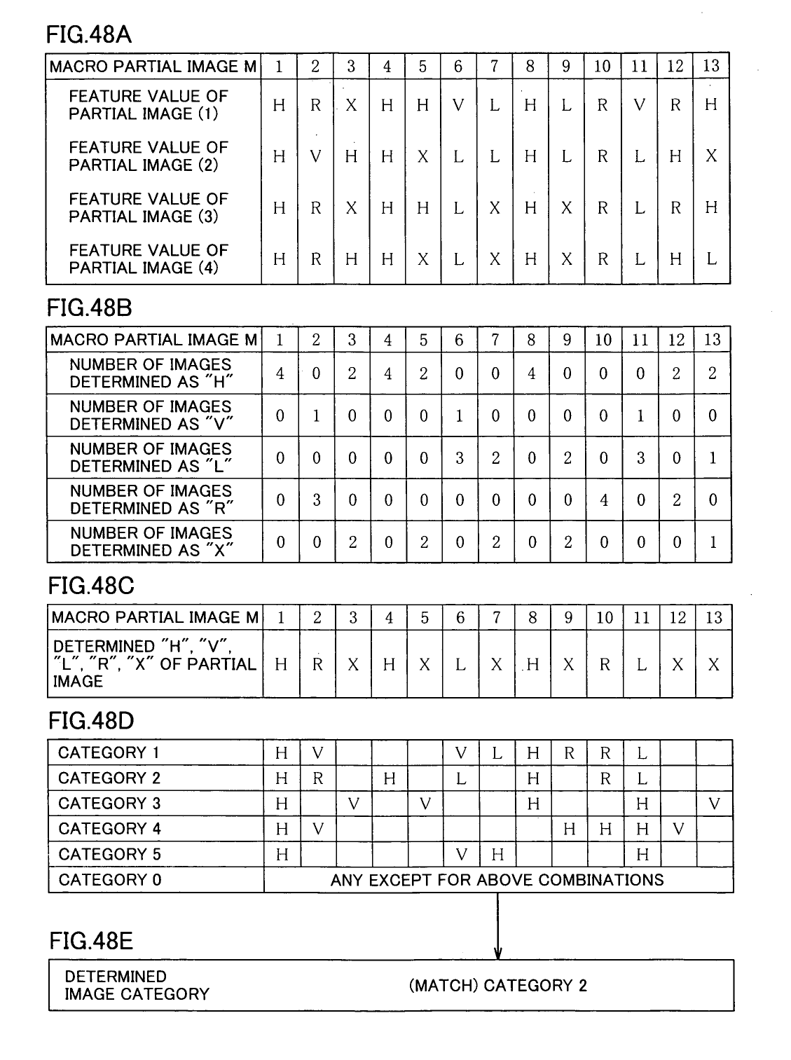

Similarly, for the fingerprint image corresponding to FIG. 46B, through the process as shown in FIGS. 48A to 48E, it is determined that the fingerprint image belongs to category “2”, namely plain arch fingerprint image.

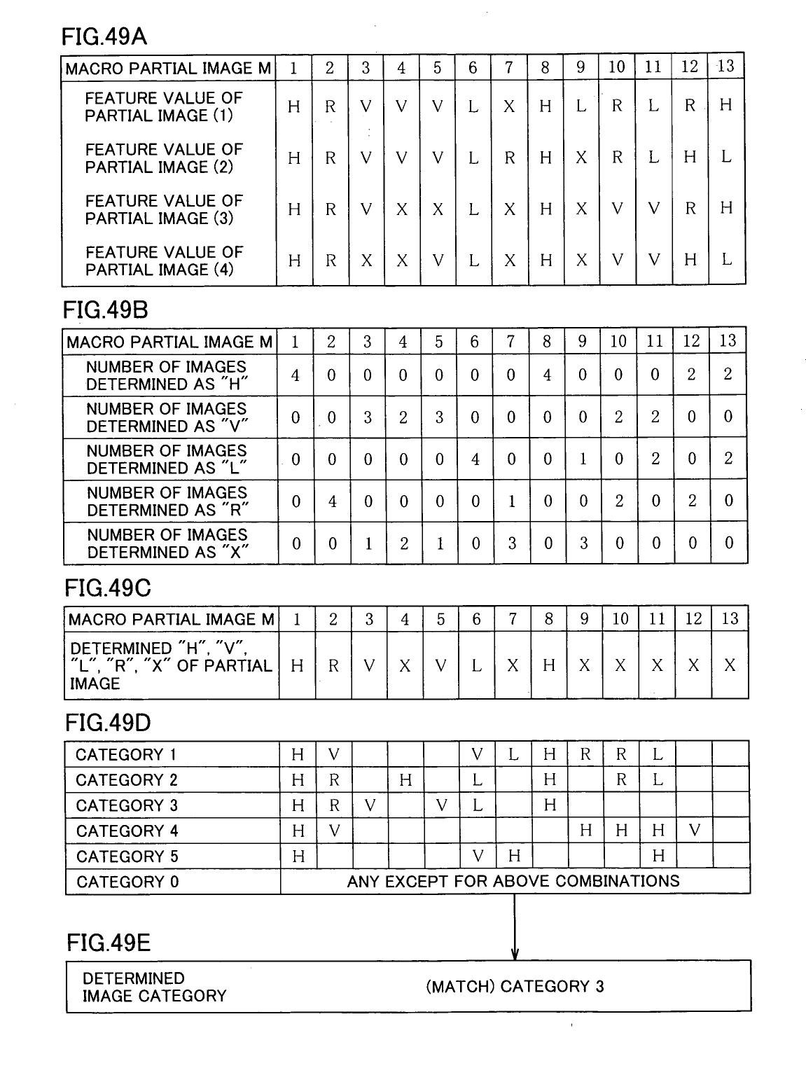

Similarly, for the fingerprint image corresponding to FIG. 46C, through the process as shown in FIGS. 49A to 49E, it is determined that the fingerprint image belongs to category “3”, namely tented arch fingerprint image.

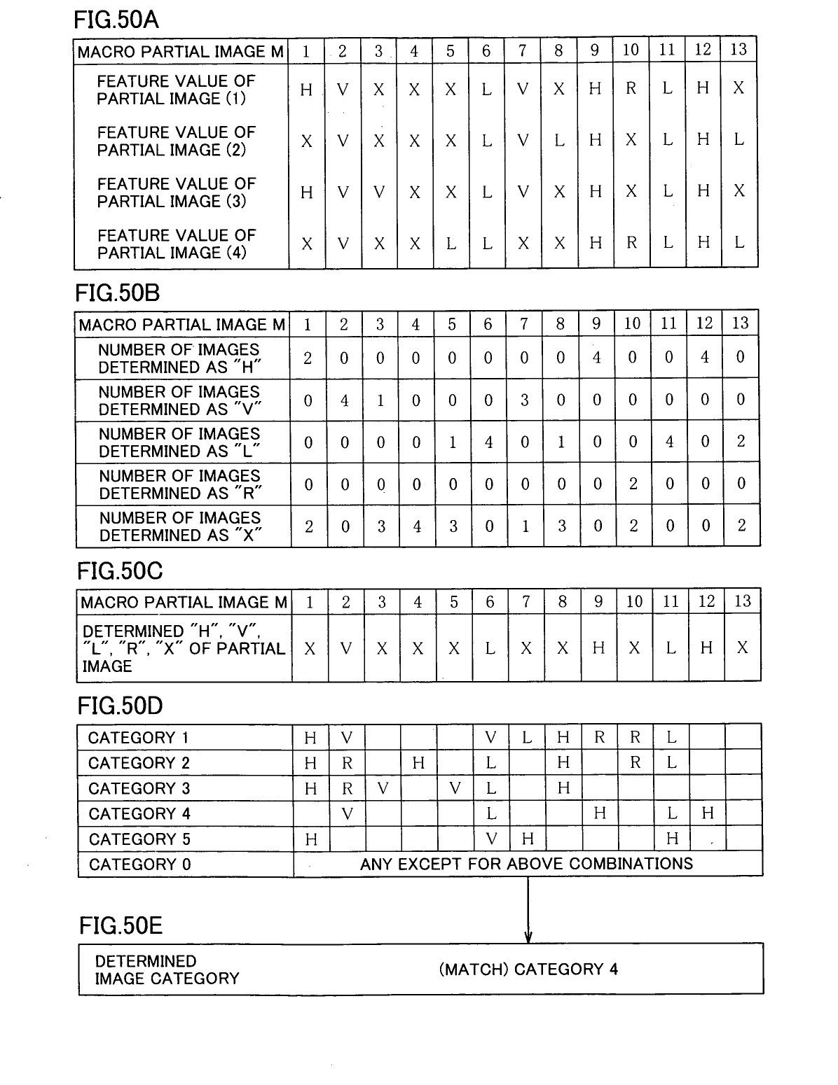

Similarly, for the fingerprint image corresponding to FIG. 46D, through the process as shown in FIGS. 50A to 50E, it is determined that the fingerprint image belongs to category “4”, namely right loop fingerprint image.

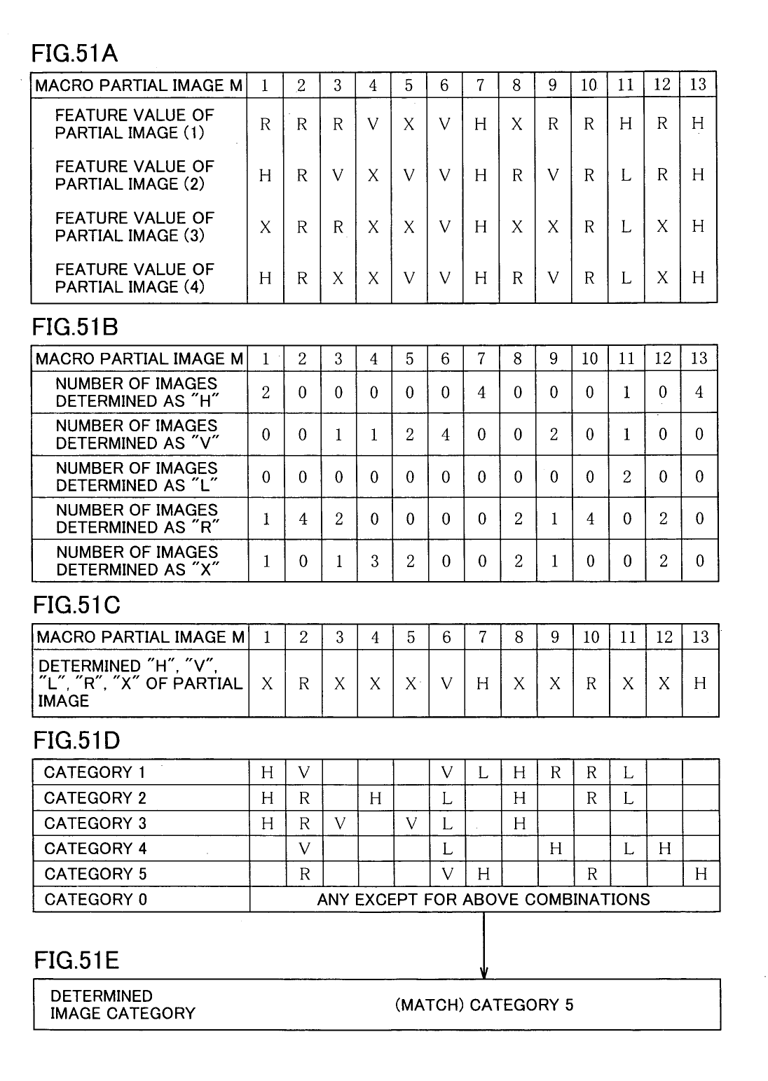

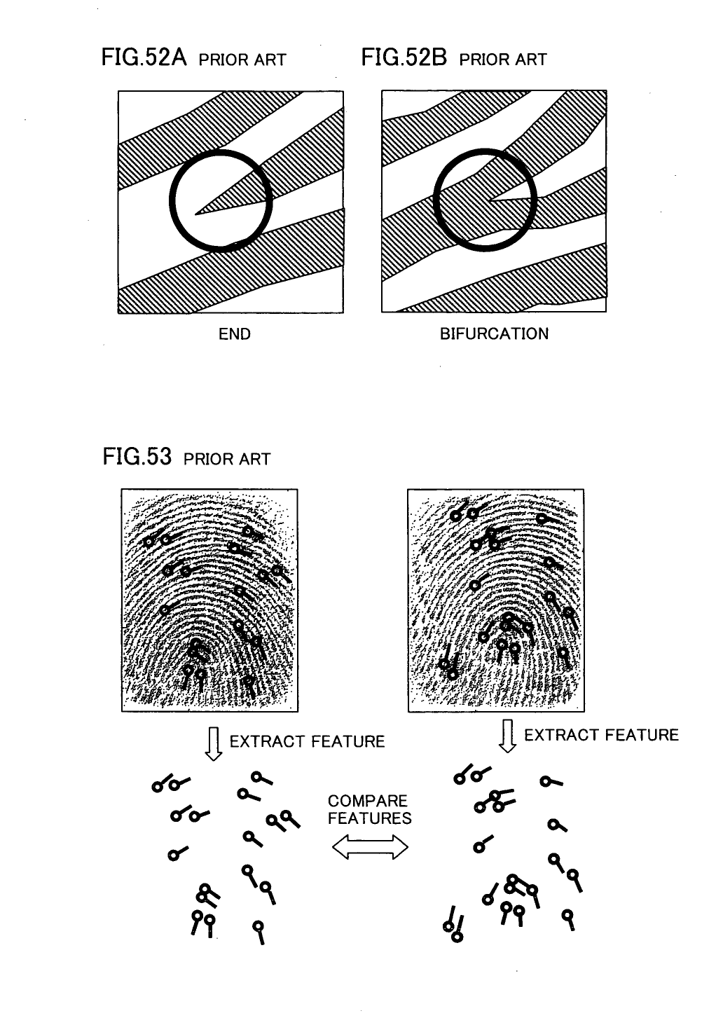

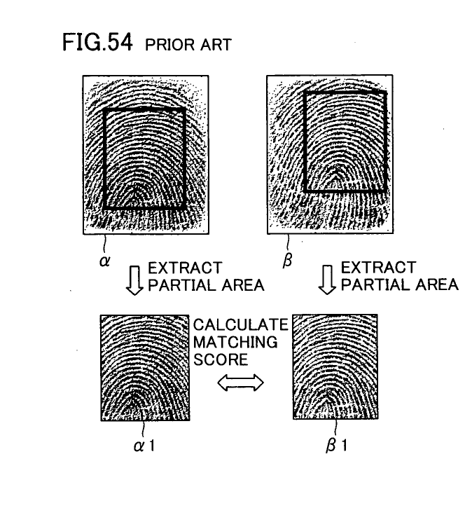

Similarly, for the fingerprint image corresponding to FIG. 46E, through the process as shown in FIGS. 51A to 51E, it is determined that the fingerprint image belongs to category “5”, namely left loop fingerprint image.

After the category is determined according to the procedure in FIG. 43, the similarity score calculation, comparison and determination are performed according to the procedure in FIG. 34, and the results are output (T3b, T5).

For the similarity score calculation, the position of the maximum matching score is searched for. The search is conducted in a search range specified in the following way. In one image, a partial region is defined. A partial region in the other image having its partial image feature value identical to that of the defined partial region in that one image is specified as the search range. Therefore, the partial region with the identical feature value can be specified as a search range.

Specifically, for the search for the position of the maximum matching score, in the case where the feature value of a partial region defined in one image indicates that the pattern in the partial region is arranged in one direction among the vertical direction (“V”), horizontal direction (“H”), left oblique direction (“L”) and right oblique direction (“R”), a partial region in the other image that has a feature value indicating that the pattern is arranged in the aforementioned one direction as well as a partial region in the other image having a feature value indicating that the pattern is out of the defined categories are specified as the search range.

Thus, a partial region of the image having the identical feature value and a partial region having the feature value indicating that the pattern is out of the categories can be specified as a search range.

Further, the partial region having the feature value indicating that the pattern in the partial region is out of the categories may not be included in the search range where the position of the maximum matching score is searched for. In this case, any partial region of an image having a pattern arranged in any obscure direction that cannot be identified as one of the vertical, horizontal, left oblique and right oblique directions can be excluded from the search range. Accordingly, deterioration in accuracy of comparison due to any obscure feature value can be prevented.

Here, a specific example of the comparing process in accordance with Embodiment 6 and effects derived therefrom are shown.

As discussed above, the comparing process in the present embodiment is characterized by the step of calculation for determining image category (T25b) and the step of similarity score calculation and comparison/determination (T3b) shown in the flowchart in FIG. 41. Thus, in the following, a description is given concerning an image on which the steps of image input (T1), image correction (T2) and partial image feature value calculation (T25a) have already been performed.

It is supposed here that, in the image comparison system, data of 100 reference images are registered and the reference images are evenly classified into image patterns, namely image categories as defined in the present embodiment. According to this supposition, the number of reference images belonging to each of the categories defined in Embodiment 6 is 20.

In Embodiment 1, by comparing an input image with about a half of 100 reference images on average, namely with 50 reference images, it can be expected that “match” can be obtained as a result of the determination. In contrast, in Embodiment 6, before comparison, the calculation for determining the image category (T25b) is performed to limit reference images to be compared with the input image to one category. Then, in Embodiment 6, about a half of the total reference images belonging to each category, namely 10 reference images may be compared with the input image. Thus, it can be expected that “match” can be obtained as a result of the determination.

Therefore, the amount of processing may be considered as follows: (the amount of processing for the similarity score determination and comparison/determination in Embodiment 6)/(the amount of processing for the similarity score determination and comparison/determination in Embodiment 1)≈(1/number of categories). It is noted that, although Embodiment 6 requires the amount of processing for the calculation for image category determination (T25b) before the comparing process, the feature values of partial images (1) to (4) belonging to each macro partial image that are used as source information used for this calculation (see FIGS. 47A, 48A, 49A, 50A and 51A) are also used in Embodiment 1, which means that Embodiment 6 does not increase in amount of processing as compared with Embodiment 1.

The determination of the feature value for each macro partial image (FIGS. 47C, 48C, 49C, 50C and 51C) and the determination of image category (FIGS. 47E, 48E, 49E, 50E and 51E) are considered as a comparison requiring a smaller amount of processing as seen from a comparison between FIGS. 47D and 47E and made once before a comparison with many reference images. It is thus apparent that the amount of processing is to the degree that is substantially negligible.

Though the reference images in Embodiment 6 are described as those stored in memory 1024 in advance, the reference images may be provided by using snap-shot images.

Embodiment 7

The process functions for image comparison described above in connection with each embodiment are implemented by a program. In Embodiment 7, the program is stored in a computer-readable recording medium.

As for the recording medium, in Embodiment 7, such a memory necessary for processing by the computer as shown in FIG. 2, as memory 624, itself may be a program medium. Alternatively, the recording medium may be a recording medium detachably mounted on an external storage device of the computer and the program recorded thereon may be read through the external storage device. Examples of such an external storage device are a magnetic tape device (not shown), an FD drive 630 and a CD-ROM drive 640, and examples of such a recording medium are a magnetic tape (not shown), an FD 632 and a CD-ROM 642. In any case, the program recorded on each recording medium may be accessed and executed by CPU 622, or the program may be once read from the recording medium and loaded to a prescribed storage area shown in FIG. 2, such as a program storage area of memory 624, and then read and executed by CPU 622. The program for loading is stored in advance in the computer.

Here, the recording medium mentioned above is detachable from the computer body. A medium fixedly carrying the program may be used as the recording medium. Specific examples may include tapes such as magnetic tapes and cassette tapes, discs including magnetic discs such as FD 623 and fixed disk 626 and optical discs such as CD-ROM 642/MO (Magnetic Optical Disc)/MD (Mini Disc)/DVD (Digital Versatile Disc), cards such as an IC card (including memory card)/optical card, and semiconductor memories such as a mask ROM, EPROM (Erasable and Programmable ROM), EEPROM (Electrically EPROM) and a flash ROM.

The computer shown in FIG. 2 has a configuration that allows connection to a communication network 300 including the Internet for establishing communication. Therefore, the program may be downloaded from communication network 300 and held on a recording medium in a non-fixed manner. When the program is downloaded from communication network, the program for downloading may be stored in advance in the computer, or it may be installed in advance from a different recording medium.

The contents stored in the recording medium are not limited to a program, and may include data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image comparing apparatus comprising:
a feature calculating unit calculating a value corresponding to a pattern of a partial image to output the calculated value as a feature of the partial image;
a position searching unit searching, with respect to said partial image in a first image, a second image for a maximum matching score position having a maximum score of matching with said partial image;
a similarity score calculating unit calculating a similarity score representing the degree of similarity between said first image and said second image, according to a positional relation amount representing positional relation between a reference position for locating said partial image in said first image and said maximum matching score position searched for, with respect to said partial image, by said position searching unit, and outputting the calculated similarity score; and
a determining unit determining whether or not said first image and said second image match each other, based on said similarity score as provided, wherein
said feature calculating unit includes a first feature calculating unit generating a third image by superimposing on each other said partial image and images generated by displacing, by a predetermined number of pixels, said partial image respectively in first opposite directions, and generating a fourth image by superimposing on each other said partial image and images generated by displacing, by said predetermined number of pixels, said partial image respectively in second opposite directions,
said first feature calculating unit calculates a difference between said generated third image and said partial image and a difference between said generated fourth image and said partial image to output, as said feature, a first feature value based on the calculated differences, and
a region that is included in said second image and that is searched by said position searching unit is determined according to said feature of said partial image that is output by said feature calculating unit.

2. The image comparing apparatus according to claim 1, further comprising a category determining unit determining, based on said feature of said partial image that is output by said feature calculating unit, a category to which said first image belongs, wherein
said second image is selected based on said category determined by said category determining unit.

3. The image comparing apparatus according to claim 2, wherein
said second image belongs to the same category as that of said first image.

4. The image comparing apparatus according to claim 3, wherein
in the case where said second image is prepared as a plurality of second images, a second image belonging to the same category as that of said first image is selected to be compared, from said plurality of second images.

5. The image comparing apparatus according to claim 1, wherein
said first image and said second image are each an image of a fingerprint, and said pattern is represented according to said fingerprint.

6. The image comparing apparatus according to claim 5, wherein
said first opposite directions refer to left-obliquely opposite directions relative to said fingerprint, and said second opposite directions refer to right-obliquely opposite directions relative to said fingerprint.

7. The image comparing apparatus according to claim 6, wherein
said feature calculating unit further includes a second feature calculating unit generating a fifth image by superimposing on each other said partial image and images generated by displacing, by a predetermined number of pixels, said partial image respectively in third opposite directions, and generating a sixth image by superimposing on each other said partial image and images generated by displacing, by said predetermined number of pixels, said partial image respectively in fourth opposite directions, and
said second feature calculating unit calculates a difference between said generated fifth image and said partial image and a difference between said generated sixth image and said partial image to output, as said feature, a second feature value based on the calculated differences.

8. The image comparing apparatus according to claim 7, wherein
said third opposite directions refer to upward and downward directions relative to said fingerprint, and said fourth opposite directions refer to leftward and rightward directions relative to said fingerprint.

9. The image comparing apparatus according to claim 8, wherein
said first feature value refers to one of a plurality of values including a value indicating that the pattern of said partial image is along said first opposite directions and a value indicating that the pattern of said partial image is along said second opposite directions, and
said second feature value refers to one of a plurality of values including a value indicating that the pattern of said partial image is along said third opposite directions and a value indicating that the pattern of said partial image is along said fourth opposite directions.

10. The image comparing apparatus according to claim 9, wherein
when said second feature value of said partial image in said first image indicates that the pattern of said partial image is along said third opposite directions or said fourth opposite directions, the region that is included in said second image and that is searched by said position searching unit is: a partial image that is included in a plurality of said partial images which are set in advance in said second image and that has said second feature value indicating that the pattern of said partial image is along said third opposite directions or said fourth opposite directions; and a partial image that is included in said plurality of partial images in said second image and that has said second feature value indicating that the pattern of said partial image is along a direction except for said third opposite directions and said fourth opposite directions.

11. The image comparing apparatus according to claim 9, wherein
the region that is included in said second image and that is searched by said position searching unit is a partial image that is included in a plurality of said partial images which are set in advance in said second image and that has said first feature value or said second feature value as calculated that matches said first feature value or said second feature value of said partial image in said first image.

12. The image comparing apparatus according to claim 9, wherein
said partial image that is included in a plurality of said partial images which are set in advance in said second image and that has said second feature value indicating that said pattern is along a direction except for said third opposite directions and said fourth opposite directions is excluded from the region searched by said position searching unit.

13. The image comparing apparatus according to claim 9, wherein
in the case where said second feature value of said partial image calculated by said second feature calculating unit indicates that said pattern is along a direction except for said third opposite directions and said fourth opposite directions, said feature calculating unit outputs, as said feature, said first feature value of said partial image that is calculated by said first feature calculating unit, instead of said second feature value and,
in the case where said partial image has said second feature value that is calculated by said second feature calculating unit and that indicates that said pattern is along said third opposite directions or said fourth opposite directions, said feature calculating unit outputs, as said feature, said calculated second feature value.

14. The image comparing apparatus according to claim 9, wherein
in the case where said first feature value of said partial image that is calculated by said first feature calculating unit indicates that said pattern is along a direction except for said first opposite directions and said second opposite directions, said feature calculating unit outputs, as said feature, said second feature value of said partial image that is calculated by said second feature calculating unit, instead of said first feature value.

15. An image comparing method performed by a computer, comprising the steps of:
feature calculating step using said computer to calculate a value corresponding to a pattern of a partial image and output the calculated value as a feature of the partial image;
position searching step using said computer to search, with respect to said partial image in a first image, a second image for a maximum matching score position having a maximum score of matching with said partial image;
similarity score calculating step using said computer to calculate a similarity score representing the degree of similarity between said first image and said second image, according to a positional relation amount representing positional relation between a reference position for locating said partial image in said first image and said maximum matching score position searched for, with respect to said partial image, in said position searching step, and output the calculated similarity score; and
determining step using said computer to determine whether or not said first image and said second image match each other, based on said similarity score as provided, wherein
said feature calculating step includes the step of first feature calculating step of generating a third image by superimposing on each other said partial image and images generated by displacing, by a predetermined number of pixels, said partial image respectively in first opposite directions, and generating a fourth image by superimposing on each other said partial image and images generated by displacing, by said predetermined number of pixels, said partial image respectively in second opposite directions,
in said first feature calculating step, a difference is calculated between said generated third image and said partial image and a difference between said generated fourth image and said partial image to output, as said feature, a first feature value based on the calculated differences, and
a region that is included in said second image and that is searched in said position searching step is determined according to said feature of said partial image that is output in said feature calculating step.

16. A machine readable storage device storing instructions executable by said computer to perform the method of claim 15.

17. A program product for a computer to perform an image comparing method, comprising:
feature calculating means for allowing said computer to calculate a value corresponding to a pattern of a partial image and output the calculated value as a feature of the partial image;
position searching means for allowing said computer to search, with respect to said partial image in a first image, a second image for a maximum matching score position having a maximum score of matching with said partial image;
similarity score calculating means for allowing said computer to calculate a similarity score representing the degree of similarity between said first image and said second image, according to a positional relation amount representing positional relation between a reference position for locating said partial image in said first image and said maximum matching score position searched for, with respect to said partial image, by said position searching means, and output the calculated similarity score; and
determining means for allowing said computer to determine whether or not said first image and said second image match each other, based on said similarity score as provided, wherein
said feature calculating means includes first feature calculating means for allowing said computer to generate a third image by superimposing on each other said partial image and images generated by displacing, by a predetermined number of pixels, said partial image respectively in first opposite directions, and generate a fourth image by superimposing on each other said partial image and images generated by displacing, by said predetermined number of pixels, said partial image respectively in second opposite directions,
said first feature calculating means allows said computer to calculate a difference between said generated third image and said partial image and a difference between said generated fourth image and said partial image to output a first feature value based on the calculated differences, and
a region that is included in said second image and that is searched by said position searching means is determined according to said feature of said partial image that is output by said feature calculating means.
